(19) United States
(12) Patent Application Publication
(10) Pub. No.: US 2012/0170021 A1
(43) Pub. Date: Jul. 5, 2012

(54) Method and apparatus for providing multiple wavelength reflectance magnitude and phase for a sample

(76) Inventor: Phillip Walsh, Austin, TX (US)

(21) Appl. No.: 12/584,203

(22) Filed: Sep. 1, 2009

Related U.S. Application Data
(60) Provisional application No. 61/190,722, filed on Sep. 2, 2008.

(51) Int. Cl. G01N 21/55

(52) U.S. Cl. 356/51

(57) ABSTRACT

A method and apparatus for providing multiple wavelength reflectance magnitude and phase for a sample is disclosed. In one embodiment, at least one of magnitude and/or phase is determined for at least some vacuum ultra-violet (VUV) wavelengths. One embodiment of the method utilizes a broadband referencing reflectometer to obtain an interference signal between reference and sample arms, in addition to the reflected intensities from each arm separately. Combined with a calibration of absolute reflectance magnitude and phase using one or more known calibration standards, the intensity and interference data can be used to obtain reflectance and phase for an unknown sample. In some embodiments, one or more properties of the calibration samples can be determined during the calibration procedure, even when the calibration samples are not stable under operating conditions, or with respect to the manufacture of the calibration samples.

### CROSS-REFERENCE TO RELATED APPLICATIONS

This application claims priority to Provisional Patent Application No. 61/190,722, filed Sep. 2, 2008 the disclosure of which is each expressly incorporated herein by reference.

The techniques disclosed herein relate to the field of optical metrology, and more particularly to a method and apparatus for providing multiple wavelength reflectance magnitude and phase for a sample.

### BACKGROUND

The advancement of many modern technologies—such as the fabrication of computer chips, disk drives, and development of photolithography features—requires the continued reduction of characteristic device dimensions. Device film thicknesses and feature sizes continue to shrink to the nanometer scale. This fact, combined with requirements for high-volume production, has lead to the rise of nondestructive optical metrologies for rapid and real-time process control of many stages of device manufacture.

Conventional laboratory metrology techniques such as scanning electron microscopy (SEM), atomic force microscopy (AFM), and transmission electron microscopy (TEM) are generally too slow and/or destructive to be useful in a high volume manufacturing environment. Optical metrologies have obvious advantages over conventional metrologies in that they are nondestructive and usually very fast.

Most optical metrologies fall under two, broad categories—optical profilometry/interferometry and reflectometry/ellipsometry. Optical profilometry uses interference between multiple beams of probe light and has been mostly applied to measurement of surface condition and to device imaging. Reflectometry and ellipsometry generally use a single probe that is usually broadband, and measure either reflectance from a surface (reflectometry) or the magnitude change and phase change on reflection of polarized light from a surface (ellipsometry). Reflectometer and ellipsometer measurements are indirect in the sense that the measured data is normally compared to models of the films/structures being measured and regression techniques used to infer the actual sample characteristics, such as film thickness, optical properties, or feature profile.

Reflectometry and ellipsometry are ideally suited to advanced materials characterization and have been used for thickness and composition control of silicon oxynitride (SiON) and hafnium silicide (HfSiOₓ) gate dielectrics, photoresist and antireflective coatings (ARCs), and ultrathin diamond-like carbon protective layers and polymer lubricating layers for disk drive manufacturing, to name just a few examples. Thin film metrology problems using reflectometry and ellipsometry can become quite complex, involving film stacks having many layers or having complicated optical dispersions.

More recently, there has been some crossover between the various roles of the two categories as reflectometers and ellipsometers measure feature dimensions and surface condition via scatterometry or specular (0 order) optical critical dimension measurements, and optical profilers perform film thickness measurements as part of imaging complicated, multi-featured surfaces. Generally speaking, however, film characterization using optical profilers has been somewhat rudimentary, and reflectometry and ellipsometry are much more suited to advanced materials characterization.

Of the two, reflectometers are generally more suited to manufacturing environments than ellipsometers for several reasons. Due to a less complicated optical path with few transmissive/dispersive components, the signal quality achieved by a reflectometer is better than that of an ellipsometer when similar measurement integration times are used. Reflectometers are mechanically less complicated than ellipsometers and are more robust in manufacturing environments. A reflectometer can be configured in a more compact configuration than an ellipsometer, and in particular can be configured for normal incidence operation. This leads to a smaller footprint and better suitability to integration into process tools.

On the other hand, ellipsometer data is, in a sense, richer than reflectance data. Ellipsometers measure two complimentary quantities—magnitude and phase change of complex polarized reflectance—for each incidence condition, whereas reflectometers typically measure only reflectance magnitude. In many applications the additional phase information allows for extraction of more simultaneous processing parameters. One simple example is the determination of optical properties of a bulk opaque material. Ellipsometer data can be directly inverted to obtain the index of refraction, n, and the extinction coefficient, k, of a bulk substrate. This is usually not possible using a reflectometer with a single angle of incidence.

Aspnes (“Minimal-data approaches for determining outer-layer dielectric responses of films from kinetic reflectometric and ellipsometric measurements”, D. E. Aspnes, J. Opt. Soc. Am. A Vol. 10, No. 5, p. 974 (1993)) points out that reflectance magnitude information can be enhanced by using interference techniques to additionally obtain reflectance phase. Similar to ellipsometric magnitude and phase change, reflectance magnitude and phase compliment each other and together increase the amount of information that can be extracted using the metrology. At the same time, an interference technique can be optically and mechanically less complex than an ellipsometric technique.

Optical and mechanical complexity has even greater impact as the industry moves toward vacuum ultra-violet (VUV) metrologies. The resolution obtainable by optical metrologies is adversely affected by the continued reduction of device feature sizes compared to the wavelength of the incident light, and one way to counter this effect is to decrease the probe wavelength. Accordingly, some manufacturers have begun to offer VUV ellipsometers and reflectometers. A smaller probe wavelength leads to the ability to extract more parameters simultaneously and with higher sensitivity from a film structure than is possible using longer wavelengths. An additional and less well-known effect of decreasing the probe wavelength arises from the fact that many materials exhibit a richer absorption spectrum in the VUV region. This is particularly advantageous for reflectance measurements.

In some cases, loss of sensitivity and resolution can be compensated for by obtaining multiple data sets, but this only goes so far. In the end, the solution of many metrology problems may only be obtainable with a reduction of the probe wavelength to VUV regions.

The practical advantages reflectometers have over ellipsometers are even more pronounced in the VUV region, where signal strength is at a premium due to fewer suitable choices of source, detection, and optical components. Due to a simpler design with a smaller number of transmissive optics, reflectance data can be obtained at wavelengths lower than is currently practical for VUV ellipsometers—approximately 120 nm or less for reflectometers versus ˜140-150 nm for ellipsometers. Additionally, the quality of reflectance data is generally better than ellipsometric data at those wavelength regions where both ellipsometers and reflectometers operate. A broadband referencing reflectometer such as that disclosed in U.S. Pat. No. 7,126,131, which is expressly incorporated herein by reference in its entirety, can be modified to provide reflectance phase data in addition to reflectance magnitude without introducing complicated transmissive optics, and is a superior method for obtaining optical data at VUV wavelengths while maximizing the richness of the data spectrum.

Generally, systems that use phase to measure film characteristics do so to improve optical profiler performance. For example, in situations where a reflected phase relative to a reference surface is used to determine profile height, the effect of changing thickness of transparent films on the measured surface should be accounted for. Such methods are taught in U.S. Pat. Nos. 6,999,180 (KLA-Tencor) and 5,173,746 (Wyco), which are still basically optical profilers and are incapable of advanced materials characterization.

U.S. Pat. No. 7,315,382 (Zygo Corporation), teaches an interference method for measuring reflectance data, but involves determining interferograms by scanning the z axis (parallel to the objective, i.e. changing the optical path distance). The method obtains angle-resolved data at a single wavelength, or at most a very few wavelengths. The limited wavelength range limits the materials characterization capability of the system. The method uses transmissive objectives in an uncontrolled environment and is not suitable for VUV operation. Data acquisition is slow since it requires continuous scanning of the z axis.

The concepts discussed in the paper “White light spectral interferometric technique used to measure thickness of thin films” (P. Hlubina, D. Ciprian, R. Clebus, J. Lunacek, and M. Lesnak, SPIE Vol. 6616, p 661605, (2007)) detect wavelength resolved interference data to infer a film thickness. It does not obtain sample reflectance, and instead combines film thickness analysis with analysis of additional sample-independent elements—particularly the beam splitter. The method is not suitable for VUV operation or advanced thin film analysis.

U.S. Patent Application No. 2006/0098206 discusses a white light interferometer technique for film characterization, but employs many transmissive optics in an uncontrolled ambient, and is incapable of measurements at VUV wavelengths.

U.S. Pat. Nos. 7,298,496 and 7,324,216, invert interference data to solve critical dimension problems, which evolves the optical profiler beyond simply imaging features, but both require detection of scattered light, and are therefore not applicable to uniform film structures.

Generally speaking, the main function of optical metrology systems based on interferometry is still the simultaneous acquisition of data from multiple locations in the field of view, basically in order to form a digital image of some property. Film characterization remains a secondary function of these systems, and is still quite rudimentary when compared to film characterization via reflectometry or ellipsometry.

Accordingly, the current method discloses a production-worthy optical metrology capable of collecting spectrally resolved reflectance magnitude and phase at wavelength ranges that include VUV wavelengths.

### SUMMARY

A method and apparatus are provided for providing multiple wavelength reflectance magnitude and phase for a sample. In one embodiment, at least one of magnitude and/or phase is determined at least some vacuum ultra-violet (VUV) wavelengths. One embodiment of the method utilizes a broadband referencing reflectometer to obtain an interference signal between reference and sample arms, in addition to the reflected intensities from each arm separately. Combined with a calibration of absolute reflectance magnitude and phase using one or more known calibration standards, the intensity and interference data can be used to obtain reflectance and phase for an unknown sample. In some embodiments, one or more properties of the calibration samples can be determined during the calibration procedure, even when the calibration samples are not stable under operating conditions, or with respect to the manufacture of the calibration samples. The analysis of reflectance magnitude and phase using thin film, scattering, or diffraction models allows for simultaneous extraction of more sample properties (film thicknesses, compositions, surface condition, feature profile shape) with better precision and less ambiguity than is possible using reflectance magnitude alone. Additionally, obtaining reflectance magnitude and phase is significantly less complex than obtaining ellipsometric data at similar wavelengths, leading to a better signal quality and better stability when the metrology is used in high volume manufacturing environments.

A method and system is described herein for enhancing a broadband VUV reflectometer such as is described in U.S. Pat. No. 7,126,131 (which; is expressly incorporated herein by reference in its entirety) to provide both reflectance magnitude and reflectance phase of a sample, and may be used at any wavelength, although a preferred embodiment operates in the VUV-NIR wavelength range. The techniques may be used to obtain reflectance magnitude and phase for unknown samples. However, the acquisition of phase over a broad wavelength range may make it desirable to utilize low coherence sources, from which it is fundamentally more difficult to maintain an interference condition than with long coherence length sources such as lasers. In addition, while the total system path difference cancels during the calibration procedure, variations in semiconductor wafer substrate thicknesses, among other things, may cause the system path difference to vary from measurement to, measurement. This variation may be accounted for with an additional fit parameter, which can lead to a degradation of the film metrology performance in some cases. It may be desirable to optionally provide a mechanically simple method for extracting at least one sample parameter in a manner that is independent of the system path difference. In addition, it may be desirable that the enhancement should integrate into the systems in a mechanically simple way.

As described below, other features and variations can be implemented, if desired, and a related method can be utilized, as well.

### DESCRIPTION OF THE DRAWINGS

It is noted that the appended drawings illustrate only exemplary embodiments of the techniques disclosed herein and are, therefore, not to be considered limiting of its scope, for the techniques disclosed herein may admit to other equally effective embodiments.

FIG. 1 is a block diagram of broadband referencing reflectometer covering VUV and DUV-NIR spectral regions with a compensator plate in the sample arm;

FIG. 2 is a simplified block diagram of a Michelson-type interferometer with complex reflection and transmission coefficients defined;

FIG. 3 is a block diagram of FIG. 2 illustrating control over path length of a reflectance arm to adjust dₛ−dₘ;

FIG. 4A is a graph illustrating reflectance for 120-800 nm wavelength range for 14 Å SiO₂/Si, 15 Å SiO₂/Si, and 16 Å SiO₂/Si structures;

FIG. 4B is a graph illustrating reflectance for 400-800 nm wavelength range for 14 Å SiO₂/Si, 15 Å SiO₂/Si, and 16 Å SiO₂/Si structures;

FIG. 4C is a graph illustrating reflectance for 120-220 nm wavelength range for 14 Å SiO₂/Si, 15 Å SiO₂/Si, and 16 Å SiO₂/Si structures;

FIG. 5A is a graph illustrating phase corresponding to reflectance for 120-800 nm wavelength range for 14 Å SiO₂/Si, 15 Å SiO₂/Si, and 16 Å SiO₂/Si structures;

FIG. 5B is a graph illustrating phase corresponding to reflectance for 400-800 nm wavelength range for 14 Å SiO₂/Si, 15 Å SiO₂/Si, and 16 Å SiO₂/Si structures;

FIG. 5C is a graph illustrating phase corresponding to reflectance for 120-220 nm wavelength range for 14 Å SiO₂/Si, 15 Å SiO₂/Si, and 16 Å SiO₂/Si structures;

FIG. 6A is a graph illustrating phase spectra for 120-800 nm wavelength range of 10 Å SiO2/4 Å SiO/Si, 11 Å SiO₂/4 Å SiO/Si, and 10 Å SiO₂/5 Å SiO/Si structures;

FIG. 6B is a graph illustrating phase spectra for 400-800 nm wavelength range of 10 Å SiO2/4 Å SiO/Si, 11 Å SiO₂/4 Å SiO/Si, and 10 Å SiO₂/5 Å SiO/Si structures;

FIG. 6C is a graph illustrating phase spectra for 200-400 nm wavelength range of 10 Å SiO2/4 Å SiO/Si, 11 Å SiO₂/4 Å SiO/Si, and 10 Å SiO₂/5 Å SiO/Si structures;

FIG. 6D is a graph illustrating phase spectra for 120-180 nm wavelength range of 10 Å SiO2/4 Å SiO/Si, 11 Å SiO₂/4 Å SiO/Si, and 10 Å SiO₂/5 Å SiO/Si structures;

FIG. 7A is a graph illustrating reflectance spectra for 120-800 nm wavelength range of 10 Å SiO2/4 Å SiO/Si, 11 Å SiO₂/4 Å SiO/Si, and 10 Å SiO₂/5 Å SiO/Si structures;

FIG. 7B is a graph illustrating reflectance spectra for 120-220 nm wavelength range of WA SiO2/4 Å SiO/Si, 11 Å SiO₂/4 Å SiO/Si, and 10 Å SiO₂/5 Å SiO/Si structures;

FIG. 8A is a graph illustrating phase spectra for 120-800 nm wavelength range of 14 Å SiON/Si, 15 Å SiON/Si, and 16 Å SiON/Si structures;

FIG. 8B is a graph illustrating phase spectra for 400-800 nm wavelength range of 14 Å SiON/Si, 15 Å SiON/Si, and 16 Å SiON/Si structures;

FIG. 8C is a graph illustrating phase spectra for 120-220 nm wavelength range of 14 Å SiON/Si, 15 Å SiON/Si, and 16 Å SiON/Si structures;

FIG. 9A is a graph illustrating phase spectra for 120-800 nm of 15 Å SiON/Si films having 14%, 15%, and 16% SiN components;

FIG. 9B is a graph illustrating phase spectra for 400-800 nm of 15 Å SiON/Si films having 14%, 15%, and 16% SiN components;

FIG. 9C is a graph illustrating phase spectra for 120-220 nm of 15 Å SiON/Si films having 14%, 15%, and 16% SiN components;

FIG. 10A is a graph illustrating reflectance spectra for 120-800 nm wavelength ranges corresponding to wavelength range of 14 Å SiON/Si, 15 Å SiON/Si, and 16 Å SiON/Si structures;

FIG. 10B is a graph illustrating reflectance spectra for 120-220 nm wavelength ranges corresponding to wavelength range of 14 Å SiON/Si, 15 Å SiON/Si, and 16 Å SiON/Si structures;

FIG. 11A is a graph illustrating reflectance spectra for 120-800 nm wavelength ranges corresponding to 15 Å SiON/Si films having 14%, 15%, and 16% SiN components;

FIG. 11B is a graph illustrating reflectance spectra for 120-180 nm wavelength ranges corresponding to 15 Å SiON/Si films having 14%, 15%, and 16% SiN components;

FIG. 12 is a graph illustrating Gaussian white noise function for an intensity noise window size of 5 counts;

FIG. 13A is a graph illustrating comparison of theoretical and simulated with noise phase spectrum for the 10 Å SiO₂/4 Å SiO/Si structure;

FIG. 13B is a graph illustrating residue of simulated with noise and theoretical curves shown in FIG. 13A;

FIG. 13C is a graph illustrating expanded 120-220 nm region of FIG. 13B;

FIG. 13D is a graph illustrating interference term showing minima at ˜155 nm;

FIG. 13E is a graph illustrating expanded 120-220 nm region of FIG. 13D;

FIG. 14A is a graph illustrating interference term with a 30 nm offset in sample and reference arm path difference;

FIG. 14B is a graph illustrating comparison of theoretical and simulated with noise phase spectrum for the structure shown in FIGS. 13A-13E;

FIG. 14C is a graph illustrating residue of simulated with noise and theoretical curves shown in FIG. 14B;

FIG. 15A is a graph illustrating comparison of theoretical and simulated with noise phase spectrum for the 400-800 nm wavelength region for the structure shown in FIGS. 13A-13E, but with different noise condition;

FIG. 15B is a graph illustrating residue of simulated with noise and theoretical curves shown in FIG. 15A;

FIG. 16A is a graph illustrating comparison of result of inverse cosine operation with original theoretical phase;

FIG. 16B is a graph illustrating comparison showing effect of correcting the phase from the inverse cosine operation shown in FIG. 16A at wavelengths below the interference minimum;

FIG. 17A is a graph illustrating comparison of interference term for 15 Å SiO2/Si, 20 Å SiO2/Si, and 15 Å 15% SiON/Si samples;

FIG. 17B is a graph illustrating an expanded view of FIG. 17A to show the 120-220 nm region;

FIG. 17C is a graph illustrating comparison of phase calculated using an algorithm to remove a phase ambiguity with the original theoretical phase;

FIG. 17D is a graph illustrating residue shown in FIG. 17C;

FIG. 17E is a graph illustrating an expanded view of FIG. 17D to 120-220 nm region;

FIG. 18 is a simplified block diagram of an interferometer with a polarizing beam splitter with complex reflection and transmission coefficients consisting of two components, one for each polarization;

FIG. 19. is a block diagram illustrating a beam splitter consisting of beam splitting films sandwiched between two identical substrates;

FIG. 20A shows two samples in the sample arm with thicknesses t_{S1} and t_{S2};

FIG. 20B. shows two samples, where sample 2 is replaced with a known calibration sample, and the total round-trip path length difference for the sample is expressed as d_{S}, and that of the calibration sample as d_{Cal};

FIG. 21 is a table illustrating exemplary data for a 15 Å SiO₂/Si system;

FIG. 22 is a table illustrating exemplary data for a 15 Å SiON film with 15% SiN component;

FIG. 23 is a table illustrating exemplary data for an ONO stack, consisting of 65 Å SiO₂/45 Å SiN/50 Å SiO₂/Si;

FIG. 24 is a simplified block diagram of a Michelson-type interferometer with complex reflection and transmission coefficients defined for polarized light;

FIG. 25 shows an expanded view of the focusing objective and sample surface of FIG. 24; and

FIG. 26 shows substrate thickness variations.

### DETAILED DESCRIPTION

A preferred embodiment of the techniques disclosed herein may optionally incorporate interference detection capability into a previously disclosed VUV reflectometer system, such as described in U.S. Pat. Nos. 7,067,818 and 7,126,131 (Metrosol, Inc.), which are expressly incorporated herein by reference in their entirety, other systems may be utilized however. In particular, U.S. Pat. No. 7,126,131 discloses a VUV referencing reflectometer that in a preferred embodiment is essentially a Michelson-type interferometer. Vacuum ultra-violet (VUV) wavelengths are generally considered to be wavelengths less than deep ultra-violet (DUV) wavelengths. Thus, VUV wavelengths are generally considered to be wavelengths less than about 190 nm. While there is no universal cutoff for the bottom end of the VUV range, some in the field may consider VUV to terminate and an extreme ultra-violet (EUV) range to begin (for example, some may define wavelengths less than 100 nm as EUV). Though the principles described herein may be applicable to wavelengths above 100 nm, such principles are generally also applicable to wavelengths below 100 nm. Thus, as used herein it will be recognized that the term VUV is meant to indicate wavelengths generally less than about 190 nm, however VUV is not meant to exclude lower wavelengths. Thus, as described herein, VUV is generally meant to encompass wavelengths generally less than about 190 nm without a low end wavelength exclusion. Furthermore, low end VUV may be construed generally as wavelengths below about 140 nm.

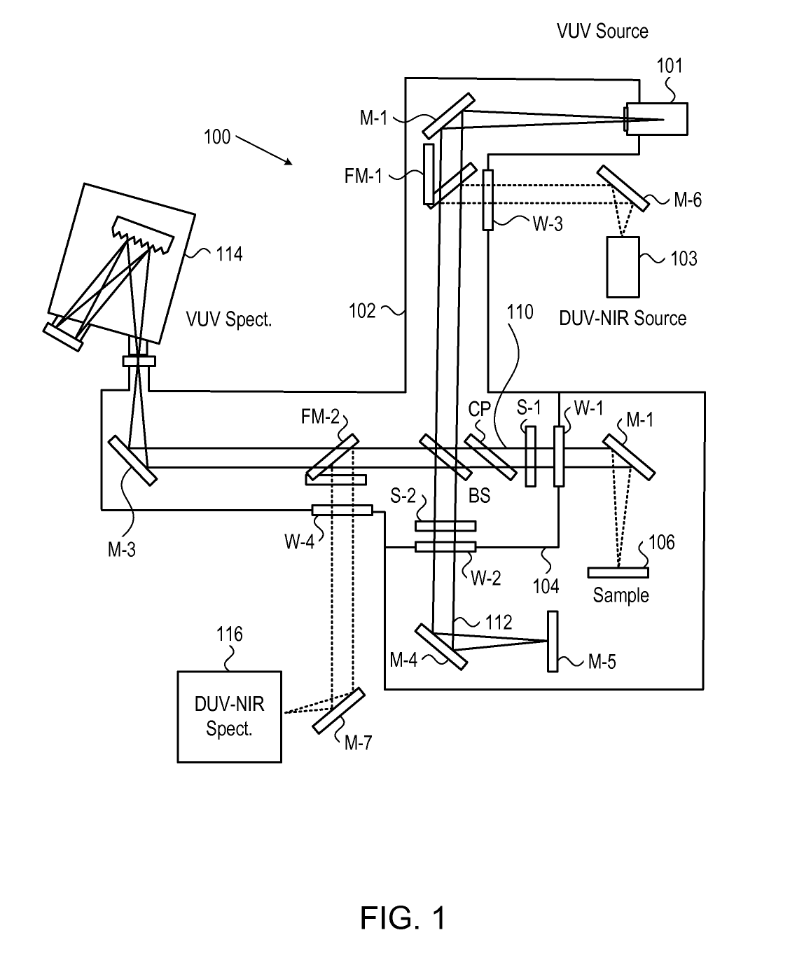

A schematic of the optical configuration is shown in FIG. 1. FIG. 1 shows an embodiment 100 of the techniques disclosed herein configured to collect referenced broadband reflectance data in both the VUV and DUV-NIR. Light from a light source 101 is split into separate sample 110 and reference 112 paths by a beam splitter BS, reflected from the sample 106 and reference surfaces M-5, recombined at the beam splitter BS, and the reflected intensities detected by a grating spectrometer 114 and array detector. In U.S. Pat. No. 7,126,131, the sample and reference arm intensities are detected separately by employing shutters. In the current techniques disclosed herein, a third detection mode is added that collects light from both arms simultaneously (both shutters open). For proper balancing between the optical paths of the sample and reference arms, the light reflected from the two surfaces undergo constructive and destructive interference. Materials for mirrors M-1, M-2, M-3, M-4, M-5, M-6, M-7, FM-1, FM-2, beam splitters BS, source 101, detection systems 116, and methods of environment control suitable for VUV operation are described in detail in U.S. Pat. Nos. 7,067,818 and 7,126,131, which are expressly incorporated herein by reference in their entirety, as stated above.

It should be noted that while U.S. Pat. Nos. 7,067,818 and 7,126,131 discuss some specific materials and methods for environmental control, the currently disclosed reflectance magnitude and phase measurement methods could be combined with any materials for optics, source, or detection components suitable for VUV operation. Additionally, while U.S. Pat. Nos. 7,067,818 and 7,126,131 discuss replacing the ambient in the sample and/or optics chambers with an inert gas environment, the measurements of the current disclosure could also be performed in vacuum, in a continuous purge system such as that described in U.S. Pat. No. 6,813,026 (Thema-Wave, Inc.) or U.S. Patent Application No. 2004/0150820, or in combination with any other environmental control method that allows transmission of VUV light.

While U.S. Pat. Nos. 7,067,818 and 7,126,131 discuss Michelson-type and Mach-Zehnder-type interferometer systems, the methods herein could be used with any type of system capable of causing interference between light reflected from sample and reference surfaces. Additionally, transmission-based interference systems can be envisioned and straight-forward modifications of the disclosed methods could be used in combination with these systems instead of reflectance-based systems.

In operation, light from two spectral regions is obtained in a serial manner. That is, reflectance data from the VUV is first obtained and referenced, following which, reflectance data from the DUV-NIR region is collected and referenced. Once both data sets are recorded they are spliced together to form a single broad band spectrum. The instrument is separated into an environmentally controlled chamber, the instrument chamber 102, which houses most of the system optics and is not opened to the atmosphere on a regular basis. A sample chamber 104 has a sample 106 and a reference optic mirror M-5 and is opened regularly to facilitate changing samples.

In operation, the VUV data is first obtained by switching flip-in source mirror FM-1 into the “out” position so as to allow light from the VUV source 101 to be collected, collimated and redirected towards beam splitter element BS by focusing mirror M-1. Light striking the beam splitter BS is divided into two components, the sample beam 110 and the reference bean 112, using a balanced Michelson interferometer arrangement. The sample beam 110 is reflected from the beam splitter BS and travels through shutter S-1. Shutter S-2 is closed during this time. The sample beam 110 continues on through compensator plate CP and is redirected and focused into the sample chamber 104 through window W-1 via focusing mirror M-2. The compensator plate CP is included to eliminate the phase difference that would occur between the sample and reference paths resulting from the fact that light traveling in the sample channel passes through the beam splitter substrate but once, while light traveling in the reference channel passes through the beam splitter substrate three times due to the nature of operation of a beam splitter BS. Hence, the compensator plate CP is constructed of the same material and is of the same thickness as the beam splitter substrate material. Window W-1 is constructed of a material that is sufficiently transparent to VUV wavelengths so as to maintain high optical throughput in the system as described above.

When collecting from the sample beam, light entering the sample chamber 104 strikes the sample 106 and is reflected back through W-1 where it is collected, collimated and redirected by mirror M-2. Light from mirror M-2 travels through compensator plate CP, shutter S-1, which is open, and beam splitter BS, where it passes unhampered by flip-in detector mirror FM-2 (switched to the “out” position at the same time as FM-1), where it is redirected and focused onto the entrance slit of the VUV spectrometer 114 by focusing mirror M-3. At this point, light from the sample beam 110 is dispersed by the VUV spectrometer 114 and acquired by its associated detector.

The reference beam 112 is measured by closing shutter S-1 and opening shutter S-2. This enables the reference beam 112 to travel through beam splitter BS and shutter S-2, wherein it enters the sample chamber 104 through window W-2 toward focusing mirror M-4. Window W-2 is also constructed of a material that is sufficiently transparent to VUV wavelengths so as to maintain high optical throughput in the system as described above. Once inside the sample chamber 104, light is focused via mirror M-4 toward reference mirror M-5. Light is then reflected from the surface of plane reference mirror M-5 and redirected towards mirror M-4 where it is collected, collimated and redirected towards beam splitter BS. Light is then reflected by beam splitter BS towards mirror M-3 where it is redirected and focused onto the entrance slit of the VUV spectrometer 114.

The final collection mode involves opening both shutters S-1 and S-2 simultaneously, and detecting the combined sample and reference paths, which includes the effects of constructive and destructive interference of the sample and reference beams.

Once the sample, reference, and combined beams are collected, a processor (not shown) can be used to calculate the reference VUV reflectance magnitude and reflectance phase spectrum.

Following measurement of the VUV data set, the DUV-NIR data is obtained by switching both the source and detector flip-in mirrors, FM-1 and FM-2 respectively, into the “in” position. As a result, light from the VUV source 101 is blocked and light from the DUV-NIR source 103 is allowed to pass through window W-3, after it is collected, collimated and redirected by focusing mirror M-6. Similarly, switching flip-in mirror FM-2 into the “in” position directs light from the sample beam 110 (when shutter S-1 is open and shutter S-2 is closed) and reference beam 112 (when shutter S-2 is open and shutter S-1 is closed) through window W-4 onto mirror M-7 which focuses the light onto the entrance slit of the DUV-NIR spectrometer 116 where it is dispersed and collected by its detector. A final collection mode is again provided by opening both shutters S-1 and S-2 simultaneously. Suitable DUV-NIR spectrometers and detectors are common place in today-s market. A particularly well-matched combination is manufactured by Jobin Yvon of France. The VS-70 combines a highly efficient (f/2) optical design that does not employ turning mirrors. This instrument has a small physical footprint, incorporates an order sorting filter and can be used with either a linear CCD or PDA detector.

The flip-in mirrors utilized into the system are designed such that they are capable of switching position quickly and in a repeatable fashion in order to minimize losses in optical throughput associated with errors in beam directionality. A particularly well suited motorized flip-in mirror is manufactured by New Focus of the United States. In a slightly modified embodiment, these mirrors could be replaced altogether by beam splitter/shutters pairs; however, this would be accompanied by an undesirable loss in VUV signal strength.

Once the sample, reference, and combined beams are obtained the processor is used to calculate the reference DUV-NIR reflectance magnitude and reflectance phase spectrum. In this manner, referenced reflectance data is serially obtained in the VUV and DUV-NIR regions. It is noted that both the VUV and DUV-NIR spectrometers, need be equipped with necessary sorting filters to avoid complications due to higher order diffraction components. It will be recognized that the techniques described herein are not limited to a system which serially obtains data over multiple wavelength regions. Thus the serially data collection over VUV and DUV is merely exemplary. Thus, the techniques described herein may be utilized in systems that only collect data from a single source or single wavelength region. Alternatively, a single source that spans multiple wavelength regions may also be utilized.

As vacuum compatible components are typically more complicated to design and expensive to manufacture than their standard counterparts, it follows that system elements not critical to VUV operation be mounted outside the controlled environment. Hence, the DUV-NIR source 103 and spectrometer/detector 116 are mounted outside the controlled environment. Such an arrangement is not required however.

Referring again to FIG. 1, a motor mechanism can be added to either the sample 110 or reference 112 arm to assist in meeting the interference criteria. The mechanism moves the sample 106 or reference surface in a direction perpendicular to the incident light so that the path length of the arm is changed. To preserve the focus condition on the surfaces, it may be advantageous to move the entire final objective (focusing mirrors M-2 or M-4) as well as the sample 106 or reference surface. During calibration, the path length of one of the arms is adjusted until the zero path difference condition is attained and interference is realized. The path lengths would then be kept constant during subsequent measurements. The sample and reference paths can be further equalized by incorporating a compensating plate CP of the same material as the bulk beam splitter BS material into the collimated part of the sample path, which is also shown in FIG. 1.

Exemplary techniques for utilizing the concepts disclosed herein are presented below for the use of un-polarized light in one embodiment and polarized light in another embodiment.

### Unpolarized Light

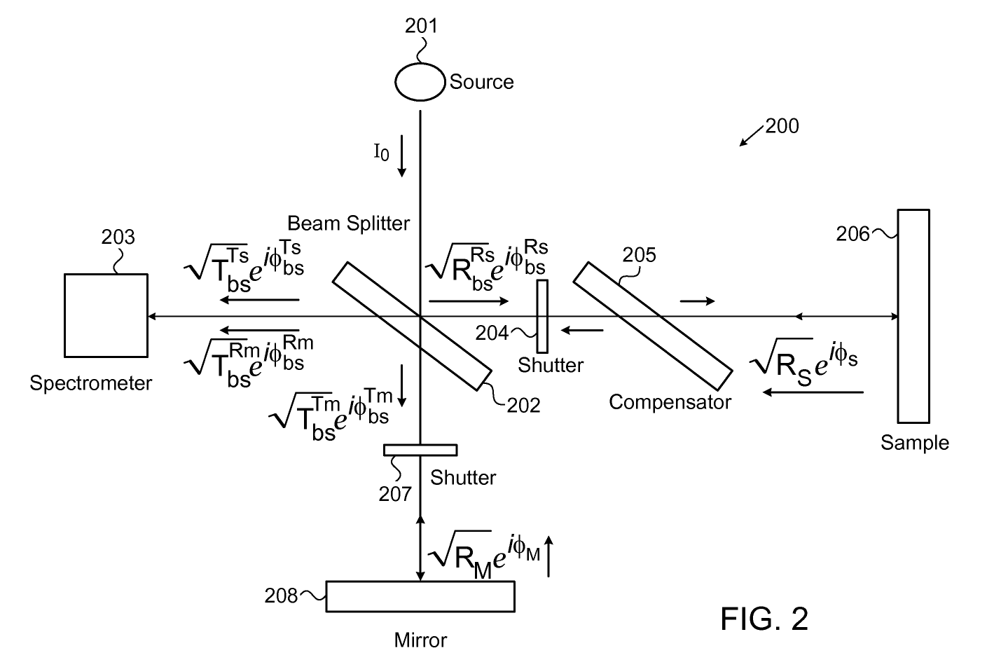

FIG. 2 shows a simplified diagram of a Michelson-type optical system 200. The definitions for the symbols of FIG. 2 are:
I₀=intensity incident on beam splitter
\sqrt{R_{bs}^{Rs}}e^{iφ}^{_{bs}}^{^{Rs}}=total complex reflection coefficient of beam splitter on sample arm side
\sqrt{R_{S}}e^{iφ}^{_{S}}=total complex reflection coefficient of sample
\sqrt{R_{M}}e^{iφ}^{_{M}}=total complex reflection coefficient of reference surface
\sqrt{T_{bs}^{Tm}}e^{iφ}^{_{bs}}^{^{Tm}}=total complex transmission coefficient of beam splitter on reference arm side
\sqrt{R_{bs}^{Rm}}e^{iφ}^{_{bs}}^{^{Rm}}=total complex reflection coefficient of beam splitter on reference arm side
\sqrt{T_{bs}^{Ts}}e^{iφ}^{_{bs}}^{^{Ts}}=total complex transmission coefficient of beam splitter on detector side (for light incident from sample arm side)

FIG. 2 shows a light source 201, beam splitter 202, a sample 206, a sample shutter 204, a reference shutter 207, a compensator 205, a mirror 208, and a spectrometer 203. At any optical surface, including the measured sample 206 and reference mirror 208, the interaction of light with the optic can be described by the total complex reflection and transmission coefficients

r=\sqrt{R}e^{iφ}^{ᵣ} eq. 1

and

t=\sqrt{T}e^{iφ}^{ₜ}, eq. 2

where r and t are the complex reflection and transmission coefficients, R and T are the total reflectance and transmittance magnitudes, φᵣ and φₜ are the phase angles of the complex reflection and transmission coefficients. φᵣ and φₜ can also be viewed as the phase change caused by reflection from the optic and transmission through the optic, respectively. Note that the effective complex reflection and transmission coefficients include the effects of multiple film layers on the optics.

The reflection or transmission coefficient gives the fraction of the incident field amplitude that is reflected at the surface or transmitted through the optic, and the reflected or transmitted intensity that would be detected is given by their squared magnitudes. So, for instance, if I₀ is the intensity of light incident on the beam splitter 202, the intensity reflected from the beam splitter 202 is

I_{R}^{bs}=I₀·(\sqrt{R_{bs}^{S}}e^{iφ}^{_{bs}}^{^{Rs}}·\sqrt{R_{bs}^{S}}e^{-iφ}^{_{bs}}^{^{Rs}})=I₀·R_{bs}^{S} eq. 3

and the intensity transmitted through the beam splitter 202 is

I_{T}^{bs}=I₀·(\sqrt{T_{bs}^{M}}e^{iφ}^{_{bs}}^{^{Tm}}·\sqrt{T_{bs}^{M}}e^{iφ}^{_{bs}}^{^{Tm}})=I₀·T_{bs}^{M} eq. 4

where the various symbols are as defined in FIG. 2.

For the reflectometer shown in FIGS. 1 and 2, the main quantity of interest is the complex reflection coefficient from the sample 106 (FIG. 1), 206 (FIG. 2),

r_{S}=\sqrt{R_{S}}e^{iφ}^{_{S}} eq. 5

from which properties of the sample 106 (FIG. 1), 206 (FIG. 2) such as film thickness and composition can be determined. Without inducing an interference condition, the quantity measured is the squared magnitude of eq. 5, and all information about the reflectance phase, φₛ, is lost.

By opening both shutters S-1, S-2 (FIG. 1) and 204, 207 (FIG. 2) in FIGS. 1 and 2, the beam paths from the reference and sample arms can be made to interfere, and in this case the detected intensity contains information about the sample reflectance phase, φₛ. This is made clear by an analysis of the detected intensity from FIG. 2, given an initial intensity I₀ at the beam splitter BS (FIG. 1), and 202 (FIG. 2). An overall arbitrary phase will be ignored. For simplicity, the incident light is assumed monochromatic and fully coherent. Both assumptions can be relaxed by including a wavelength-dependent scaling factor on the interference cross-term at the end of the analysis. The exact form of the scaling factor is not important for the measurement and its effects can be accounted for through a calibration procedure (described below).

In order to understand the techniques disclosed herein, some concepts regarding beam splitter 202 and compensating plate 205 are discussed. The bulk of the beam splitter material is usually MgF₂, LiF, or some other suitable material that transmits VUV light. The beam splitter 202 has a film structure coated on one side, in this case on the source side, and it is this film structure that is actually responsible for dividing the beam intensity. The compensating plate 205 is composed of the same bulk material as the beam splitter 202, but without the thin film structure. Inserted into the sample arm, the compensating plate 205 accounts for the fact that light traversing the sample arm passes through the bulk of the beam splitter 202 only once, while light traversing the reference path passes through the beam splitter substrate 202 three times. This negates the need to include a phase contribution (2πn_{bs}t_{bs} cos θ/λ, where n_{bs} is the beam splitter refractive index, t_{bs} is the bulk thickness, and θ is the angle of travel through the material) each time light passes through the beam splitter substrate 202 or compensating plate 205, since these phases cancel out in the end. Additionally, we ignore other effects like a small loss in intensity on each pass through the bulk beam splitter and compensating plate. Finally, since presumably k is zero for the beam splitter and compensating plate, there is no contribution to the phase difference from the beam splitter/air interfaces. In light of all of this, the reflection and transmission coefficients and phases shown in FIG. 2 for the beam splitter material actually refer to the film stack on the beam splitter 202 surface, and all effects of the bulk beam splitter and compensating plate, or cancel out and are therefore ignored.

For the embodiment shown in FIG. 2, all transmissions through the beam splitter films occur from the same side, and so will usually have T_{bs}^{Ts}=T_{bs}^{Tm} and φ_{bs}^{Ts}=φ_{bs}^{Tm}, although other embodiments are possible where this need not be the case.

For light traversing the sample path, the amplitudes in FIG. 2 combine to give

$${A}_{S} = \sqrt{{R}_{bs}^{S}} {e}^{{iφ}_{bs}^{Rs}} \sqrt{{R}_{S}} {e}^{{iφ}_{S}} \sqrt{{T}_{bs}^{S}} {e}^{{φ}_{bs}^{Ts}} {e}^{( i 2 π {d}_{s} / λ )} , \qquad eq . 6$$

whereas light traversing the reference path combines to give

$${A}_{M} = \sqrt{{T}_{bs}^{M}} {e}^{{iφ}_{bs}^{Tm}} \sqrt{{R}_{M}} {e}^{{iφ}_{M}} \sqrt{{R}_{bs}^{M}} {e}^{{iφ}_{bs}^{Rm}} {e}^{( i 2 π {d}_{m} / λ )} . \qquad eq . 7$$

In eqs. 6 and 7, dₛ and dₘ are the total distances traversed by light travelling the sample and reference paths, respectively. The intensity at the detector is then

I_{Det}=I₀·(A_{S}+A_{M})·(A_{S}+A_{M}) eq. 8

where the star denotes the complex conjugate operation which, in this case, simply has the effect of negating the arguments of the exponentials. After performing the multiplications and some simplification, Eq. 8 becomes

$$\begin{matrix}{I}_{Det} = {I}_{Det , S} + {I}_{Det , M} + 2 \sqrt{{I}_{Det , S} {I}_{Det , M}} cos \{ ( {φ}_{bs}^{Rs} - {φ}_{bs}^{Rm} ) + ( {φ}_{bs}^{Ts} - {φ}_{bs}^{Tm} ) + \frac{2 π}{λ} ( {d}_{S} - {d}_{M} ) + ( {φ}_{S} - {φ}_{M} ) \} , & eq . 9 \\ where & \\ {I}_{Det , S} = {I}_{0} {R}_{bs}^{S} {R}_{S} {T}_{bs}^{S} & eq . 10 \\ and & \\ {I}_{Det , M} = {I}_{0} {T}_{bs}^{M} {R}_{M} {T}_{bs}^{M} & eq . 11\end{matrix}$$

are the intensities detected when only the sample shutter 204 is open (I_{Det,S}), and only the reference shutter 207 is open (I_{Det,M}).

It is useful to combine all of the terms in the phase argument in eq. 9 that do not depend on the measured sample:

$${φ}_{M}^{′} = ( {φ}_{bs}^{Rs} - {φ}_{bs}^{Rm} ) + ( {φ}_{bs}^{Ts} - {φ}_{bs}^{Tm} ) + \frac{2 π}{λ} ( {d}_{S} - {d}_{M} ) - {φ}_{M} \qquad eq . 12$$

so eq. 9 becomes

I_{Det}=I_{Det,S}+I_{Det,M}+2\sqrt{I_{Det,S}I_{Det,M}} cos(φ_{S}+φ_{M}′) eq. 13

Note that all of the quantities in eq. 13 will typically be wavelength dependent.

For the embodiment shown in FIG. 2, the development up to eq. 13 is only strictly valid for a non-polarizing beam splitter. However, it will be shown in an Appendix B that if a polarizing beam splitter is used with un-polarized incident light, eq. 13 will still result, provided the beam splitter is symmetric. That is, R_{bs}^{Rs,s}=R_{bs}^{Rm,s}, φ_{bs}^{Rs,s}=φ_{bs}^{Rm,s} R_{bs}^{Rs,p}=R_{bs}^{Rm,p}, φ_{bs}^{Rs,p}=φ_{bs}^{Rm,p}, T_{bs}^{Ts,s}=T_{bs}^{Tm,s}, φ_{bs}^{Ts,s}=φ_{bs}^{Tm,s} T_{bs}^{Ts,p}=T_{bs}^{Tm,p}, φ_{bs}^{Ts,p}=φ_{bs}^{Tm,p}, where in the second superscript, s and p represent polarization perpendicular to and parallel to the plane of incidence on the beam splitter, respectively. For now, it is assumed that for the embodiment shown in FIG. 2, the beam splitter is either non-polarizing or symmetric.

Solving for the sample reflection phase:

$${φ}_{S} = {cos}^{- 1} \{ \frac{{I}_{Det} - {I}_{Det , S} - {I}_{Det , M}}{2 \sqrt{{I}_{Det , S} {I}_{Det , M}}} \} - {φ}_{M}^{′} , \qquad eq . 14$$

where φ_{S}+φ_{M}′ is determined to within an integral factor of 2π. The inverse cosine operation in eq. 14 actually maps the π to 2π values of the original phase back on the 0 to π interval. However, there are methods for recovering the original phase over the entire 0 to 2π interval. For now, we ignore the ambiguity and present methods for removing it in an appendix A.

At this point, I_{Det}, I_{Det,S}, and I_{Det,M} are quantities that can be measured—I_{Det} with both shutters 204, 207 open, and I_{Det,S} and I_{Det,M} with only the sample shutter 204 and reference shutter 207 open, respectively. The quantity φ_{M}′ is unknown, but since it does not depend on the sample surface, it can be cancelled by measuring eq. 14 for two samples and taking the difference:

$${φ}_{S}^{( 1 )} - {φ}_{S}^{( 2 )} = {cos}^{- 1} \{ \frac{{I}_{Det}^{( 1 )} - {I}_{Det , S}^{( 1 )} - {I}_{Det , M}}{2 \sqrt{{I}_{Det , S}^{( 1 )} {I}_{Det , M}}} \} - {cos}^{- 1} \{ \frac{{I}_{Det}^{( 2 )} - {I}_{Det , S}^{( 2 )} - {I}_{Det , M}}{2 \sqrt{{I}_{Det , S}^{( 2 )} {I}_{Det , M}}} \} . \qquad eq . 15$$

All quantities on the right hand side of eq. 15 are measurable with either sample 1 or sample 2 in the sample arm, and one or both shutters 204, 207 open as appropriate. In this way, eq. 15 gives a way to directly measure the phase difference between samples 1 and 2. Eq. 15 also makes the assumption that the reference path does not change, as long as the two samples are measured reasonably close together in time.

To measure the absolute phase change on reflection of an unknown sample, a known calibration sample can be employed. The reflectance magnitude and phase for the known calibration sample can be calculated from the optical properties and thicknesses of the substrate and any films on the calibration sample (using, for example, the techniques in Spectroscopic Ellipsometry and Reflectometry, H. G. Tompkins and W. A. McGahan, John Wiley & Sons, New York, 1999). Knowledge of the film structure and optical properties of the calibration sample can be enhanced by pre-characterization using alternate metrology techniques, or via the methods disclosed in U.S. Pat. No. 7,282,703 and U.S. patent application Ser. Nos. 11/418,846 and 11/789,686, the disclosures of which are incorporated herein by reference in their entirety. Then, for a given unknown sample, eq. 15 can be rearranged with the unknown sample in place of sample 1 and the calibration sample in place of sample 2 to give

$${φ}_{S} = {cos}^{- 1} \{ \frac{{I}_{Det} - {I}_{Det , S} - {I}_{Det , M}}{2 \sqrt{{I}_{Det , S} {I}_{Det , M}}} \} + {φ}_{Cal} - {cos}^{- 1} \{ \frac{{I}_{Det}^{( Cal )} - {I}_{Det , S}^{( Cal )} - {I}_{Det , M}}{2 \sqrt{{I}_{Det , S}^{( Cal )} {I}_{Det , M}}} \} , \qquad eq . 16$$

where the Cal superscript refers to the known calibration sample. Note that the calibration has effectively determined the sample-independent phase component:

$${φ}_{M}^{′} = {cos}^{- 1} \{ \frac{{I}_{Det}^{( Cal )} - {I}_{Det , S}^{( Cal )} - {I}_{Det , M}}{2 \sqrt{{I}_{Det , S}^{( Cal )} {I}_{Det , M}}} \} - {φ}_{Cal} . \qquad eq . 17$$

The magnitude of the calibration sample reflectance can be used to determine the reflectance magnitude of the unknown sample using the sample arm:

$${R}_{S} = \frac{{I}_{Det , S}}{{I}_{Det , S}^{Cal}} {R}_{cal} . \qquad eq . 18$$

It is assumed that none of the quantities other than I_{Det} and I_{Det,S} change after the calibration procedure, which is true over reasonably short periods (usually a few minutes to a couple of hours). Calibrations can be done periodically to account for system drift over time. With these assumptions, the reflectance magnitude from eq. 18 can be augmented with reflection phase information via eq. 16 with only the additional measurement of I_{Det}, so that the total measurement time is essentially the same as would be required for two successive reflectance magnitude measurements.

Until now, the assumption of fully coherent, monochromatic light has been used. In reality, a variety of effects, including partial coherence, will cause the interference amplitude to differ from that given in eq. 13. This effect can be accounted for by imposing a wavelength dependent coherence factor on the interference term in eq. 13:

I_{Det}=I_{Det,S}+I_{Det,M}+2\sqrt{I_{Det,S}I_{Det,M}}F(λ)cos(φ_{S}+φ_{M}′). eq. 19

The coherence factor can be thought of as serving a similar function as the fringe visibility function from white light interferometry (see, e.g., Optical Interferometry—Second Edition, P. Hariharan, Academic Press, Amsterdam, 2003). However, in this case the wavelength dependence is stressed and the factor is allowed to account for a variety of wavelength-dependent modifications of the interference amplitude from the ideal. The modulating effects can include partial coherence, deviations of the optical beam paths from ideal collimated paths (e.g. focused beams with a range of incident angles), finite spectrometer bandwidth, etc. The exact form of F(λ) is unimportant since its effects will be accounted for by a calibration procedure described below. The only assumption made is that the sample dependence of the interference amplitude in eq. 19 is contained in I_{Det,S}, so that F(λ) is independent of the measurement sample. Additionally, F(λ) is assumed to be real.

Solving eq. 19 for the sample phase,

$${φ}_{S} = {cos}^{- 1} \{ \frac{{I}_{Det} - {I}_{Det , S} - {I}_{Det , M}}{2 F ( λ ) \sqrt{{I}_{Det , S} {I}_{Det , M}}} \} - {φ}_{M}^{′} \qquad eq . 20$$

Using two known samples and taking the phase difference,

$${φ}_{cal}^{( 1 )} - {φ}_{cal}^{( 2 )} = {cos}^{- 1} \{ \frac{{I}_{Det}^{( 1 )} - {I}_{Det , S}^{( 1 )} - {I}_{Det , M}}{2 F ( λ ) \sqrt{{I}_{Det , S}^{( 1 )} {I}_{Det , M}}} \} - {cos}^{- 1} \{ \frac{{I}_{Det}^{( 2 )} - {I}_{Det , S}^{( 2 )} - {I}_{Det , M}}{2 F ( λ ) \sqrt{{I}_{Det , S}^{( 2 )} {I}_{Det , M}}} \} . \qquad eq . 21$$

The phase difference on the left hand side of eq. 21 is known, and all quantities on the right hand side are measured except for F(λ). F(λ) can be found for each λ by simply assuming values between 0 and 1 and computing the right hand side of eq. 21 until it agrees with the known phase difference. Now a calibration for φ_{M}′ using one of the standards or even a completely different calibration sample can be done, and subsequent unknown samples can be measured as before using the now known function F(λ):

$${φ}_{S} = {cos}^{- 1} \{ \frac{{I}_{Det} - {I}_{Det , S} - {I}_{Det , M}}{2 F ( λ ) \sqrt{{I}_{Det , S} {I}_{Det , M}}} \} + {φ}_{Cal} - {cos}^{- 1} \{ \frac{{I}_{Det}^{( Cal )} - {I}_{Det , S}^{( Cal )} - {I}_{Det , M}}{2 F ( λ ) \sqrt{{I}_{Det , S}^{( Cal )} {I}_{Det , M}}} \} , \qquad eq . 22$$

where again the superscript Cal refers to a known calibration sample. F(λ) may be determined more definitively by adding a third known sample, to form the known phase differences

$$\begin{matrix}{φ}_{Cal}^{( 1 )} - {φ}_{Cal}^{( 3 )} = {cos}^{- 1} \{ \frac{{I}_{Det}^{( 1 )} - {I}_{Det , S}^{( 1 )} - {I}_{Det , M}}{2 F ( λ ) \sqrt{{I}_{Det , S}^{( 1 )} {I}_{Det , M}}} \} - {cos}^{- 1} \{ \frac{{I}_{Det}^{( 3 )} - {I}_{Det , S}^{( 3 )} - {I}_{Det , M}}{2 F ( λ ) \sqrt{{I}_{Det , S}^{( 3 )} {I}_{Det , M}}} \} , & eq . 23 \\ and & \\ {φ}_{Cal}^{( 2 )} - {φ}_{Cal}^{( 3 )} = {cos}^{- 1} \{ \frac{{I}_{Det}^{( 2 )} - {I}_{Det , S}^{( 2 )} - {I}_{Det , M}}{2 F ( λ ) \sqrt{{I}_{Det , S}^{( 2 )} {I}_{Det , M}}} \} - {cos}^{- 1} \{ \frac{{I}_{Det}^{( 3 )} - {I}_{Det , S}^{( 3 )} - {I}_{Det , M}}{2 F ( λ ) \sqrt{{I}_{Det , S}^{( 3 )} {I}_{Det , M}}} \} . & eq . 24\end{matrix}$$

Eqs. 23 and 24 can be analyzed simultaneously with eq. 21 to solve for F(λ). In addition to providing more data to facilitate and compliment the determination of F(λ), the multiple phase differences also provide overlap so that F(λ) can still be determined in wavelength regions where some of the sample intensities may fall to zero (see below).

The function F(λ) also depends strongly on the path difference between reference and sample arms. If the paths are too different, there will be no interference. This is a major reason it may be desirable to include a compensating plate in the sample path to account for the fact that the two beams take different paths through the beam splitter 202. Additionally, it is desirable that the factor dₛ−dₘ in eq. 12 be less than the coherence length of the broad band source light. It is desirable to have dₛ−dₘ as close to zero as possible, and certainly less than a few microns.

The calibration procedure outlined above negates the need for a cumbersome analysis of the reflectometer optics. It is desirable to continue this philosophy by simply including a motor control capable of adjusting the path-length of one of the arms.

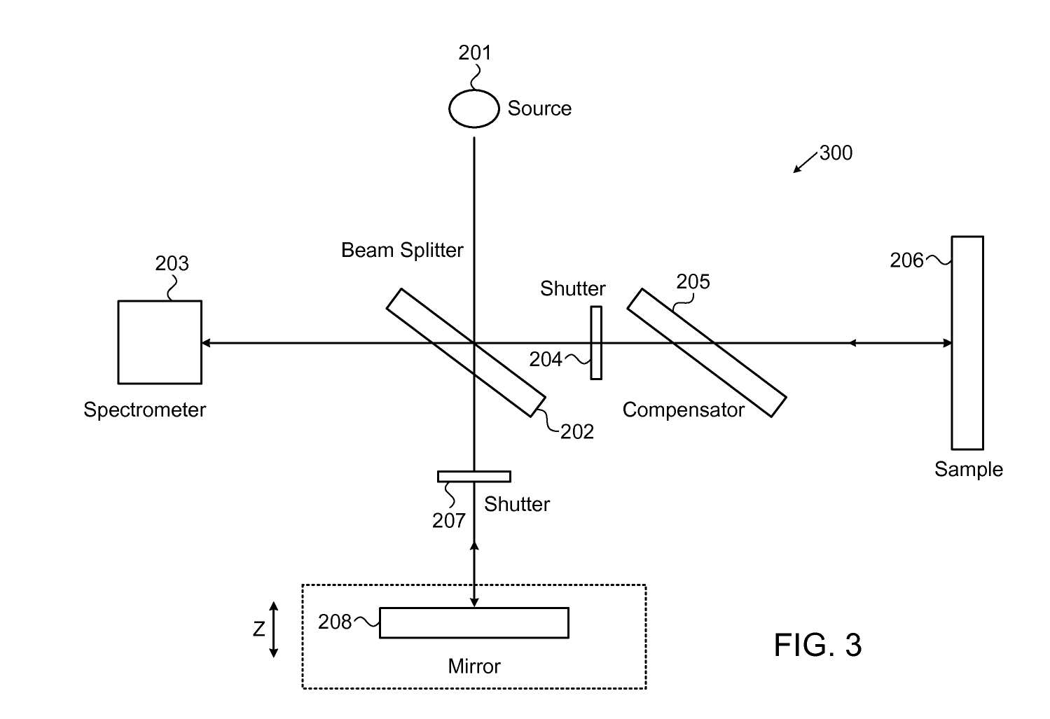

FIG. 3 schematically shows this functionality added to the reference arm. FIG. 3 shows a block diagram of a system 300 illustrating control over the path length of the reference arm. FIG. 3 shows a light source 201, beam splitter 202, a sample 206, a sample shutter 204, a reference shutter 207, a compensator 205, a mirror 208, and a spectrometer 203, which operate as discussed above in FIG. 2. Then, during the calibration procedure for determining F(λ), the path length difference dₛ−dₘ can be adjusted until maximum interference visibility over the widest wavelength range possible is observed. A simple criteria would be to take any sample 106 or collection of samples and observe the difference between I_{Det} and the quantity (I_{Det,S}+I_{Det,M}). The more these two quantities differ, the better the visibility. Once a suitable path difference is found, it can be fixed for the determination of F(λ), φ_{M}′, and all subsequent measurements. While for an ideal system the path difference would presumably be close to zero, the exact value of the resulting dₛ−dₘ need never be known. dₛ−dₘ can be periodically readjusted as needed. Note that the path difference is not continuously varied during measurement, as is done by a typical optical profiler. The current disclosure benefits from wavelength-dependent interference as opposed to interference that is a function of path difference.

Due to inevitable small irregularities in the optics system, the ideal path length may be wavelength dependent. Accordingly, it may be advantageous to determine a wavelength range, 120-220 nm for example, where phase sensitivity is most important for determining film properties. The path length dₛ−dₘ can be adjusted experimentally to maximize the interference condition in the 120-220 nm range at the expense of other, less important wavelength regions. In some of the examples given below, it is actually desirable to combine reflectance phase at visible wavelength ranges with reflectance magnitude at VUV wavelength ranges. In this case, the path difference may be adjusted to maximize interference properties in the 400-800 nm range. Such optimization will have no effect on the determination of VUV reflectance magnitude, which can proceed in the usual manner.

Going back to the general form of the inverse cosine argument of eq. 14 or eq. 20, the reference and calibration materials can always be chosen such that I_{Det,M} and I_{Det,S}^{(Cal)} are nonzero over the entire wavelength range. However, in some situations there may be wavelength regions where I_{Det,S} is close to zero. In such cases, the inverse cosine argument will tend to 0/0, and the phase is impossible to determine. Since there is a wide wavelength range of information in a typical sample dataset of the preferred embodiment, regions where the phase cannot be determined can be simply dropped from the analysis. In addition, for ultra-thin films where the techniques disclosed herein are expected to provide the most benefit, the sample intensity is rarely zero in a typical 120-800 nm measurement range.

Additionally, while the final result for phase is independent of the path length difference, the uncertainty of the phase argument does increase at the interference extrema, when the value of the cosine function is −1 and 1. This can adversely affect the measured film parameter results, especially when interference extrema occur at wavelength regions that are important for the analysis. In such cases, the path difference can be adjusted to shift the extrema to wavelength ranges where the impact is less important, or even outside the measurement range entirely. An example is given later.

Generally, the quality of the phase data depends on the value of the total phase argument φ_{S}+φ_{M}′, and the strength of the interference signal depends on the value of F(λ). Since φ_{S} is determined independently of φ_{M}′ through use of the calibration sample, it is beneficial in practice to adjust the total phase argument via dₛ−dₘ to optimize the sample phase signal quality at a specific wavelength range of interest.

Techniques related to measurement of an unknown sample are now discussed. Generally, when discussing intensity measurements it is assumed that standard operations like subtracting out electronic dark noise, background measurements, or correcting for stray light effects have been implemented, where required. These procedures may vary from configuration to configuration and also depend on the spectrometer and detector used. We do not explicitly state these additional steps in this description, but assume that whatever steps are necessary are carried out when obtaining measured intensity values.

A measurement of sample properties using one embodiment of the techniques disclosed herein proceeds as follows. First, a series of calibration samples are placed on the sample stage, one after the other. The calibration samples should have relatively simple film structures. To the extent that the film properties are well-known in the literature, these properties can be assumed. Remaining unknown properties can be pre-characterized using any metrology that is appropriate. For example, a set of calibration samples may include a native SiO₂/Si and several thermal SiO₂/Si samples. The thermal SiO₂/Si samples may have different thicknesses, say 250 Å SiO₂/Si, 500 Å SiO₂/Si, and 1000 Å SiO₂/Si, etc. The optical properties n and k for Si and SiO₂ may be regarded as known. An interface layer between SiO₂ and Si may be included in the model. The exact thicknesses can be determined using a standard reflectance or ellipsometric measurement, after which the calibration samples may be regarded as known.

Knowing the optical properties of Si and SiO₂ and thicknesses of the SiO₂ layers, reflectance and phase can be computed for each of the calibration samples using standard thin film algorithms (see, as before, Spectroscopic Ellipsometry and Reflectometry, H. G. Tompkins and W. A. McGahan, John Wiley & Sons, New York, 1999). The path difference dₛ−dₘ can be adjusted so that the interference amplitude is optimized for one or more of the calibration samples. The criteria for optimization can simply consist of summing the quantity (I_{Det}−I_{Det,S}−I_{Det,M})² over the wavelength range of interest. The summation can include data from several of the calibration samples. dₛ−dₘ is adjusted so that the sum is maximized.

Next, two or more of the calibration samples are used to determine F(λ). If only two calibration samples are measured, then eq. 21 can be used to determine F(λ). If multiple samples are used, the procedure described for eqs. 23 and 24 can be used. The procedure to determine the optimal path difference and F(λ) need only be occasionally performed, and should not influence production metrics such as tool measurement throughput.

Now the tool is ready for production operation, and a single calibration sample selected for routine calibration. A convenient choice is the native SiO₂/Si sample. The calibration sample is put in the sample arm periodically and I_{Det}^{(Cal)}, I_{Det,S}^{(Cal)} and I_{Det,M} are measured. These quantities change slowly compared to the time required for sample measurement, and the calibration need be done only as often as required by system drift. In many cases, a calibration every one or two hours is sufficient. The calibration, along with the known calibration sample phase, can be used to provide the factor

$${φ}_{Cal} - {cos}^{- 1} \{ \frac{{I}_{Det}^{( Cal )} - {I}_{Det , S}^{( Cal )} - {I}_{Det , M}}{2 F ( λ ) \sqrt{{I}_{Det , S}^{( Cal )} {I}_{Det , M}}} \} \qquad eq . 25$$

as well as I_{Det,M} for subsequent sample measurements.

Unknown samples can now be placed in the sample arm and measured by collecting two separate intensities: I_{Det} with both shutters open and I_{Det,S} with the sample shutter open. There is now enough information to calculate the reflectance phase (called simply “phase” form here on out) of the unknown sample from eq. 22 and the reflectance magnitude (called simply “reflectance”) from eq. 18. Each sample collection requires the same amount of time as a standard reflectance measurement, which is typically only a few seconds. Phase and reflectance of an unknown sample can be obtained in the same amount of time as would be required for two successive reflectance measurements. More unknown samples can be measured until a new calibration to re-determine eq. 25 is required.

Each sample measurement results in the sample reflectance and phase spectra throughout the measured range. For a VUV-NIR tool for example, the measured range might be 120-800 nm, although the range could include longer and shorter wavelengths. Now, unlike the known calibration samples, at least some of the properties of the sample film structure are unknown. For example, for an ultrathin SiON film structure on silicon substrate, the optical properties of the silicon substrate may be known, but the thickness and composition of the SiON film are not. The composition of an ultrathin SiON film can often be adequately treated using a Bruggeman EMA combination of SiO₂ and SiN (silicon nitride), and the composition monitored via the EMA mixing fraction. Therefore, a theoretical model of the system consists of the known Si, SiO₂, and SiN optical properties, and the as yet unknown SiON thickness and EMA mixing fraction. The procedure for inverting measured optical data to extract the unknown parameters, given a nominal film model, is well-known in the art. The Levenberg-Marquardt regression algorithm (a description can be found in W.H. Press, S. A. Teukolsky, W. T. Vetterling, and B. P. Flannery, Numerical Recipes in C: The Art of Scientific Computing (2^{nd} Edition), Cambridge University Press, Cambridge, 1992) can be used to optimize the unknown parameters by minimizing a merit function:

$${χ}^{2} = {\sum }_{i = 1}^{Nr} {( \frac{1}{{σ}_{i}^{r}} )}^{2} {( {R}_{i , m} - {R}_{i , c} )}^{2} + {\sum }_{j = 1}^{Np} {( \frac{1}{{σ}_{j}^{p}} )}^{2} {( {φ}_{j , m} - {φ}_{j , c} )}^{2} , \qquad eq . 26$$

where R_{i,m} is the reflectance measured for data point i, R_{i,c} is the calculated reflectance for data point i, σⱼ^{r} is the assumed measurement uncertainty for data point i, φ_{j,m} is the phase measured at data point j, φ_{j,c} is the phase calculated for data point j, Nᵣ is the total number of reflectance data points, and Nₚ is the total number of phase data points. The data points in eq. 26 are for different incidence conditions, which is usually wavelength. The regression procedure adjusts the unknown parameters and regenerates R_{i,c} and φ_{j,c} until the value of the merit function is minimized, and the resulting optimized parameters for SiON EMA mixing fraction and film thickness are the result of the measurement. The procedure can obviously be generalized to multiple layer stacks of films having complicated optical dispersions, such as Cauchy, Sellmeier, Tauc-Lorentz, etc. 2-D and 3-D structures can be measured as well, particularly gratings, where the calculation is performed using diffraction algorithms such as the rigorous coupled wave (RCW) method.

A point was made earlier that the path difference may be adjusted to optimize some measurements. Obviously, if this is done, F(λ) and eq. 25 need to be re-determined. However, after experimentation the optimal value for dₛ−dₘ is likely already known for a particular measurement, and this can be used to predetermine F(λ) as before. Now, there is potentially a separate F(λ) for each measurement recipe (there is normally a separate recipe for each production product—this is true of all optical metrology tools). The value of F(λ) can be stored and used in eqs. 25 and 22 at measurement time whenever the specific product with adjusted path difference is measured. Eq. 25 will need to be re-determined by a standard system calibration whenever dₛ−dₘ changes, however.

The complimentary nature of reflectance magnitude and reflectance phase is now illustrated using a few simulated examples. In the first examples, ideal, noiseless spectra will be assumed.

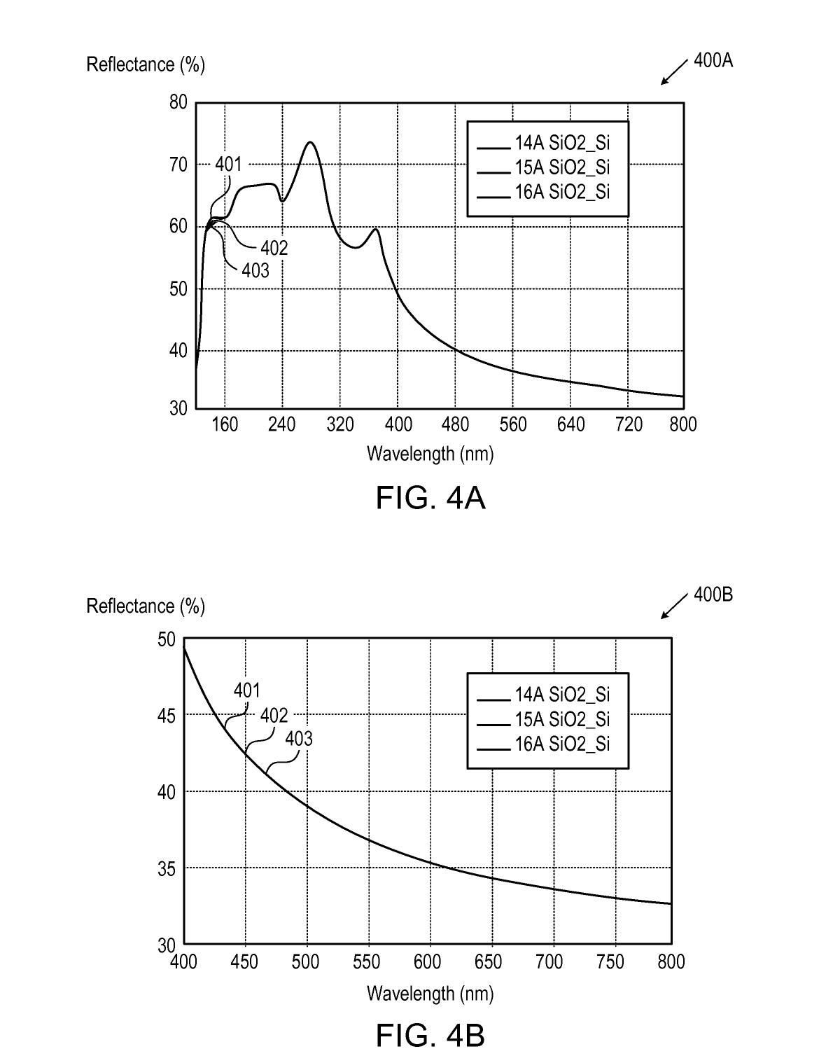

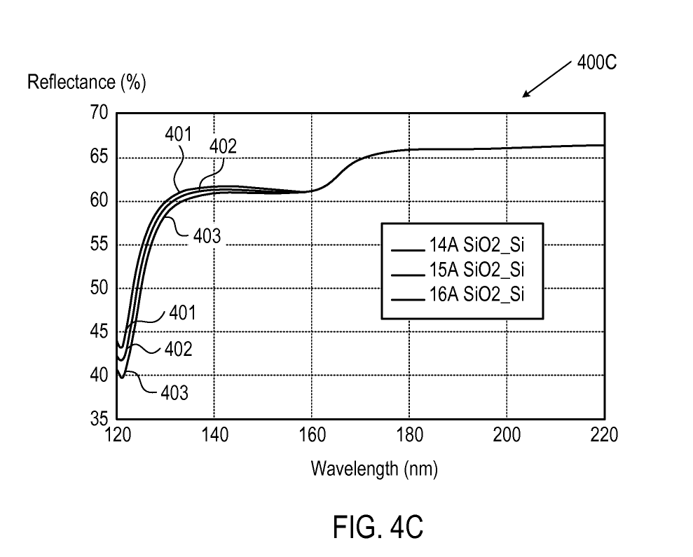

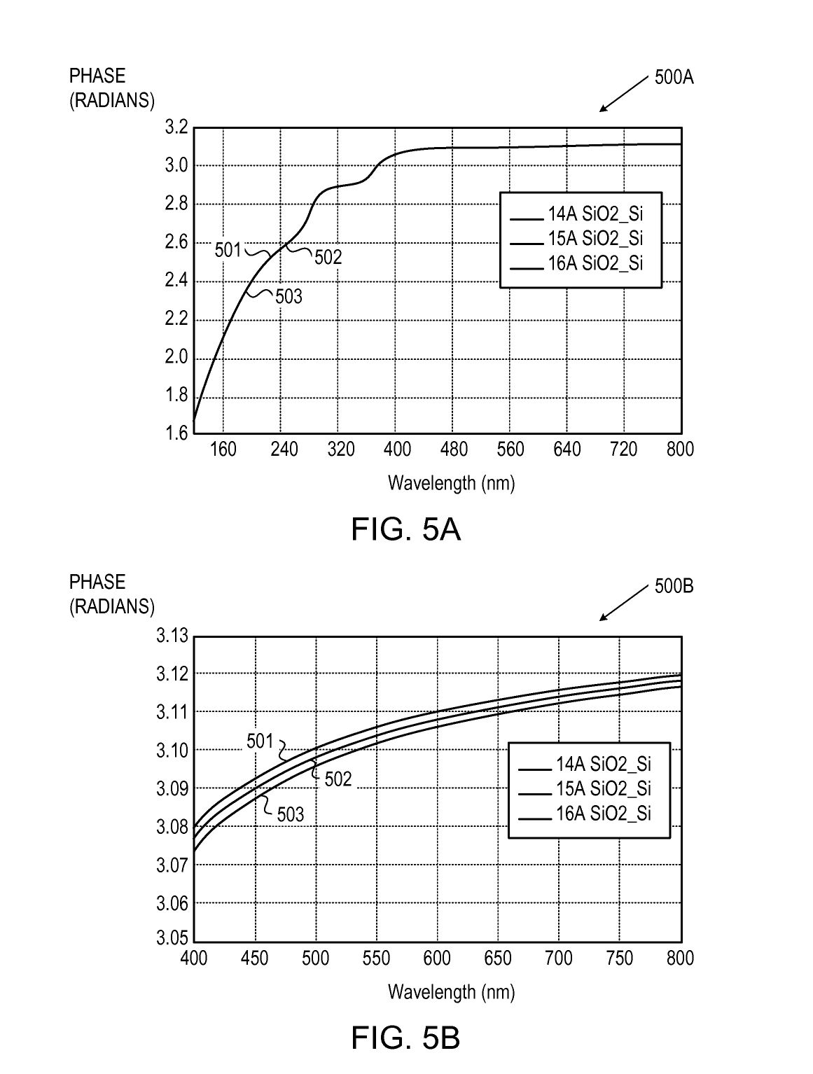

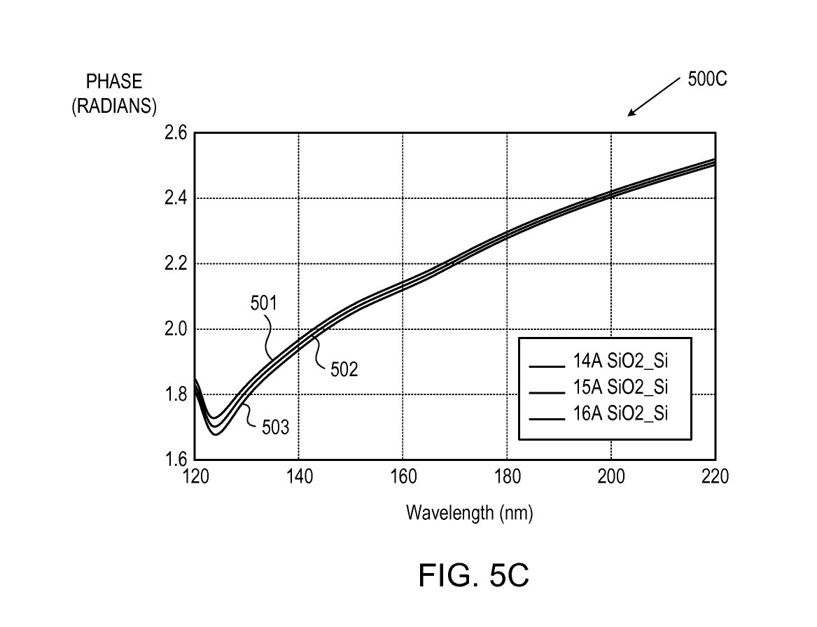

FIGS. 4A-4C and 5A-5C show reflectance and phase for a structure of ultra-thin SiO₂/Si. FIG. 4A is a graph illustrating reflectance for 120-800 nm 400A. FIG. 4A shows 120-800 nm reflectance for 14 Å SiO₂/Si 401, 15 Å SiO₂/Si 402, and 16 Å SiO₂/Si 403 film structures. FIG. 4B is a graph illustrating reflectance for 400-800 nm 400B. In FIG. 4B, reflectance is shown for 14 Å SiO₂/Si 401, 15 Å SiO₂/Si 402, and 16 Å SiO₂/Si 403 film structures. FIG. 4B shows the 400-800 nm region, where the samples are indistinguishable, and reflectance metrology of this structure using 400-800 nm light is impossible. FIG. 4C is a graph illustrating reflectance for 120-220 nm 400C. In FIG. 4C, reflectance for 14 Å SiO₂/Si 401, 15 Å SiO₂/Si 402, and 16 Å SiO₂/Si film structures 403 is shown. FIG. 4C shows the 120-220 nm region, where the samples are distinguishable to a degree that increases with decreasing wavelength.

FIGS. 5A, 5B and 5C show graphs illustrating the phase corresponding to the reflectance for 14 Å SiO₂/Si 501, 15 Å SiO₂/Si 502, and 16 Å SiO₂/Si 503 film structures. The 120-800 nm phase spectra for the samples are shown in FIG. 5A 500A. In this case, the samples are easily distinguished throughout the wavelength range, as can be seen for the 400-800 nm range in FIG. 5B 500B and the 120-220 nm range in FIG. 5C 500C. Again, the difference between the spectra is larger in the VUV.

The film structure in FIGS. 4A-4C and 5-5C is somewhat trivial and is used mainly to illustrate some of the differences in behavior of reflectance and phase. In fact, visible range phase only, or VUV-DUV (Deep Ultra-Violet) reflectance only would probably do an adequate job at measuring the structure. More complicated examples will show that a major advantage of having VUV-NIR (Near Infra-Red) reflectance and phase information lies in the ability to more reliably extract multiple simultaneous parameters from a film structure. For many applications, this advantage may be apparent when both reflectance and phase are used throughout the VUV-NIR range. Alternately, some applications may be better suited to either reflectance or phase at some particular wavelength range, in which case the availability of both phase and reflectance in VUV-NIR wavelength ranges translates to an ability to handle a wider suite of applications than is possible with conventional metrologies.

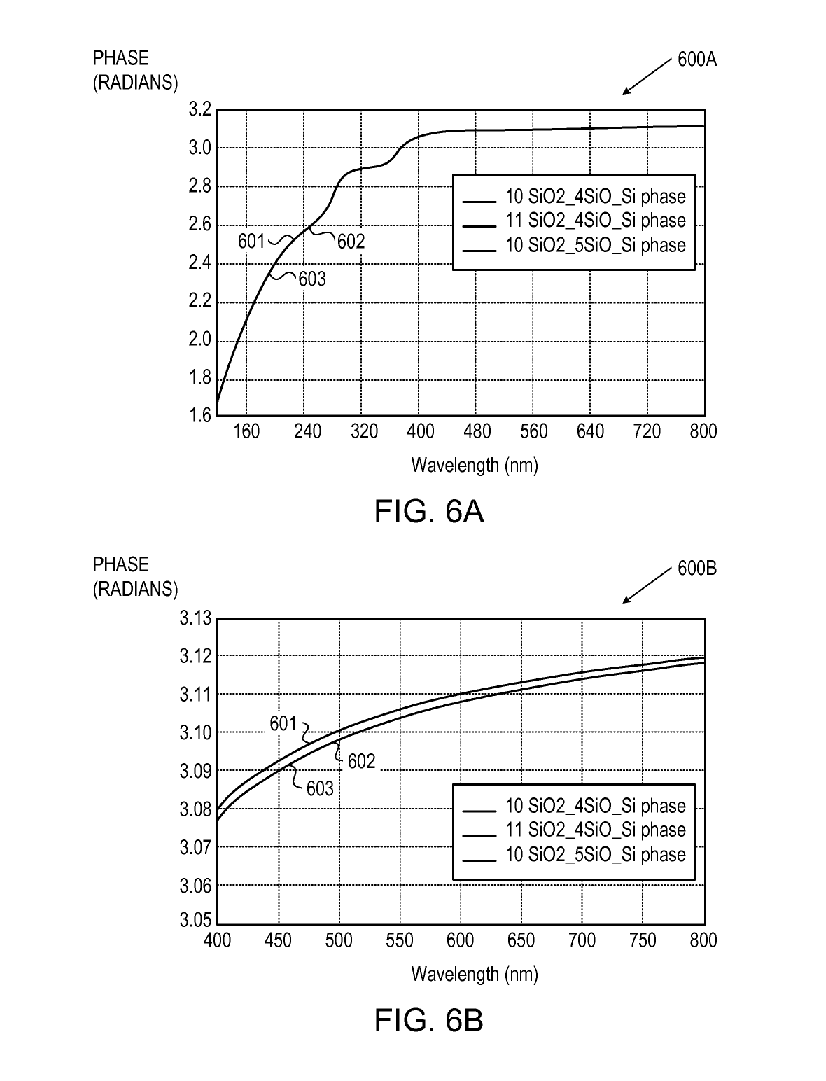

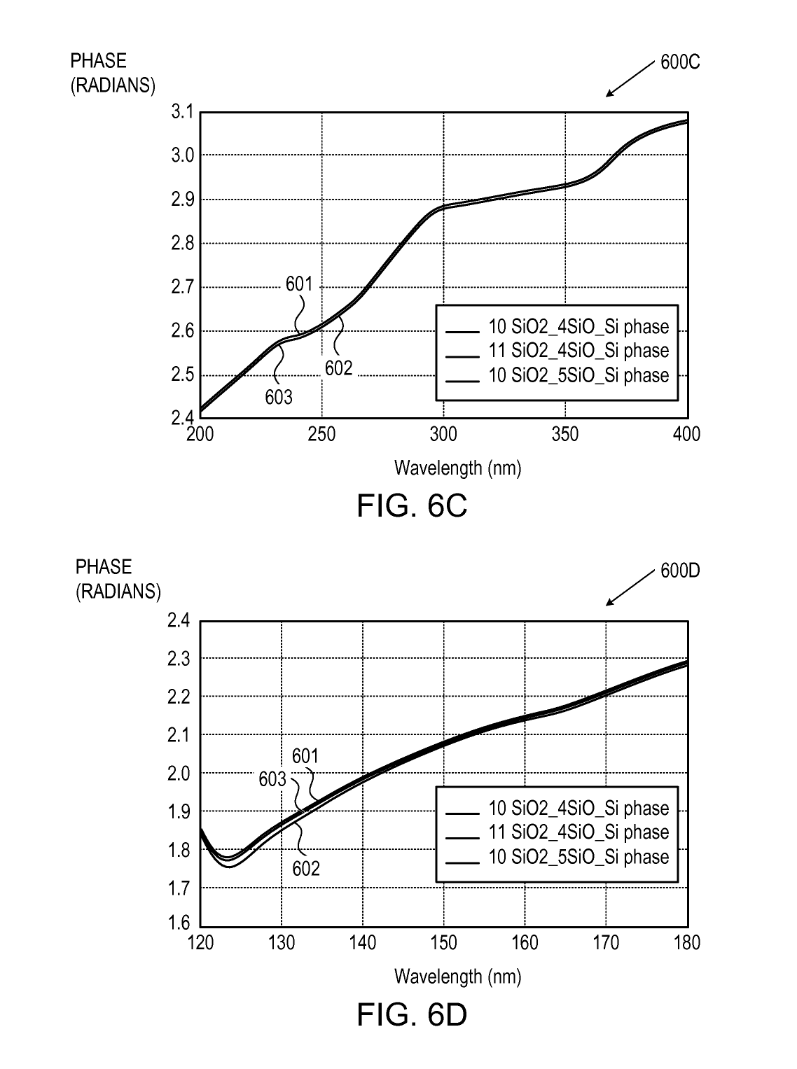

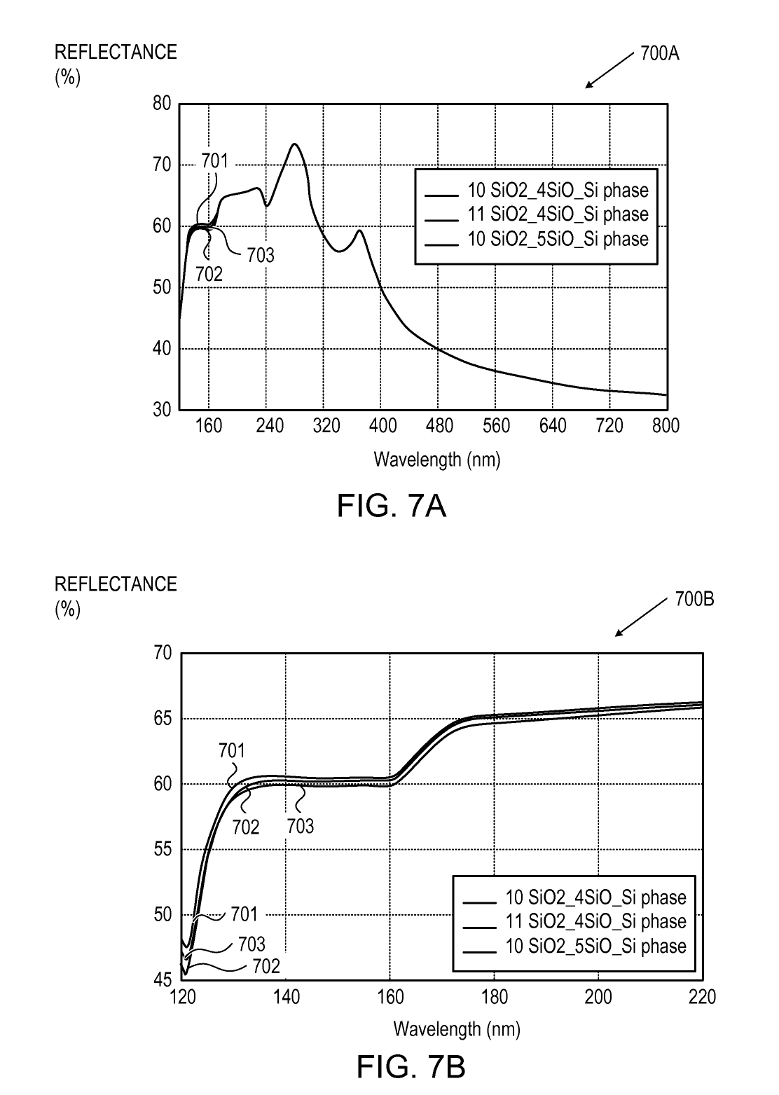

FIGS. 6A-6D and 7A-7B show reflectance and phase for a film structure of ultra-thin SiO₂ on SiO on Si. FIG. 6A compares 120-800 nm phase for 10 Å SiO₂/4 Å SiO/Si 601, 11 Å SiO₂/4 Å SiO/Si 602, and 10 Å SiO₂/5 Å SiO/Si 603 film structures 600A. FIG. 6B shows the visible wavelength range from 400-800 nm 600B. Here it is apparent that the phase can easily separate the samples having different total thickness, i.e. the 10 Å SiO₂/4 Å SiO/Si 601 sample from the 11 Å SiO₂/4 Å SiO/Si 602 and WA SiO₂/5 Å SiO/Si 603 samples, but phase differences distinguishing which layer has changed are much smaller. FIG. 6C shows a reflectance range of 200-400 nm 600C leads one to a similar conclusion. FIG. 6D shows part of the VUV region, 120-180 nm, where the three samples are clearly distinguishable 600D.

Reflectances for the same three samples (10 Å SiO₂/4 Å SiO/Si 701, 11 Å SiO₂/4 Å SiO/Si 702, and 10 Å SiO₂/5 Å SiO/Si 703 film structures) are shown in FIGS. 7A and 7B, with FIG. 7A showing the 120-800 nm range 700A, and FIG. 7B showing the 120-220 nm range 700B. In this case, the samples are completely indistinguishable in the visible region, whereas in the VUV region they can once again be distinguished. Clearly the phase information compliments the reflectance information through sensitivity to total thickness at visible wavelength ranges, while VUV regions enhance the information content of phase and reflectance, and is required in order to determine both film and interface layer properties.

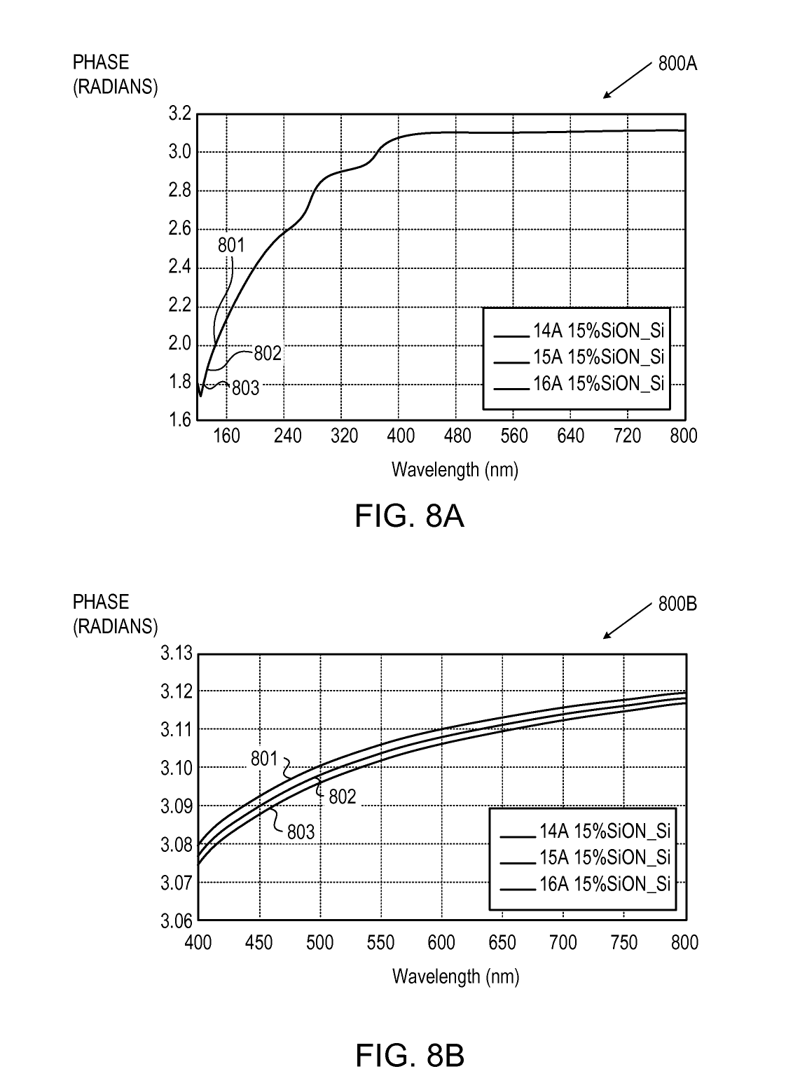

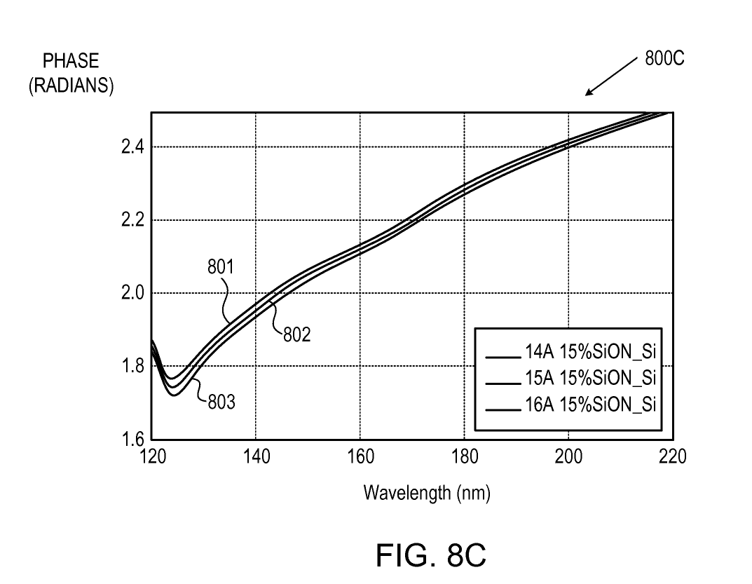

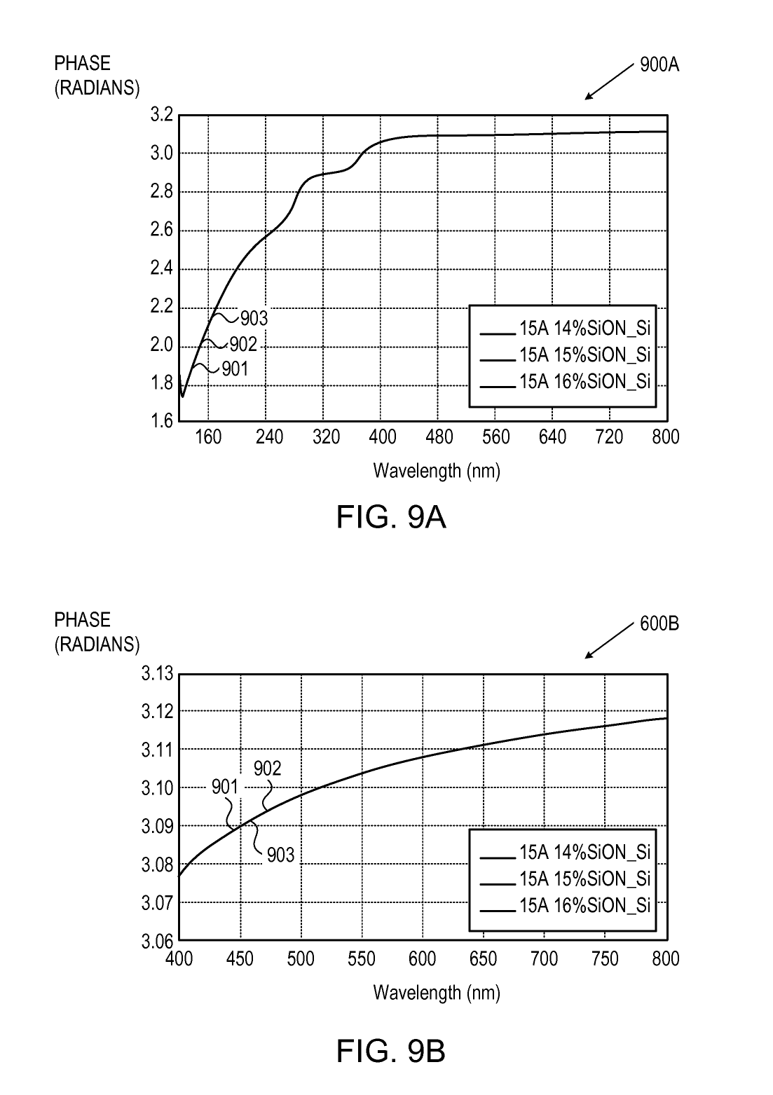

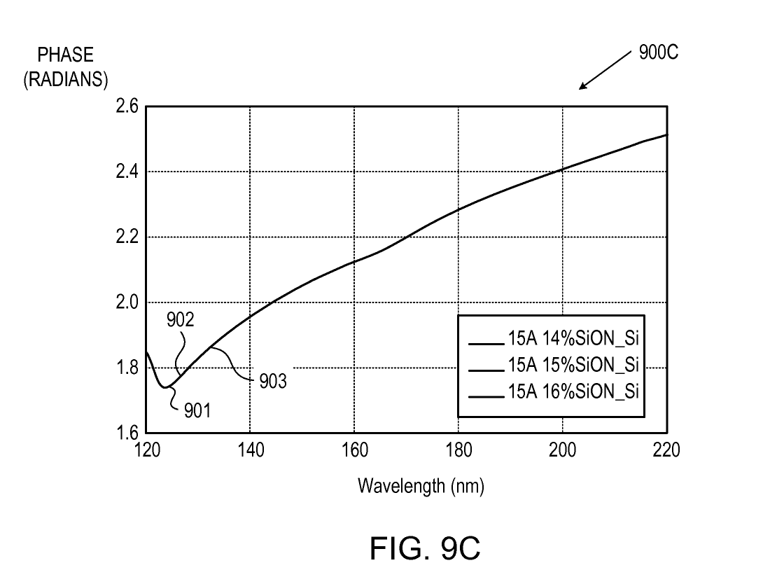

A third example is provided in FIGS. 8A, 8B, and 8C by a nominal 15 Å thick silicon oxynitride (SiON) film with 15% nitride component, as represented by a Bruggeman EMA mixture of SiN and SiO₂ films. FIG. 8A shows 120-800 nm phase spectra of 14 Å 801, 15 Å 802, and 16 Å SiON 803 films with 15% SiN component on silicon 800A. FIGS. 8B and 8C show the 400-800 nm 800B and 120-220 nm 800C wavelength ranges, respectively. FIGS. 9A-9C show the phase spectra for the same wavelength ranges, but for a 15 Å film with 14% 901, 15% 902, and 16% SiN 903 components. FIG. 9A shows phase spectra for 120-800 nm 900A, FIG. 9B shows phase spectra for 400-800 nm 900B, and FIG. 9C shows phase spectra for 120-220 nm 900C of a 15 Å film with 14% 901, 15% 902, and 16% SiN 903 components. Comparison of FIGS. 8A-8C and 9A-9C shows that the thickness changes are well-resolved in the phase spectra throughout the 120-800 nm wavelength range, while composition changes are relatively unresolved.

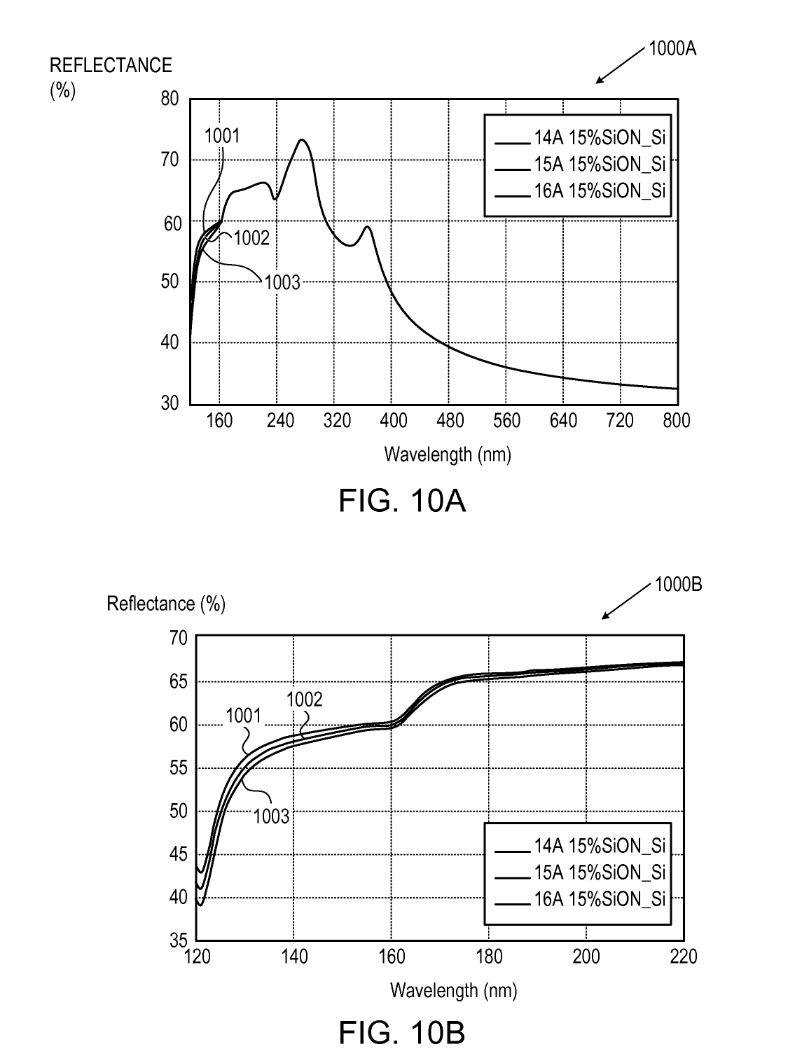

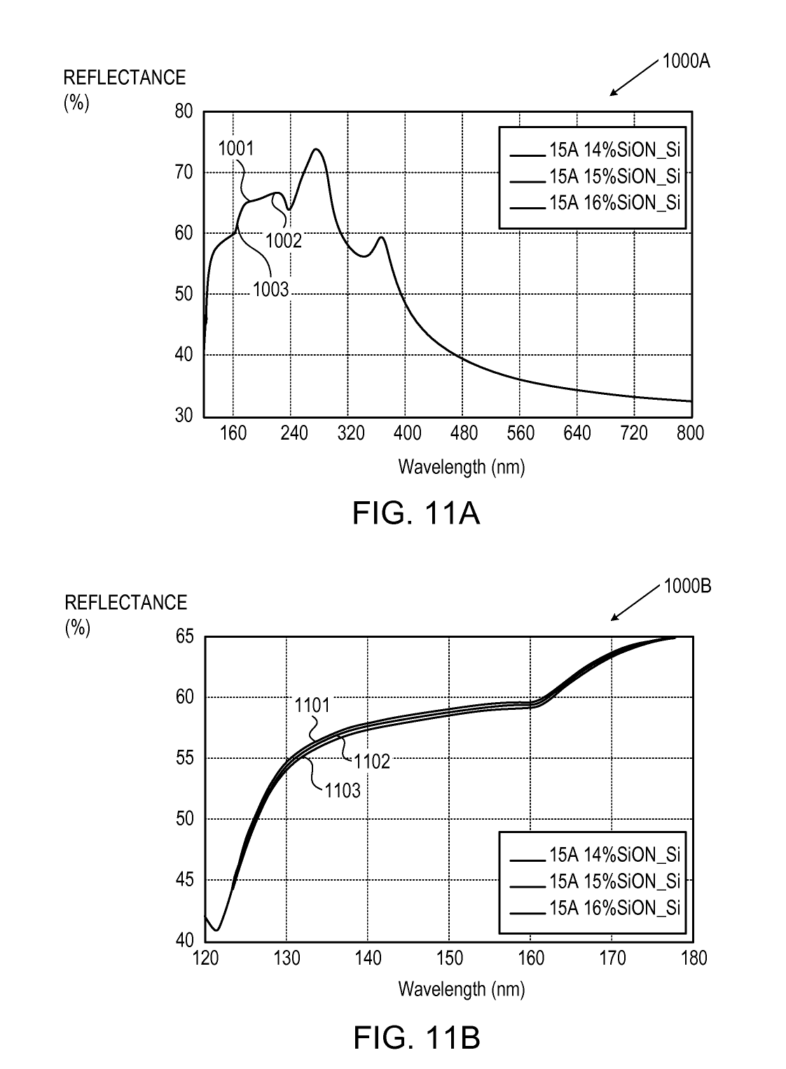

FIG. 10A shows the 120-800 nm reflectance spectra for the 14 Å 1001, 15 Å 1002, and 16 Å SiON 1003 films with 15% SiN component 1000A, while FIG. 10B shows the VUV region at 120-220 nm 1000B. FIGS. 11A and 11B show reflectance spectra for similar regions (FIG. 11A shows the reflectance spectra for 120-800 nm 1100A, and FIG. 11B shows the reflectance spectra for 120-180 nm 1100B), but for 15 Å films with 14% 1101, 15% 1102, and 16% SiN 1103 components. The reflectance changes due to thickness and composition are roughly orthogonal. This shows that VUV reflectance data can determine composition and thickness simultaneously. However, since the phase spectrum is relatively insensitive to composition, it is apparent that a way to further enhance the reflectance data might be to determine the total thickness using phase data and composition using reflectance data. Longer wavelength phase data may be used to determine thickness, since there is even less sensitivity to composition and a better signal noise may be obtained there. The thickness information determined from phase can be used along with the VUV reflectance data to determine composition, with better precision than reflectance alone.

The previous illustrations showed theoretical, noiseless data. Starting with some simple assumptions about the uncertainty in the intensity measurements, signal noise can be added to simulations of I_{Det}, I_{Det,S}, and I_{Det,M} for various film structures. The intensity signal noise will obviously be propagated to the resulting phase, determined by applying eq. 22, giving an idea of the measurement error that can be expected for a given intensity signal quality. The resulting simulations can be thought of as “simulated phase measurements”.

Thesimulations proceed as follows. First, theoretical reflectance and phase spectra are calculated using standard thin film algorithms, as was done in FIGS. 4A-11B. Theoretical reflectance and phase spectra are also calculated for the calibration sample, which is assumed to be 15 Å SiO₂/Si, and for the reference surface, assumed to be 200 Å MgF₂/3 Å Al₂O₃/Al. It is then assumed that the intensity detected when a perfectly reflecting surface (100% reflectance) is placed in the sample arm is 5000 counts, and the intensity due to a perfectly reflecting surface at the reference mirror position is 6000 counts, irrespective of wavelength. The perfect surface intensities are used to generate reflected intensities from the sample and reference surface reflectances via

I_{Det,S}=I_{perf,S}R_{S}, eq. 27

I_{Det,S}^{(Cal)}=I_{perf,S}R_{Cal,} eq. 28

and

I_{Det,M}=I_{perf,M}R_{M} eq. 29

where I_{perf,S} and I_{perf,M} are the intensities corresponding to perfectly reflecting surfaces. The actual values chosen for I_{perf,S} and I_{perf,M} are somewhat arbitrary and are of no further importance.

The results of eqs. 27-29 are used in eq. 19 to compute I_{Det} and I_{Det}^{(Cal)}. For simplicity, we assume that all terms in φ_{M}′ are negligible except for the reference surface phase and the path difference phase, so that

$${φ}_{M}^{′} = \frac{2 π}{λ} ( {d}_{S} - {d}_{M} ) - {φ}_{M} \qquad eq . 30$$

In practice, F(λ) will be pre-determined via the procedure already discussed. However, for the purpose of these simulations, the value for F(λ) will simply be assumed.

At this point, we have obtained the “actual”, noiseless values of I_{Det}, I_{Det}^{(Cal)}, I_{Det,S}, I_{Det,S}^{(Cal)}, and I_{Det,M}. However, the real intensities measured by the reflectometer will be affected by measurement error. This error can be reasonably simulated by applying a Gaussian white noise function to the noiseless intensities. The Gaussian noise function perturbs the intensity values from their ideal values by an amount consistent with a Gaussian probability distribution, and is characterized by its standard deviation, σ:

$$f ( x ) = ( \frac{1}{σ \sqrt{2 π}} ) exp ( - \frac{1}{2} {( \frac{x}{σ} )}^{2} ) . \qquad eq . 31$$

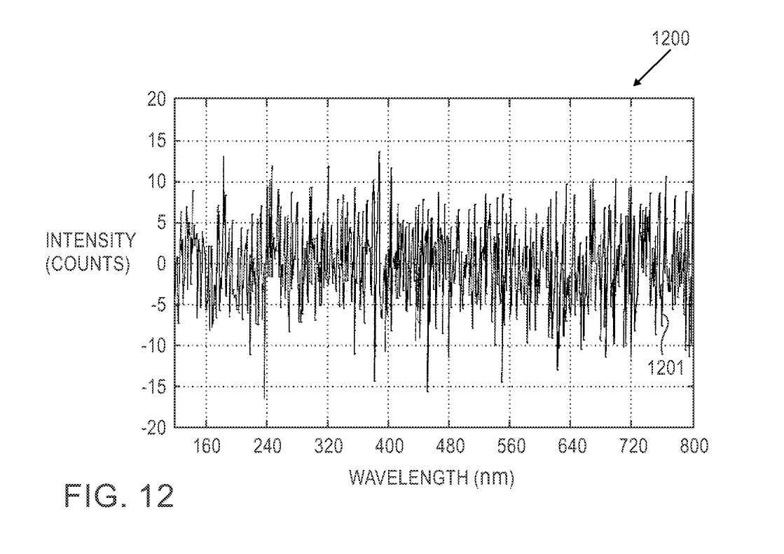

Most development packages include a noise generation routine. In particular, the “Gaussian White Noise” routine in the Labview development suite from National Instruments can be used to generate a Gaussian distributed sequence of numbers characterized by a standard deviation that are then added to the intensity data to simulate actual measured intensity data. FIG. 12 shows an example of a noise function generated by Labview's “Gaussian White Noise” routine for a standard deviation of 5 counts 1200. The noise standard deviation measurement 1201 is illustrated in FIG. 12.

It is noted that for a real measurement system where the sources of error are all random, the error in the measured data will approximately follow a Gaussian distribution. Major departures from Gaussian error are almost always due to systematic errors.

A reasonable value for a noise standard deviation can be estimated by repeated measurement of reflected intensity from either sample or reference arm (or both), and computing the standard deviation of the resulting intensity values about their means. The result is likely wavelength dependent, but a reasonable first estimate can treat the noise standard deviation as uniform with respect to wavelength. The intensities modified with noise represent more realistic simulations of what the system actually measures.

The values of I_{Det}, I_{Det}^{(Cal)}, I_{Det,S}, I_{Det,S}^{(Cal)}, and I_{Det,M} with noise added, and the theoretical value for φ_{Cal} can now be used with eq. 22 to calculate phase. Since φ_{Cal} is assumed known without error, the error in the measured phase arises from the measurement error assumed for the reflected intensities.

The phase error is wavelength dependent due to the form of eq. 22. It is also sensitive to the form of F(λ) and the value of dₛ−dₘ. The following examples illustrate the nature of the measurement error expected for phase determined using the current techniques disclosed herein.

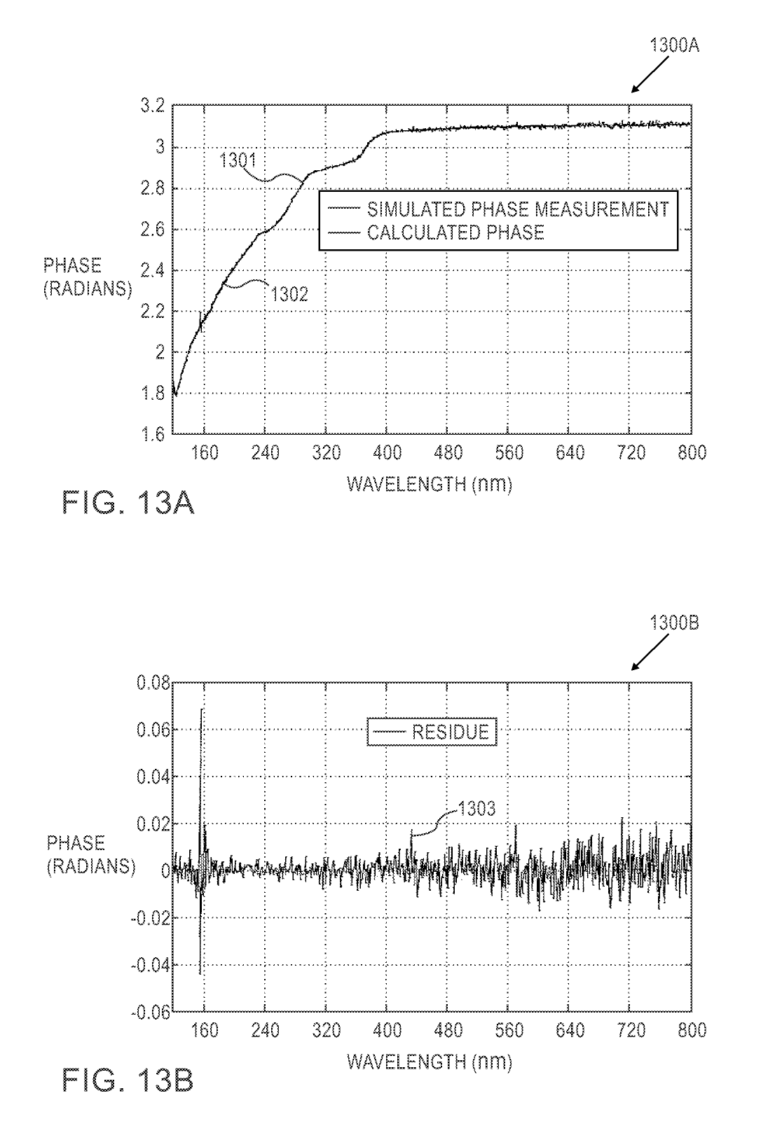

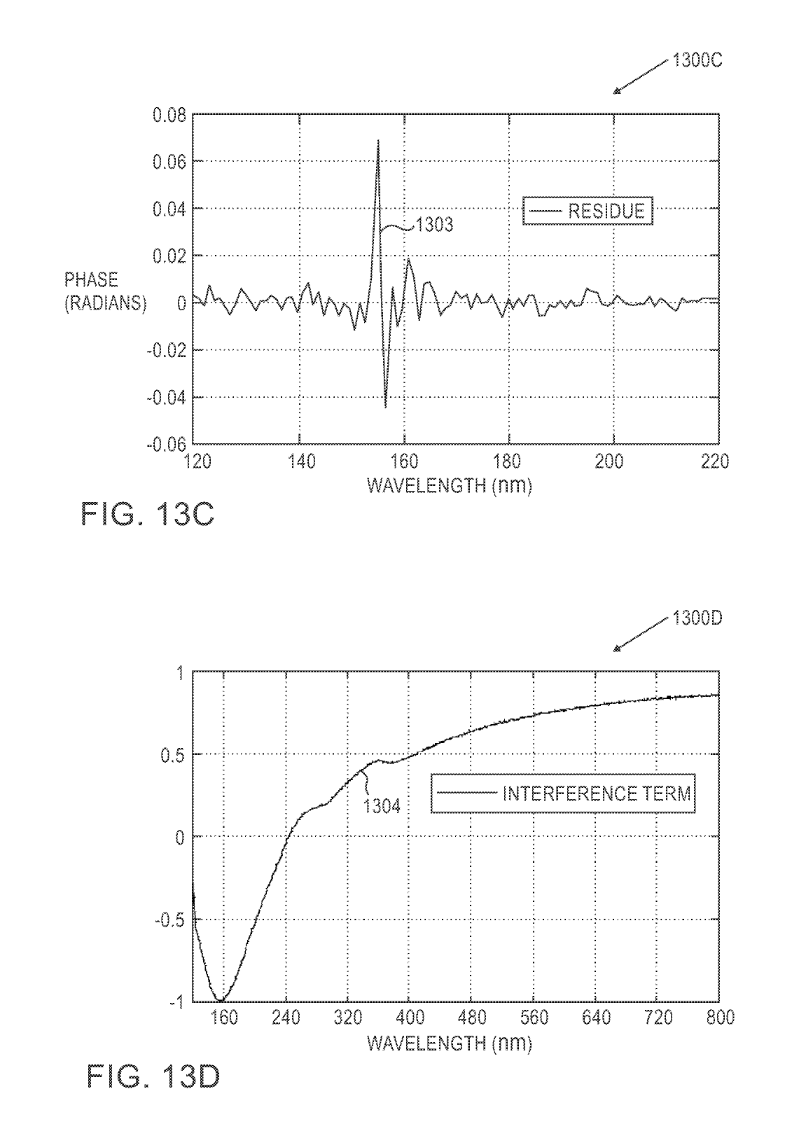

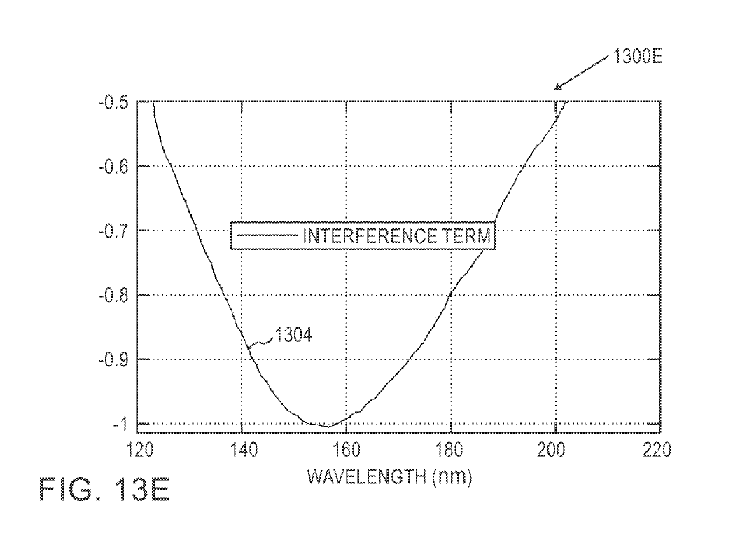

FIGS. 13A-13E show phase simulations for the 10 Å SiO₂/4 Å SiO/Si structure from FIGS. 6A-6D and 7A-7B. The intensities are modified with Gaussian noise with a standard deviation equal to 0.1% of the sample arm perfect surface intensity (5 counts). Initially, the path difference dₛ−dₘ is assumed to be zero. F(λ) is assumed to be 0.5 for all wavelengths.

FIG. 13A shows a comparison of eq. 22 phase with the original theoretical phase calculated for the 10 Å SiO₂/4 Å SiO/Si film structure 1300A. In FIG. 13A, a simulated phase measurement 1301 is compared with a calculated phase 1302. FIG. 13B shows the difference between the “measured” phase and the theoretical one 1300B. In FIG. 13B, residue 1303 of the theoretical and simulated with noise measurements from FIG. 13A is shown. As expected, the error is wavelength dependent. The fact that the error is slightly larger at longer wavelengths is consistent with the lower intensities there due to lower reflectance of both measured and calibration samples. Additionally, there is a larger error in the vicinity of 155 nm. This region is expanded in FIG. 13C for clarity. FIG. 13C shows an expanded 120-220 nm region of FIG. 13B 1300C, showing the residue 1303 of the theoretical and simulated with noise measurements from FIG. 13A. FIG. 13D shows interference term showing minima at near 155 nm 1300D.

FIG. 13D shows the interference term 1304,

$$cos ( {φ}_{S} + {φ}_{M}^{′} ) = \{ \frac{{I}_{Det} - {I}_{Det , S} - {I}_{Det , M}}{2 F ( λ ) \sqrt{{I}_{Det , S} {I}_{Det , M}}} \} , \qquad eq . 32$$

which reveals that the region of increased error occurs at the interference minimum. More generally, the final phase error is larger at the interference extrema, making the phase harder to determine there. However, the locations of the interference extrema are not entirely determined by the sample phase, and in particular depend on the quantity dₛ−dₘ as well. In the techniques disclosed herein, dₛ−dₘ can be independently adjusted by moving the reference arm, as previously discussed. FIG. 13E is an expanded 120-220 nm region of FIG. 13D 1300E, showing an interference term 1304 showing minima at near 155 nm.

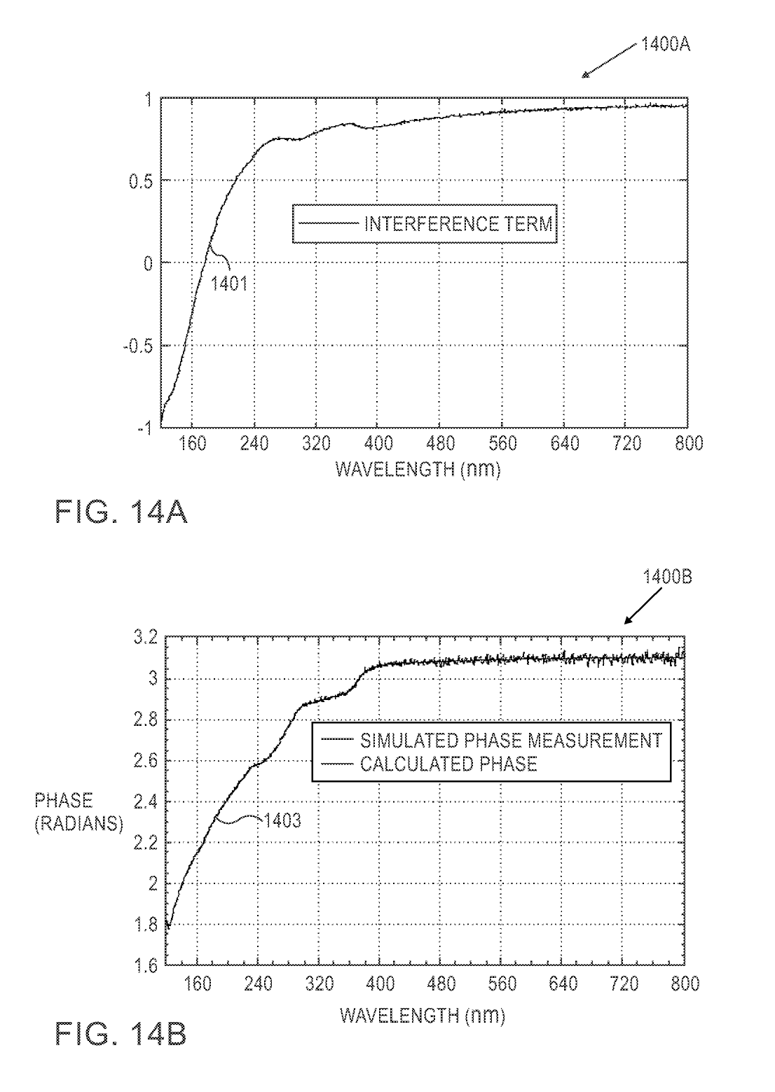

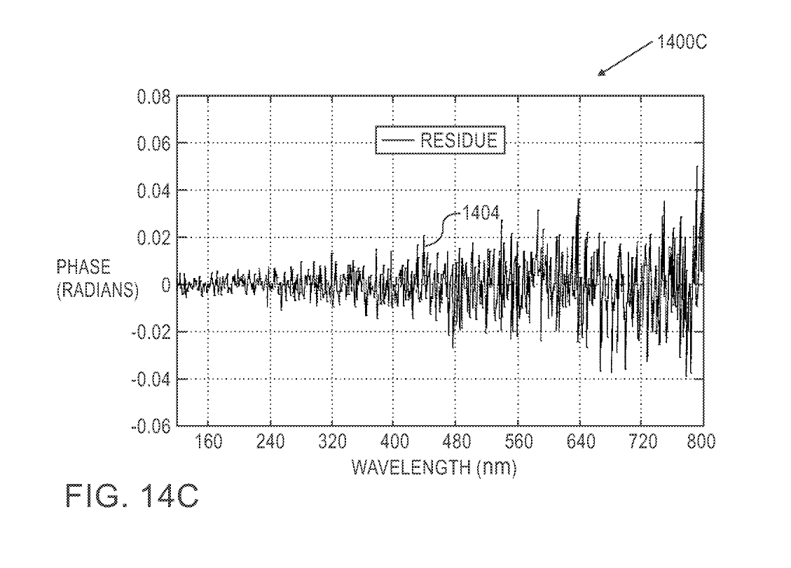

FIGS. 14A-14C show the data from FIGS. 13A-13E, but with dₛ−dₘ=−30 nm (the reference surface is moved 15 nm closer to the beam splitter, for example). FIG. 14A shows an interference term with a 30 nm offset in sample and reference arm path difference 1400A. The interference term 1401 is shown in FIG. 14A. The interference minimum has moved outside the measurement range. FIG. 14B shows a comparison of the measured and calculated phase 1400B with a simulated phase measurement 1402 and a calculated phase 1403. FIG. 14C shows the residue 1404 of the theoretical and simulated with noise phase spectrum curves shown in FIG. 14 1400C. FIGS. 14B and 14C show that the measurement error is drastically reduced in the VUV region, particularly at wavelengths near 155 nm. The average phase standard deviation for the 120-220 nm wavelength region is approximately 0.0026 radians for this example.

While VUV phase is critical for many applications, the point was made earlier that in some cases it may be beneficial to combine longer wavelength phase information with VUV reflectance. This arises from the fact that there is sometimes variation in phase at longer wavelengths when there is no reflectance variation at corresponding wavelengths. In particular, for many ultrathin film systems, visible wavelength phase is sensitive to total thickness, but not composition or individual layer thicknesses. VUV reflectance is sensitive to all of these properties, but the signal quality is inherently inferior to the quality available at visible wavelengths, due to weaker VUV sources and lower throughput of VUV radiation through the optical system. In addition, new types of sources such as the supercontinuum source (“Broad as a lamp, bright as a laser”, Nature Photonics Technology Focus, January 2008, p. 26) could be coupled with the standard VUV-Visible range source. The supercontinuum source combines a broad wavelength range with output power comparable to monochromatic laser output. Such sources are currently available at infra-red through visible wavelength ranges down to about 400 nm, and would result in an enhanced signal quality at longer wavelength ranges. Consequently, it may be beneficial to obtain total thickness with high resolution using visible wavelength phase, and then determine other parameters such as composition using VUV reflectance.

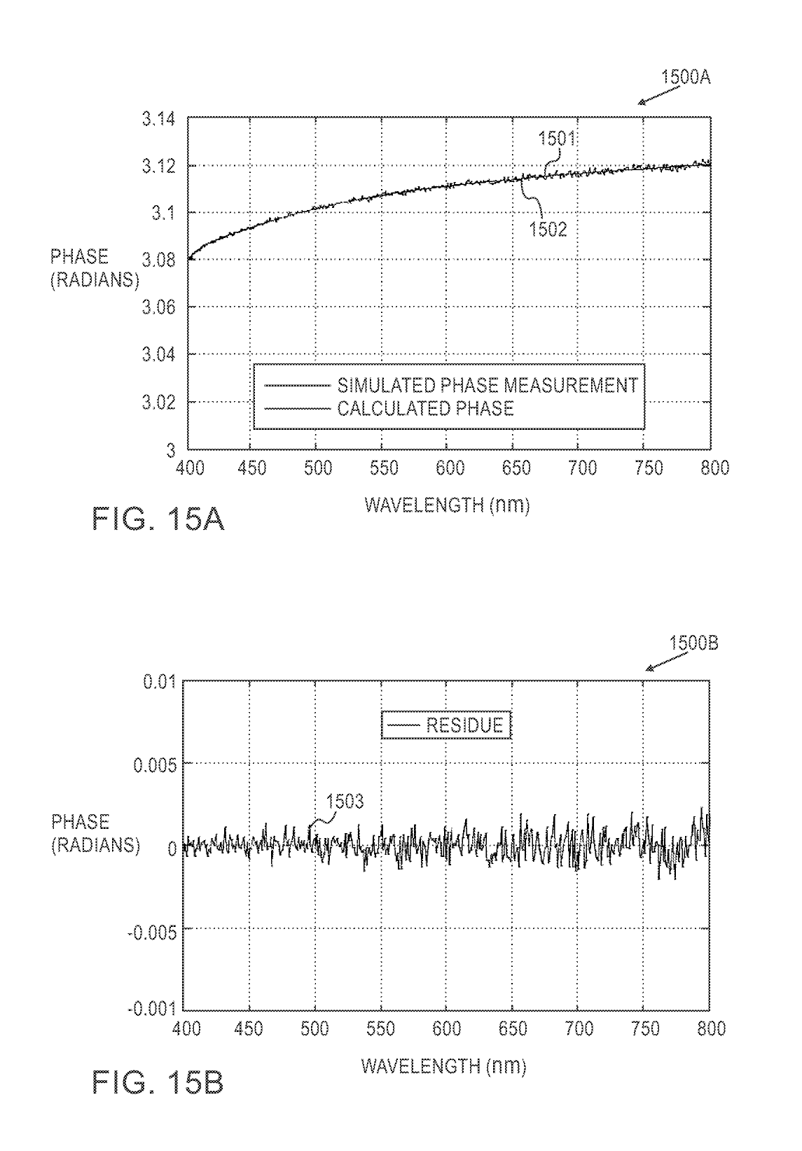

FIGS. 15A and 15B illustrate 400-800 nm phase and residue for the film structure shown in FIGS. 13A-13E and 14A-14B, but with a signal noise of 0.01% of the perfect sample intensity. The path difference is again zero. FIG. 15A shows a comparison between measured and calculated phase 1500A, and FIG. 15B shows the residual 1500B. FIG. 15A compares a simulated phase measurement 1501 with a calculated phase 1502, while FIG. 15B shows the residue of the simulated phase measurement and a calculated phase shown in FIG. 15A. The result is an order of magnitude improvement in phase uncertainty, to 0.00029 radians standard deviation in the 400-800 nm region.

It should be pointed out that the signal improvement would in actuality be achieved as a result of increased intensity counts through the entire system, but it is convenient here to keep the total intensity constant and simply reduce the width of the Gaussian noise used in the simulations in order to simulate improved signal quality. This choice is of no consequence—the effect is the same.

The power of a combined reflectance and phase measurement can be further illustrated via covariance analysis (see W.H. Press, S. A. Teukolsky, W. T. Vetterling, and B. P. Flannery, Numerical Recipes in C: The Art of Scientific Computing (2^{nd} Edition), Cambridge University Press, Cambridge, 1992) of the SiON example from FIGS. 8A-11B. Given a set of model parameters a=(a₁, a₂, . . . , aₘ), so that R_{c,i}=R_{c,i}(a) and φ_{c,j}=φ_{c,j}(a), the partial derivatives of eq. 26 are

$$\frac{{\partial }^{2} {χ}^{2}}{\partial {a}_{k} \partial {a}_{l}} = 2 {\sum }_{i = 1}^{Nr} {( \frac{1}{{σ}_{i}^{r}} )}^{2} \frac{\partial {R}_{i , c}}{\partial {a}_{k}} \frac{\partial {R}_{i , c}}{\partial {a}_{l}} - 2 {\sum }_{i}^{Nr} ( {R}_{i , m} - {R}_{i , c} ) \frac{{\partial }^{2} {R}_{i , c}}{\partial {a}_{k} \partial {a}_{l}} + 2 {\sum }_{j = 1}^{Np} {( \frac{1}{{σ}_{j}^{p}} )}^{2} \frac{\partial {φ}_{j , c}}{\partial {a}_{k}} \frac{\partial {φ}_{j , c}}{\partial {a}_{l}} - 2 {\sum }_{j}^{Np} ( {φ}_{j , m} - {φ}_{j , c} ) \frac{{\partial }^{2} {φ}_{j , c}}{\partial {a}_{k} \partial {a}_{l}} . \qquad eq . 33$$

The terms with (R_{i,m}−R_{i,c}) and (φ_{j,m}−φ_{j,c}) are nearly zero at the χ² minimum when summed over wavelength, provided the model is a reasonable description of the real system, which leads to

$$\frac{{\partial }^{2} {χ}^{2}}{\partial {a}_{k} \partial {a}_{l}} = 2 {\sum }_{i = 1}^{Nr} {( \frac{1}{{σ}_{i}^{r}} )}^{2} \frac{\partial {R}_{i , c}}{\partial {a}_{k}} \frac{\partial {R}_{i , c}}{\partial {a}_{l}} + 2 {\sum }_{j}^{Np} ( \frac{1}{{σ}_{j}^{p}} ) \frac{\partial {φ}_{j , c}}{\partial {a}_{k}} \frac{\partial {φ}_{j , c}}{\partial {a}_{l}} . \qquad eq . 34$$

The curvature matrix α is defined by

$${α}_{kl} ≡ \frac{1}{2} \frac{{\partial }^{2} {χ}^{2}}{\partial {a}_{k} \partial {a}_{l}} \qquad eq . 35$$

And the covariance matrix is

[C]≡[α]⁻¹ eq. 36

The significance of the covariance matrix is that its diagonal elements are the variances for the parameters in a. In particular, the standard one-sigma uncertainty for parameter aₖ is

σ=\sqrt{C_{k,k}}. eq. 37

For the ultrathin SiON example given above, the parameters are the EMA mixing fraction and thickness. The assumption will be made that a better signal quality can be obtained for visible wavelengths than for VUV wavelengths. Accordingly, it is assumed that the reflectance uncertainty is 0.1% for wavelengths between 120 and 400 nm, and 0.01% for the 400-800 nm range. Based on the simulation in FIGS. 15A-15B, it is assumed that a reasonable corresponding phase uncertainty is 0.0003 radians for the 400-800 nm wavelength range. The result of the covariance analysis (eq. 37) for 120-800 nm reflectance-only measurement for this example is 0.0279 Å (1-sigma) for thickness and 0.113% for EMA fraction. The result for reflectance and 400-800 nm phase together is 0.00683 Å for thickness and 0.0673% for EMA fraction. The 400-800 nm phase has significantly improved the thickness result. To obtain the same improvement in thickness performance would have required averaging the results of about 16 reflectance-only measurements, while the reflectance and phase measurement can be done in about the same amount of time as two successive reflectance measurements. On the other hand, the composition measurement is only possible using VUV reflectance data, and in this sense the two datasets have substantially complimented each other.

Techniques related to calibration of VUV reflectance and phase are now discussed. The reflectance and phase calibration method presented above works well in the visible wavelength ranges due to the availability of well-known and stable calibration samples. In VUV optical systems, however, the optics and calibration standards undergo changes due to interaction with the higher energy light. A major source of this instability in fab production environments is thought to involve a contaminant photodeposition process as VUV light interacts with siloxanes, hydrocarbons, and other compounds common in fab environments (see, for example, T. M. Bloomstein, V. Liberman, M. Rothschild, S. T. Palmacci, D. E. Hardy, and J. H. C. Sedlacek, “Contamination rates of optical surface at 157 nm in the presence of hydrocarbon impurities,” Optical Microlithography XV, Proceedings of the SPIE, Vol. 4691, p. 709 (2002), and U. Okoroanyanwu, R. Gronheid, J. Coenen, J. Hermans, K. Ronse, “Contamination monitoring and control on ASML MS-VII 157 nm exposure tool”, Optical microlithography Proceedings of the SPIE, Vol. 5377, p. 1695 (2004)). It is also possible that optical surfaces degrade and roughen as they undergo repeated VUV exposure and cleaning.

Changes in optical components can be well accounted for using known calibration standards as presented earlier. However, the calibration standards also undergo changes during repeated VUV exposure. Additionally, while thermal and native SiO₂/Si samples are relatively simple structures and make convenient choices for calibration standards, variations in oxide thickness from sample to sample, and perhaps even changes in SiO₂—Si interface layer properties, should be taken into account. For example, native SiO₂/Si sample (basically a bare silicon wafer) has very stable visible wavelength reflectance, basically due to the fact that visible wavelength reflectance is usually not sensitive to ultrathin SiO₂ thickness or interface layer properties. DUV and VUV reflectance are sensitive to changes in these properties, and small variations in silicon wafer manufacture undermine the use of these materials as DUV and VUV calibration standards. In addition, even visible wavelength phase is sensitive to changes in native oxide and interface layer thicknesses, which further undermines the use of the bare silicon system as a phase calibration standard. A more sophisticated calibration procedure should be implemented, and at least some properties of the calibration samples should be determined at the time of calibration.

A method for calibrating a VUV reflectometer was disclosed in U.S. Pat. No. 7,282,703, (Metrosol, Inc.) and continued in U.S. patent application Ser. No. 11/418,846 filed on May 5, 2006 and U.S. patent application Ser. No. 11/789,686 filed on Apr. 25, 2007, all of which are expressly incorporated herein by reference in their entirety. This method provides a means of using a relative reflectance measurement of two or more calibration samples, each having distinct reflectance properties, to determine the unknown properties of the samples. In a particular case, a thick thermal SiO₂/Si and a native SiO₂/Si sample are used, and the thicknesses of all oxide and interface layers are determined irrespective of changes in system intensity profile or changes in optic surfaces. In addition, the optical properties of the contaminant layer are characterized and used to determine the contaminant layer thickness during calibration. The results of the calibration measurement for native SiO₂ thickness, interface layer thickness, and contaminant thickness are then fed into a standard reflectance calculation to calculate the now known reflectance for the native SiO₂/Si calibration sample, which is then used as a known standard to calibrate the reflectometer.

One method for calibrating the phase measurement is to use the relative reflectance methods disclosed in U.S. Pat. No. 7,282,703 and its continuation applications referenced above to determine the state of the calibration samples at the time of calibration. The determined parameters may include thicknesses of all SiO₂ film layers, thicknesses of all interface layers, and thicknesses of photocontaminant buildup. In one embodiment, the optical properties n and k for all of these layers and the silicon substrate are regarded as known. Having determined the layer thicknesses during the relative reflectance calibration measurement, the actual reflectance and phase spectra of the calibration standards can be calculated, and used with the methods previously discussed in this disclosure to determine F(λ), when needed. More often, the results of the relative reflectance measurement will be used to compute φ_{cal} for use with eq. 22 to determine phase of an unknown sample. Note that the reflectance magnitude measurement is also calibrated during the relative reflectance measurement, as described in U.S. Pat. No. 7,282,703 and its continuation applications referenced above.

A second method makes use of a simultaneous reflectance magnitude ratio and reflectance phase difference for two or more calibration samples to determine the properties of film, interface, and contaminant layer thicknesses on all of the calibration samples. As an example, suppose the two calibration samples consist of a native SiO₂/Si (sample 1) and approximately 1000 Å SiO₂/Si (sample 2) structures. We define the reflectance magnitudes of samples 1 and 2 by R1 and R2, respectively, and the reflectance phases by φ1 and φ₂, respectively. The ratio of the effective complex reflectance coefficients gives

$$\frac{r 2}{r 1} = \frac{\sqrt{R 2}}{\sqrt{R 1}} \frac{{e}^{i φ 2}}{{e}^{iφ 1}} = \sqrt{\frac{R 2}{R 1}} {e}^{i ( φ 2 - φ 1 )} . \qquad eq . 38$$

Defining

$$\begin{matrix}Δ R ≡ \frac{R 2}{R 1} \\ and & eq . 39 \\ Δ φ ≡ φ 2 - φ1 , & eq . 40\end{matrix}$$

eq. 38 becomes

$$\frac{r 2}{r 1} = \sqrt{Δ R} {e}^{i Δ φ} , \qquad eq . 41$$

which is the de facto fundamental quantity determined using the disclosed method.

It is reasonable to assume that F(λ) need only be occasionally determined, using well-characterized calibration samples as previously disclosed. In fact, the calibration samples used to determine F(λ) can be characterized using any method available. It is therefore assumed for the present discussion that F(λ) is already known. The measurement of eq. 41 then proceeds by successively placing the calibration samples in the sample arm, and measuring I_{det}⁽¹⁾) and I_{Det,S}⁽¹⁾ with sample 1 in the sample arm, I_{Det}⁽²⁾ and I_{Det,S}⁽²⁾ with sample 2 in the sample arm, and I_{Det,M}. Then

$$\begin{matrix} Δ {R}_{m} = \frac{{I}_{Det , S}^{( 2 )}}{{I}_{Det , S}^{( 1 )}} \\ and & eq . 42 \\ Δ {φ}_{m} = {cos}^{- 1} \{ \frac{{I}_{Det}^{( 2 )} - {I}_{Det , S}^{( 2 )} - {I}_{Det , M}}{2 F ( λ ) \sqrt{{I}_{Det , S}^{( 2 )} {I}_{Det , M}}} \} - {cos}^{- 1} \{ \frac{{I}_{Det}^{( 1 )} - {I}_{Det , S}^{( 1 )} - {I}_{Det , M}}{2 F ( λ ) \sqrt{{I}_{Det , S}^{( 1 )} {I}_{Det , M}}} \} . & eq . 43\end{matrix}$$

The subscript m in eqs. 42 and 43 stands indicate that the quantities are measured quantities.

Models for r1 and r2 are constructed using standard thin film algorithms, so that ΔR_{c} and Δφ_{c} can be determined and used in a regression procedure. In the models, as much information is assumed known as is possible, for instance the optical properties of SiO₂, interface layer, and contaminant layers. The unknown parameters, such as layer thicknesses, are varied in the parameter set a=(a₁, a₂, . . . aₘ), so that ΔR_{c}=ΔR_{c}(a) and Δφ_{c}=Δφ_{c}(a). As before, a regression procedure such as Levenberg-Marquardt can be used to minimize the merit function

$${χ}^{2} = {\sum }_{i = 1}^{Nr} {( \frac{1}{{σ}_{i}^{r}} )}^{2} {( Δ {R}_{i , m} - Δ {R}_{i , c} )}^{2} + {\sum }_{j = 1}^{Nr} {( \frac{1}{{σ}_{j}^{p}} )}^{2} {( {Δφ}_{j , m} - Δ {φ}_{j , c} )}^{2} \qquad eq . 44$$

where ΔR_{i,m} is the reflectance ratio measured for data point ΔR_{i,c} is the calculated reflectance ratio for data point i, σᵢ^{r} is the assumed measurement uncertainty for reflectance ratio data point i, Δφ_{j,m} is the phase difference measured at data point j, Δφ_{j,c} is the phase difference calculated for data point j, σᵢ^{p} is the assumed measurement uncertainty for phase difference data point i Nᵣ is the total number of reflectance data points, and Nₚ is the total number of phase data points. The data points in eq. 44 are for different incidence conditions, which is usually wavelength. The regression procedure adjusts the unknown parameters and regenerates ΔR_{i,c} and Δφ_{j,c} until the value of the merit function is minimized, and the resulting optimized parameters are the results for film layer thicknesses for both samples. Either sample can now be used as a known calibration sample to calibrate absolute reflectance magnitude and phase for the system as discussed previously, giving R_{Cal} and φ_{Cal}. Reflectance phase of a subsequent unknown sample is then determined by eq. 22, and reflectance magnitude by eq. 18.

The parameter set a can be expanded by using dispersion models for the contaminant layer, and the optical properties of the contaminant layer can be determined in addition to the layer thicknesses. The dispersion model can be quite complicated, such as a multiple term Tauc-Lorentz dispersion. Accordingly, a contaminant layer can be characterized by intentionally generating contaminant on calibration samples, and running a measurement as described above to determine the optical properties of the contaminant layer. The optical properties can then be regarded as known in subsequent calibration procedures.

The determination of contaminant optical properties need not be constrained by the same time considerations that production measurements are, and the experiment can be as complex as desired. In particular, multiple samples can be used and different combinations of complex reflectance ratios formed, all of which are analyzed simultaneously to more accurately determine the common contaminant optical properties.

In another embodiment of the techniques disclosed herein, the calibration of absolute reflectance and phase are skipped entirely, and a measurement of eq. 41 used in conjunction with eq. 44 are used to determine unknown properties of two unknown samples. Clearly, if the two samples are very similar, ΔR tends to 1 and Δφ tends to zero regardless of the actual properties of the samples. Therefore, it is beneficial to measure samples that have very distinct reflectance and phase characteristics, as was done with the native SiO₂/Si and 1000A SiO₂/Si system. Put another way, if two measured samples are sufficiently distinct in terms of their total complex reflectance amplitudes, eq. 41 is often all that need be measured in order to determine the film properties of both samples.

It was pointed out earlier, but is again stressed that the above methods are not limited to complex thin film analysis, but may be applied to determination of critical dimensions and profile shapes of 2D and 3D structures. In particular, grating structures could be measured, with R_{c} and φ_{c} calculated using a rigorous solution such as the RCW method. R and φ are also sensitive to non-periodic perturbations of surface, such as surface roughness and other types of surface damage. The regression analysis can be performed using any available rigorous or approximate model for such structures.

### Unpolarized Light

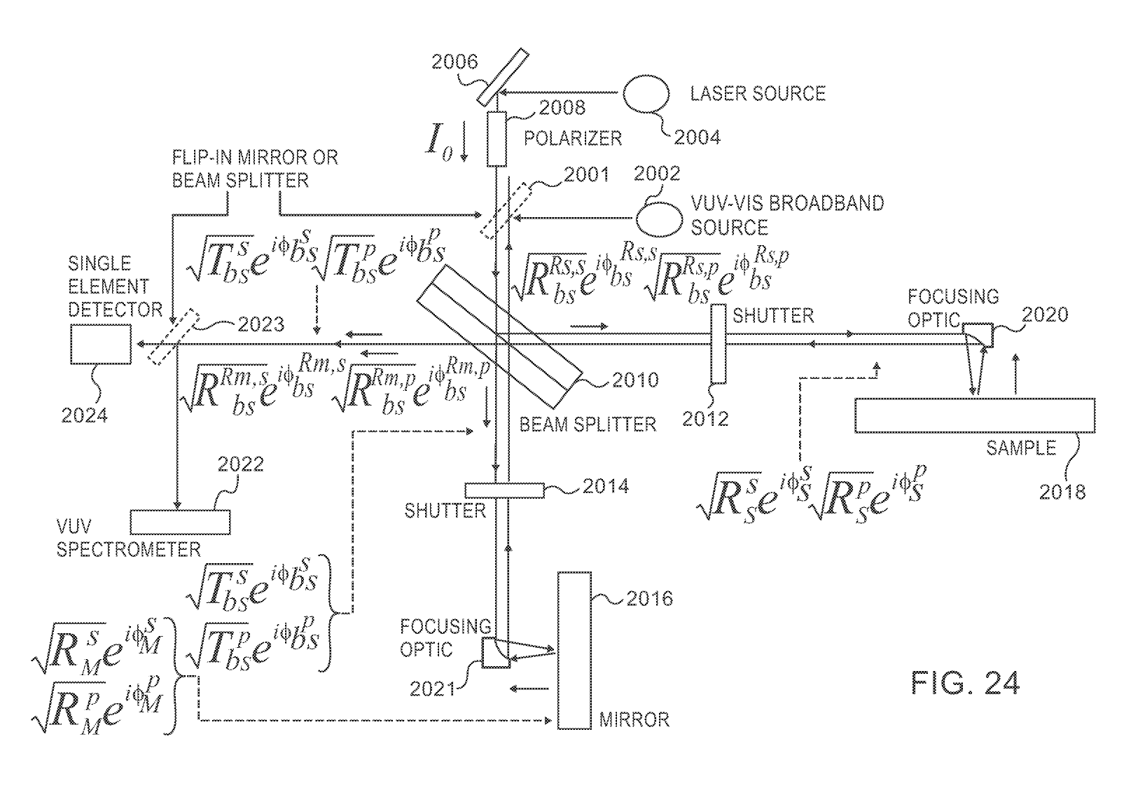

FIG. 24 shows a simplified diagram of a Michelson-type optical system. As shown in FIG. 24, a laser source 2004 and a VUV-VIS broadband source 2002 may be utilized. Flip-in mirror 2001 (or a beam splitter) is used as shown. A polarizer 2008 may receive light from mirror 2006. Beam splitter 201 provides light to shutters 2012 and 2014. Focusing optics 2010 and 2021 focus light on the sample 2016 and 2018 respectively. A flip in mirror 2023 (or alternatively a beam splitter) is used to direct the light to the VUV spectrometer 2022 or a single element detector 2024. The definition of the symbols of FIG. 24 are:
I₀=intensity incident on beam splitter
\sqrt{R_{bs}^{Rs,s}}e^{iφ}^{_{bs}}^{^{Rs,s}}\sqrt{R_{bs}^{Rs,p}}e^{iφ}^{_{bs}}^{^{Rs,p}}=total complex reflection coefficient of beam splitter films on sample arm side for s and p polarization
\sqrt{R_{S}^{s}}e^{iφ}^{_{S}}^{^{s}}\sqrt{R_{S}^{p}}e^{iφ}^{_{S}}^{^{p}}=total complex reflection coefficient of sample for s and p polarization
\sqrt{R_{M}^{s}}e^{iφ}^{_{M}}^{^{s}}\sqrt{R_{M}^{p}}e^{iφ}^{_{M}}^{^{p}}=total complex reflection coefficient of reference surface
\sqrt{T_{C}^{s}}e^{iφ}^{_{C}}^{^{s}}\sqrt{T_{C}^{p}}e^{iφ}^{_{C}}^{^{p}}=total complex transmission coefficient of compensator or beam splitter surface
\sqrt{R_{bs}^{Rm,s}}e^{iφ}^{_{bs}}^{^{Rm,s}}\sqrt{R_{bs}^{Rm,p}}e^{iφ}^{_{bs}}^{^{Rm,p}}=total complex reflection coefficient of beam splitter films on reference arm side
\sqrt{T_{bs}^{s}}e^{iφ}^{_{bs}}^{^{s}}\sqrt{T_{bs}^{p}}e^{iφ}^{_{bs}}^{^{p}}=total complex transmission coefficient of beam splitter films for light incident from sample arm side

At any optical surface, including the measured sample and reference mirror, the interaction of light with the optic can be described by the total complex reflection and transmission coefficients

r^{s}=\sqrt{R^{s}}e^{iφ}ᵣ^{s}, r^{p}=\sqrt{R^{p}}e^{iφ}ᵣ^{p} eq. 101

And

t^{s}=\sqrt{T^{s}}e^{iφ}ₜ^{s}, t^{p}=\sqrt{T^{p}}e^{iφ}ₜ^{p} eq. 102

where r and t are the complex reflection and transmission coefficients, R and T are the total reflectance and transmittance magnitudes, φᵣ and φₜ are the phase angles of the complex reflection and transmission coefficients. The superscripts s and p refer to light with polarization perpendicular and parallel to the plane of incidence, respectively. φᵣ and φₜ can also be viewed as the phase change caused by reflection from the optic and transmission through the optic, respectively. Note that the effective complex reflection and transmission coefficients include the effects of multiple film layers on the optics.

The reflection or transmission coefficient gives the fraction of the incident field amplitude that is reflected at the surface or transmitted through the optic, and the reflected or transmitted intensity that would be detected is given by their squared magnitudes. So, for instance, if I₀ is the intensity of light incident on the beam splitter, the intensity reflected from the beam splitter is

$$\begin{matrix}{I}_{R}^{bs} = {I}_{0} \cdot ( \begin{matrix}\frac{1}{2} \sqrt{{R}_{bs}^{Rs , s}} {e}^{i {φ}_{bs}^{Rs , s}} \cdot \sqrt{{R}_{bs}^{Rs , s}} {e}^{- i {φ}_{bs}^{Rs , s}} + \\ \frac{1}{2} \sqrt{{R}_{bs}^{Rs , p}} {e}^{{i}_{bs}^{Rs , p}} \cdot \sqrt{{R}_{bs}^{Rs , p}} {e}^{- i {φ}_{bs }^{Rs , p}}\end{matrix} ) \\ = \frac{1}{2} {I}_{0} ( {R}_{bs}^{Rs , s} + {R}_{bs}^{Rs , p} )\end{matrix} \qquad eq . 103$$

and the intensity transmitted through the beam splitter is

$$\begin{matrix}{I}_{T}^{bs} = {I}_{0} \cdot ( \begin{matrix}\frac{1}{2} \sqrt{{T}_{bs}^{s}} {e}^{i {φ}_{bs}^{s}} \cdot \sqrt{{T}_{bs}^{s}} {e}^{- i {φ}_{bs}^{s}} + \\ \frac{1}{2} \sqrt{{T}_{bs}^{p}} {e}^{i {φ}_{bs}^{p}} \cdot \sqrt{{T}_{bs}^{p}} {e}^{- i {φ}_{bs}^{p}}\end{matrix} ) \\ = \frac{1}{2} {I}_{0} ( {T}_{bs}^{s} + {T}_{bs}^{p} )\end{matrix} \qquad eq . 104$$

for un-polarized incident light, where the various symbols are as defined in FIG. 24.

For the reflectometer shown in FIGS. 1 and 24, the main quantity of interest is the complex reflection coefficient from the sample,

r_{S}^{s}=\sqrt{R_{S}^{s}}e^{iφ}^{_{S}}^{^{s}}, r_{S}^{p}=\sqrt{R_{S}^{p}}e^{iφ}^{_{S}}^{^{p}} eq. 105

from which properties of the sample such as film thickness and composition can be determined. By opening both shutters in FIGS. 1 and 24, the beam paths from the reference and sample arms can be made to interfere, and in this case the detected intensity contains information about the sample reflectance phase, φ_{S}^{s} and φ_{S}^{p}.

In the some of the embodiments of U.S. Pat. No. 7,126,131, the final objectives before the sample and reference surfaces are focusing objectives designed to provide particular spot characteristics at the sample/reference surface. For example, the focusing objective could consist of off-axis parabolic mirrors with suitable VUV-NIR reflective coatings with off-axis angle of 90°. The properties of the illumination spot on the sample are determined by the properties of the source and additional magnification optics, as well as the quality of the alignment of the system. However, for the purposes of the present disclosure, we are concerned about the range of angles incident on the sample, which is determined by the final objective.

In one embodiment, the final focusing objective can have a reflected effective focal length of 6 inches, leading to a small range of angles incident on the sample about the sample normal. For all practical purposes the incident angle on the sample can be considered to be zero, and the sample can be accurately assumed to be non-polarizing.

In a second embodiment, the focusing optic has a reflected effective focal length of 1 inch, leading to a larger range of angles incident on the sample, up to ˜30-35 degrees. The sample and reference surface must then be considered to be polarizing, the degree of which depends on how large the incident angle is from normal.

For the VUV reflectometer systems in one embodiment of U.S. Pat. No. 7,126,131 the incident light is un-polarized and fills the entire objective surface. The resulting angles at sample and reference surfaces are approximately distributed about a cone (azimuthal symmetry), and the polarization effects mostly average out. The present disclosure couples in a laser or supercontinuum source to the VUV reflectometer, which is collimated and directed to a specific region (˜1 mm diameter) of the focusing optic. The light is focused to a small spot on the sample and reference surface with a well-defined angle of incidence. Here, a well-defined angle of incidence is understood to mean a range of incident angles small enough to be well-approximated by assuming the light is incident at a single discrete angle. Preferably, the light is directed such that the plane of incidence on the sample coincides with the plane of incidence on all other optics, including the beam splitter. In this case, light entering the system polarized parallel or perpendicular to the plane of incidence of the optics/sample retains its polarization throughout the system. A second detector is also coupled into the system. The second detector can be a single-element detector in the case of a monochromatic laser source, or a detector array in the case of a supercontinuum source.

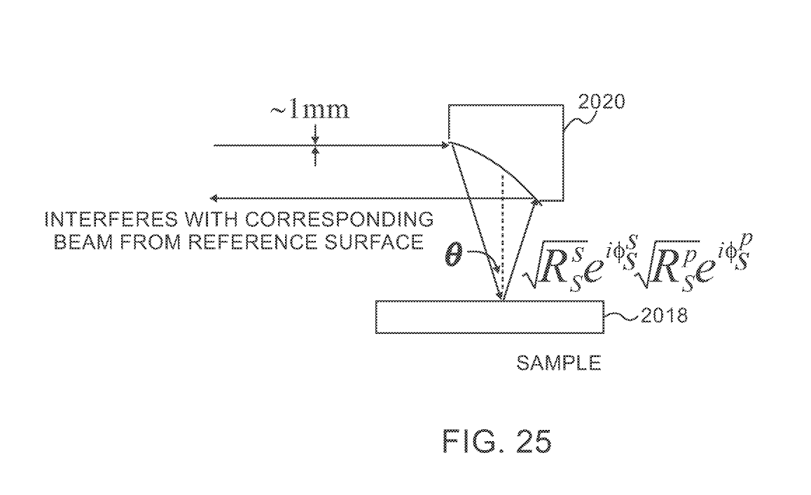

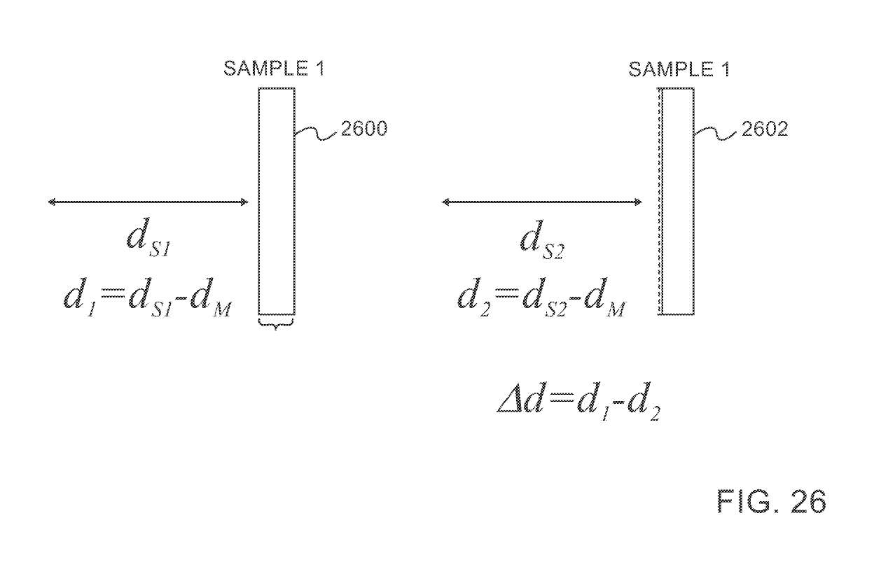

FIG. 25 shows an expanded view of the focusing objective 2020 and sample 2018 surface. A small area of the focusing optic is illuminated so that the light is incident on and reflects from a sample at a well-defined angle, θ. The light reflected from the sample illuminates the focusing optic at another location, and consequently is re-collimated and directed back toward the beam splitter. The same configuration is used at the reference surface, so that the light reflected from sample and reference surface can be made to recombine and interfere at the beam splitter.

It should be noted that while a ˜1 mm diameter collimated beam is indicated in FIG. 25, this dimension merely serves to illustrate that the objective is not completely filled by the collimated light. The beam diameter can be any size that allows for high intensity incident at a well-defined angle of incidence on the sample. A smaller diameter will yield a better defined incident angle. At the same time, a smaller diameter may cause the properties of the incident beam to diverge further from ideal, well-collimated behavior. Additionally, a smaller diameter could lead to lower intensities on the sample. Therefore, the actual beam diameter will be determined from a balance between the ability to obtain near-ideal properties at that diameter, a small spread of angles incident on the sample, and finally high intensity incident on the sample. FIG. 25 indicates that a ˜1 mm diameter beam might result in a good balance between these aspects, but other beam diameters are possible and will work with the present disclosure. Additionally, the beam cross section does not have to be perfectly circular. Among other shapes, the beam cross section can be elliptical, in which case the beam diameter can be taken as the dimension of the long axis of the ellipse.

The sample reflectances for s and p incident polarization, r_{S}^{s} and r_{S}^{p}, are equal when θ=0. For θ≠0, r_{S}^{s} and r_{S}^{p} generally differ, and are more distinct for larger θ. Therefore, a preferred embodiment directs the laser or supercontinuum source to a portion of the focusing optic that maximizes the resulting angle of incidence on the sample, so that difference between r_{S}^{s}(θ) and r_{S}^{p}(θ) is maximized. For the optic with reflected effective focal length of 1 inch described above, practical incident angles between 20 and 30 degrees can be obtained. The advantage of coupling in the source in the manner described is that the VUV reflectometer can otherwise be operated as taught in U.S. Pat. No. 7,126,131 whenever the laser source is not in use. In a preferred embodiment, the instrument will be used alternately to measure an unknown sample using the laser source or in VUV reflectometer mode by operating the flip in mirrors shown in FIG. 24, for example.

The propagation of un-polarized light through the system described above. We now do the same for polarized incident light, and in particular are interested in light having pure s or p polarization with respect to the plane of incidence on the system optics and sample. We ignore an analysis of an optional compensating plate, which could be included to cancel asymmetric sample and reference arm paths caused by propagation through the transparent substrate of certain types of beam splitter. The inclusion of the compensating plate in the analysis does not affect the final result, and is omitted for simplicity. The effects of reflections from the focusing objectives are also omitted, as these are balanced for the two arms and cancel out anyway.

For the embodiment shown in FIG. 24, all transmissions through the beam splitter films occur from the same side, and so we will usually have T_{bs}^{Ts}=T_{bs}^{Tm} and φ_{bs}^{Ts}=φ_{bs}^{Tm}, although other embodiments are possible where this need not be the case.

For s-polarized light traversing the sample path, the complex amplitudes in FIG. 24 combine to give

$${A}_{S}^{s} = \sqrt{{R}_{bs}^{Rs , s}} {e}^{i {φ}_{bs}^{Rs , s}} \sqrt{{R}_{S}^{s}} {e}^{i {φ}_{S}^{s}} \sqrt{{T}_{bs}^{Ts , s}} {e}^{{φ}_{bs}^{Ts , s}} {e}^{( i 2 π {d}_{s} / λ )} , \qquad eq . 106$$

whereas light traversing the reference path combines to give

$${A}_{M}^{s} = \sqrt{{T}_{bs}^{Tm , s}} {e}^{i {φ}_{bs}^{Tm , s}} \sqrt{{R}_{M}^{s}} {e}^{i {φ}_{M}^{s}} \sqrt{{R}_{bs}^{Rm , s}} {e}^{i {φ}_{bs}^{Rm , s}} {e}^{( i 2 π {d}_{m} / λ )} . \qquad eq . 107$$

In eqs. 106 and 107, dₛ and dₘ are the total in ambient distances traversed by light travelling the sample and reference paths, respectively. The intensity at the detector for s polarized incident light is then

I_{Det}^{s}=I₀^{s}·(A_{S}^{s}++A_{M}^{s})·(A_{S}^{s}+A_{M}^{s})* eq. 108

where the star denotes the complex conjugate operation which, in this case, simply has the effect of negating the arguments of the exponentials. After performing the multiplications and some simplification, Eq. 108 becomes

$$\begin{matrix}{I}_{Det}^{s} = {I}_{Det , S}^{s} + {I}_{Det , M}^{s} + 2 \sqrt{{I}_{Det , S}^{s} {I}_{Det , M}^{s}} cos \{ \begin{matrix}( {φ}_{bs}^{R , s} - {φ}_{bs}^{Rm , s} ) + ( {φ}_{bs}^{Ts , s} - {φ}_{bs}^{Tm , s} ) + \\ \frac{2 π}{λ} ( {d}_{S} - {d}_{M} ) + ( {φ}_{S}^{s} - {φ}_{M}^{s} )\end{matrix} \} . \\ where & eq . 109 \\ {I}_{Det , S}^{s} = {I}_{0}^{s} {R}_{bs}^{Rs , s} {R}_{S}^{s} {T}_{bs}^{Ts , s} \\ and & eq . 110 \\ {I}_{Det , M}^{s} = {I}_{0}^{s} {T}_{bs}^{Tm , s} {R}_{M}^{s} {R}_{bs}^{Rm , s} & eq . 111\end{matrix}$$

are the intensities detected when only the sample shutter is open (eq. 110), and only the reference shutter is open (eq. 111).

It is useful to combine all of the terms in the phase argument in eq. 109 that do not depend on the measured sample:

$${Φ}_{M}^{s} = ( {φ}_{bs}^{Rs , s} - {φ}_{ bs}^{Rm , s} ) + ( {φ}_{bs}^{Ts , s} - {φ}_{ bs}^{Tm , s} ) + \frac{2 π}{λ} ( {d}_{S} - {d}_{M} ) - {φ}_{M}^{s} \qquad eq . 112$$

so eq. 9 becomes

I_{Det}^{s}=I_{Det,S}^{s}+I_{Det,M}^{s}+2\sqrt{I_{Det,S}^{s}I_{Det,M}^{s}} cos(φ_{S}^{s}+Φ_{M}^{s}). eq. 113

Note that all of the quantities in eq. 113 will typically be wavelength dependent.

Solving for the sample reflection phase:

$${φ}_{S}^{s} = {cos}^{- 1} \{ \frac{{I}_{Det}^{s} - {I}_{Det , S}^{s} - {I}_{Det , M}^{s}}{2 \sqrt{{I}_{Det , S}^{s} {I}_{Det , M}^{s}}} \} - {Φ}_{M}^{s} . \qquad eq . 114$$

The quantity φ_{S}^{s} is most accurately described as the phase change caused by reflection of s-polarized light from the sample.

In eq. 114, φ_{S}^{s}+Φ_{M}^{s} is determined to within an integral factor of 2π. The inverse cosine operation in eq. 114 actually maps the π to 2π values of the original phase back on the 0 to π interval. However, there are methods for recovering the original phase over the entire 0 to 2π interval. For example, the methods in the Appendix A herein can be adapted for use with the present disclosure. However, the present disclosure will often be employed for measuring ultra-thin films, where the primary interest is in the ability to determine very small changes in φ_{S}^{s}, and the π ambiguity has very little, if any, influence.

At this point, I_{Det}^{s}, I_{Det,S}^{s}, and I_{Det,M}^{s} are quantities that can be measured—I_{Det}^{s} with both shutters open, and I_{Det,S}^{s} and I_{Det,M}^{s} with only the sample shutter and reference shutter open, respectively. The quantity Φ_{M}^{s} is unknown, but since it does not depend on the sample surface, it can be cancelled by measuring eq. 114 for two samples and taking the difference:

$${φ}_{S}^{1 , s} - {φ}_{S}^{2 , s} = {cos}^{- 1} \{ \frac{{I}_{Det}^{1 , s} - {I}_{Det , S}^{1 , s} - {I}_{Det , M}^{s}}{2 \sqrt{{I}_{Det , S}^{1 , s} {I}_{Det , M}^{s}}} \} - {cos}^{- 1} \{ \frac{{I}_{Det}^{2 , s} - {I}_{Det , S}^{2 , s} - {I}_{Det , M }^{s}}{2 \sqrt{{I}_{Det , S}^{2 , s} {I}_{Det , M}^{s}}} \} . \qquad eq . 115$$

All quantities on the right hand side of eq. 115 are measurable with either sample 1 or sample 2 in the sample arm, and one or both shutters open as appropriate. In this way, eq. 115 gives a way to directly measure the phase difference between samples 1 and 2. Eq. 115 also makes the assumption that the reference path does not change, as long as the two samples are measured reasonably close together in time.

To measure the absolute phase change on reflection of an unknown sample, a known calibration sample can be employed. The reflectance magnitude and phase for the known calibration sample can be calculated from the optical properties and thicknesses of the substrate and any films on the calibration sample (using, for example, the techniques in Spectroscopic Ellipsometry and Reflectometry, H. G. Tompkins and W. A. McGahan, John Wiley & Sons, New York, 1999). Knowledge of the film structure and optical properties of the calibration sample can be enhanced by pre-characterization using alternate metrology techniques, or via the methods disclosed in U.S. Pat. No. 7,282,703 and U.S. patent application Ser. Nos. 11/418,846 and 11/789,686, the disclosures of which are incorporated herein by reference in their entirety. Then, for a given unknown sample, eq. 115 can be rearranged with the unknown sample in place of sample 1 and the calibration sample in place of sample 2 to give

$${φ}_{S}^{s} = {cos}^{- 1} \{ \frac{{I}_{Det}^{s} - {I}_{Det , S}^{s} - {I}_{Det , M}^{s}}{2 \sqrt{{I}_{Det , S}^{s} {I}_{Det , M}^{s}}} \} + {φ}_{Cal}^{s} - {cos}^{- 1} \{ \frac{{I}_{Det}^{Cal , s} - {I}_{Det , S}^{Cal , s} - {I}_{Det , M }^{s}}{2 \sqrt{{I}_{Det , S}^{Cal , s} {I}_{Det , M}^{s}}} \} , \qquad eq . 116$$

where the Cal superscript refers to the known calibration sample. Note that the calibration has effectively determined the sample-independent phase component:

$${Φ}_{M}^{s} = {cos}^{- 1} \{ \frac{{I}_{Det}^{Cal , s} - {I}_{Det , S}^{Cal , s} - {I}_{Det , M}^{s}}{2 \sqrt{{I}_{Det , S}^{Cal , s} {I}_{Det , M}^{s}}} \} - {φ}_{Cal}^{s} . \qquad eq . 117$$

The magnitude of the calibration sample reflectance can be used to determine the reflectance magnitude of the unknown sample using the sample arm:

$${R}_{S}^{s} = \frac{{I}_{Det , S}^{s}}{{I}_{Det , S}^{Cal , s}} {R}_{Cal}^{s} . \qquad eq . 118$$

It is assumed that none of the quantities other than I_{Det}^{s} and I_{Det,S}^{s} change after the calibration procedure, which is true over reasonably short periods (usually a few minutes to a couple of hours). Calibrations can be done periodically to account for system drift over time. With these assumptions, the reflectance magnitude from eq. 118 can be augmented with reflection phase information via eq. 116 with only the additional measurement of I_{Det}^{s}, so that the total measurement time is essentially the same as would be required for two successive reflectance magnitude measurements.

The equations that result for p-polarized incident light are identical to the s-polarized case, so that eqs. 113, 115, 116, and 118 become

$$\begin{matrix} {I}_{Det}^{p} = {I}_{Det , S}^{p} + {I}_{Det , M}^{p} + 2 \sqrt{{I}_{Det , S}^{p} {I}_{Det , M}^{p}} cos ( {φ}_{S}^{p} + {Φ}_{M}^{p} ) & eq . 119 \\ {φ}_{S}^{1 , p} - {φ}_{S}^{2 , p} = {cos}^{- 1} \{ \frac{{I}_{Det}^{1 , p} - {I}_{Det , S}^{1 , p} - {I}_{Det , M}^{p}}{2 \sqrt{{I}_{Det , S}^{1 , p} {I}_{Det , M }^{p}}} \} - {cos}^{- 1} \{ \frac{{I}_{Det}^{2 , p} - {I}_{Det , S}^{2 , p} - {I}_{Det , M}^{p}}{2 \sqrt{{I}_{Det , S}^{2 , p} {I}_{Det , M}^{p}}} \} , & eq . 120 \\ {φ}_{S}^{p} = {cos}^{- 1} \{ \frac{{I}_{Det}^{p} - {I}_{Det , S}^{p} - {I}_{Det , M}^{p}}{2 \sqrt{{I}_{Det , S}^{p} {I}_{Det , M}^{p}}} \} + {φ}_{Cal}^{p} - {cos}^{- 1} \{ \frac{{I}_{Det}^{Cal , p} - {I}_{Det , S}^{Cal , p} - {I}_{Det , M}^{p}}{2 \sqrt{{I}_{Det , S}^{Cal , p} {I}_{Det , M}^{p}}} \} , \\ and & eq . 121 \\ {R}_{S}^{p} = \frac{{I}_{Det , S}^{p}}{{I}_{Det , S}^{Cal , p}} {R}_{Cal}^{p} . & eq . 122\end{matrix}$$

Using a known calibration sample, all of the quantities in eq. 105 can be determined for an unknown sample. First, I_{Det}^{Cal,s}, I_{Det,S}^{Cal,s}, and I_{Det,M}^{s} are measured with the calibration sample in the sample arm for s-polarized incident light. The same three measurements are done for p-polarized incident light, if desired. Next, the unknown sample is placed in the sample arm and I_{Det}^{s} and I_{Det,S}^{s} are measured, and eqs. 116 and 118 can be used to determine r_{S}^{s}. I_{Det}^{p} and I_{Det,S}^{p} can be measured, and if the calibration sample was measured with p polarization as well, eqs. 120 and 122 are used to determine r_{S}^{p}. r_{S}^{s} and r_{S}^{p} can be determined for subsequent unknown samples with only four additional measurements, since the calibration data is reused. Since I_{Det,S}^{s} is already measured to determine R_{S}^{s} (and similarly for p polarization), measurement of reflectance magnitude and phase for s or p polarization can be determined in about the same measurement time that would be required for two reflectance measurements.

Note that if both s and p polarization have been measured, we have also obtained the ellipsometric parameters for the sample, since

$$\frac{{r}_{S}^{p}}{{r}_{S}^{s}} = \sqrt{\frac{{R}_{S}^{p} }{{R}_{S}^{s}}} {e}^{i ( {φ}_{S}^{p} - {φ}_{S}^{s} )} = tan {Ψ}_{s} {e}^{i {Δ}_{s}} . \qquad eq . 123$$

Either eq. 105 or eq. 123 can be analyzed by assuming a model for the unknown sample and using regression techniques to optimize the values of the unknown parameters such as film thicknesses, optical properties, etc., as is known in the art.

We note that while the ellipsometric parameters can be determined for an unknown sample via the present disclosure, the current technique is distinct from the technique of ellipsometry, since the light is never elliptically polarized during the measurement, either before or after the sample. In fact, in the preferred embodiment the polarization state of the light does not change at all during the measurement.

Appendix A: Determining Phase Over the Entire 0 to 2π Range.

Rewriting Eq. 20,

$${φ}_{S} + {φ}_{M}^{′} = {cos}^{- 1} \{ \frac{{I}_{Det} - {I}_{Det , S} - {I}_{Det , M}}{2 F ( λ ) \sqrt{{I}_{Det , S} {I}_{Det , M}}} \} , \qquad eq . A1$$

which is the same as eq. 32.

The absolute phase ranges from 0 to 2π, but the inverse cosine function in eq. A1 maps values of the original phase φ_{S}+φ_{M}′ between π and 2π back to the 0 to π interval. There are various methods for recovering the entire 0 to 2π range of the original phase.

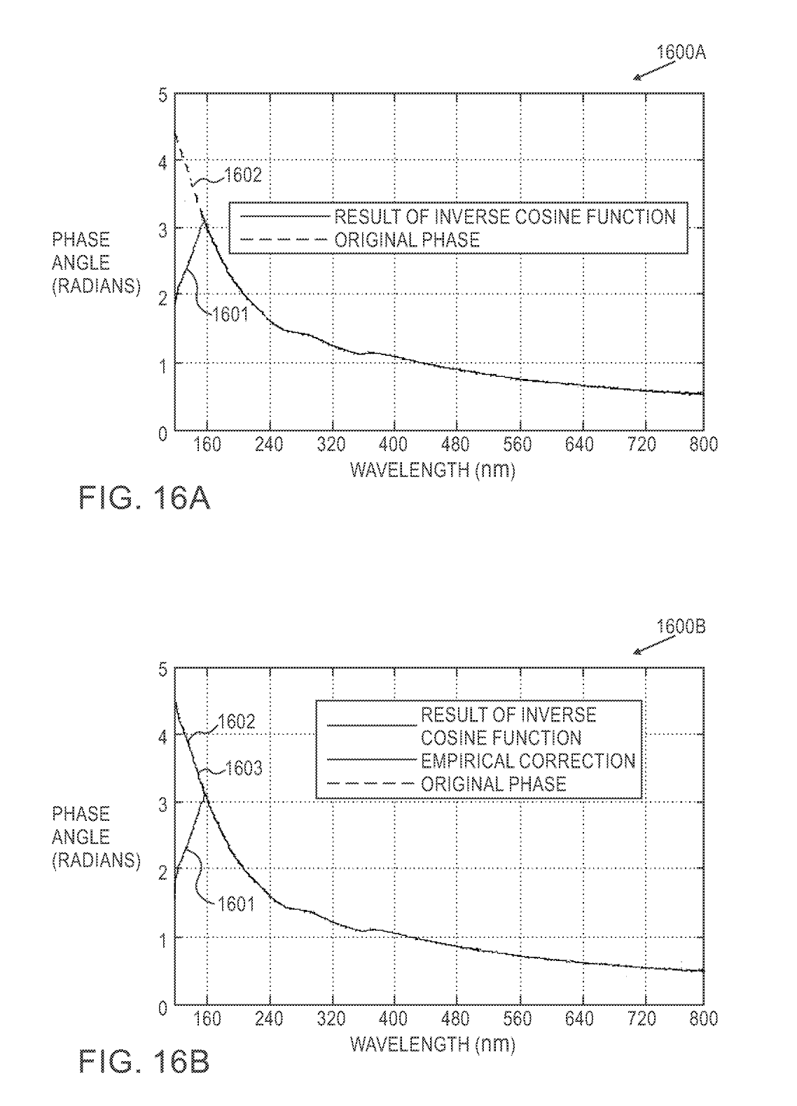

FIGS. 16A and 16B show the uncorrected result for φ_{S}+φ_{M}′ corresponding to the 10 Å SiO₂/4 Å SiO/Si structure of FIG. 13. FIG. 16A shows a comparison of result of inverse cosine operation with original theoretical phase 1600A. FIG. 16A shows the result of eq. A1 applied to the curve in FIG. 13D. The resulting phase or result of inverse cosine function 1601 versus wavelength curve has a sharp discontinuity in its slope at the interference minimum. Comparing with the value for φ_{S}+φ_{M}′ used in the original simulations or original phase 1602 (dashed curve in FIG. 16A), it is apparent that the original values between π and 2π are mapped back on the 0 to π interval, but with π→π and 2π→0. FIG. 16B shows a comparison illustrating the effect of correcting the phase from the result of inverse cosine operation at wavelengths below the interference minimum 1600B. FIG. 16B shows the data from FIG. 16A (i.e. the result of inverse cosine function 1601 and original phase 1602) with an additional curve marked “Empirical Correction” 1603 where the phase is subtracted from 2π at wavelengths below the interference minimum. Clearly the original φ_{S}+φ_{M}′ phase 1602 has been recovered by this operation. The correction was used in combination with a simple peak detection algorithm to recover the 0 to 2π phase for the example in FIGS. 13A-13E, for both measurement and calibration samples.

More generally, given two consecutive extrema of the cos(φ_{S}+φ_{M}′) versus wavelength curve, the inverse cosine operation will map the original value of φ_{S}+φ_{M}′ to the 0 to π interval in regions lying between a minimum followed by a maximum (in the direction of increasing wavelength). If the region lies between a maximum and minimum, the original phase was greater than π, and those values will be mapped backward on the π to 0 interval. A peak detection algorithm can be used to detect all of the cosine extrema and the correction applied for regions lying between a maximum and minimum, in the direction of increasing wavelength. It may work better to actually detect the slope discontinuities in the inverse cosine function instead of the peaks of the cosine function. Applying this correction to both measurement and calibration samples is sufficient to determine absolute phase of the measurement sample throughout the wavelength range to within an integral factor of 2π.

Obviously, the above method relies on having multiple wavelength data, so that interference peaks can be detected. Other methods can use known calibration samples to unambiguously determine the 0 to 2π phase for a single data point.

One method adds a second known calibration sample to the standard calibration procedure. For example, the system calibration sample could be a 15 Å SiO₂/Si, and an additional sample can consist of a 20 Å SiO₂/Si structure. The exact properties of the calibration samples can be determined using previously discussed methods. The known properties can be used to calculate the phase difference, φ_{Cal}^{(1)-φ}_{Cal}⁽²⁾. With each sample placed successively in the measurement arm, the calculated phase difference can be compared to the measured one according to

$${φ}_{Cal}^{( 1 )} - {φ}_{Cal}^{( 2 )} = {cos}^{- 1} \{ \frac{{I}_{Det}^{( 1 )} - {I}_{Det , S}^{( 1 )} - {I}_{Det , M }}{2 F ( λ ) \sqrt{{I}_{Det , S}^{( 1 )} {I}_{Det , M}}} \} - {cos}^{- 1} \{ \frac{{I}_{Det}^{( 2 )} - {I}_{Det , S}^{( 2 )} - {I}_{Det , M}}{2 F ( λ ) \sqrt{{I}_{Det , S}^{( 2 )} {I}_{Det , M}}} \} . \qquad eq . A2$$

If the phases of the two calibration samples are fairly close together, the corresponding interference extrema will be close together as well. In this case, at wavelength regions sufficiently far away from the extrema, the 0 to π ambiguity results in the inverse relationship

$$- ( {φ}_{Cal}^{( 1 )} - {φ}_{Cal}^{( 2 )} ) = {cos}^{- 1} \{ \frac{{I}_{Det}^{( 1 )} - {I}_{Det , S}^{( 1 )} - {I}_{Det , M}}{2 F ( λ ) \sqrt{{I}_{Det , S}^{( 1 )} {I}_{Det , M}}} \} - {cos}^{- 1} \{ \frac{{I}_{Det}^{( 2 )} - {I}_{Det , S}^{( 2 )} - {I}_{Det , M}}{2 F ( λ ) \sqrt{{I}_{Det , S}^{( 2 )} {I}_{Det , M} }} \} \qquad eq . A3$$

holding instead of eq. A2. Therefore, for a given wavelength, comparison of the left and right hand sides of eq. A2 can be used to determine whether or not the phase difference should be inverted. An easy way to do this is to compare the right hand side of eq. A2 to φ_{Cal}⁽¹⁾−φ_{Cal}⁽²⁾ and to −φ_{Cal}⁽¹⁾−φ_{Cal}⁽²⁾). If the right hand side is closer to −(φ_{Cal}⁽¹⁾−φ_{Cal}⁽²⁾), the phase difference should be inverted. This information can be stored for each wavelength in the measurement range, and the inversion can be applied during the measurement of an unknown sample with phase properties sufficiently close to the two calibration samples. In particular, the interference extrema of the three samples should be close together. The phase of the unknown sample will then be accurate at wavelength regions sufficiently far from the interference extrema.

This method is best used with calibration samples that are distinct, but close enough together that most of the measured regions are within the same period of both samples. Put another way, the phase difference should be as close to zero as possible without actually being zero. Additionally, the phase of the unknown sample should be fairly close to the two calibration samples. This is actually not a very stringent condition for many ultrathin film structures when the ultra-thin SiO₂/Si calibration samples are used. The error using this method is large in the vicinity of the interference extrema of the three samples.

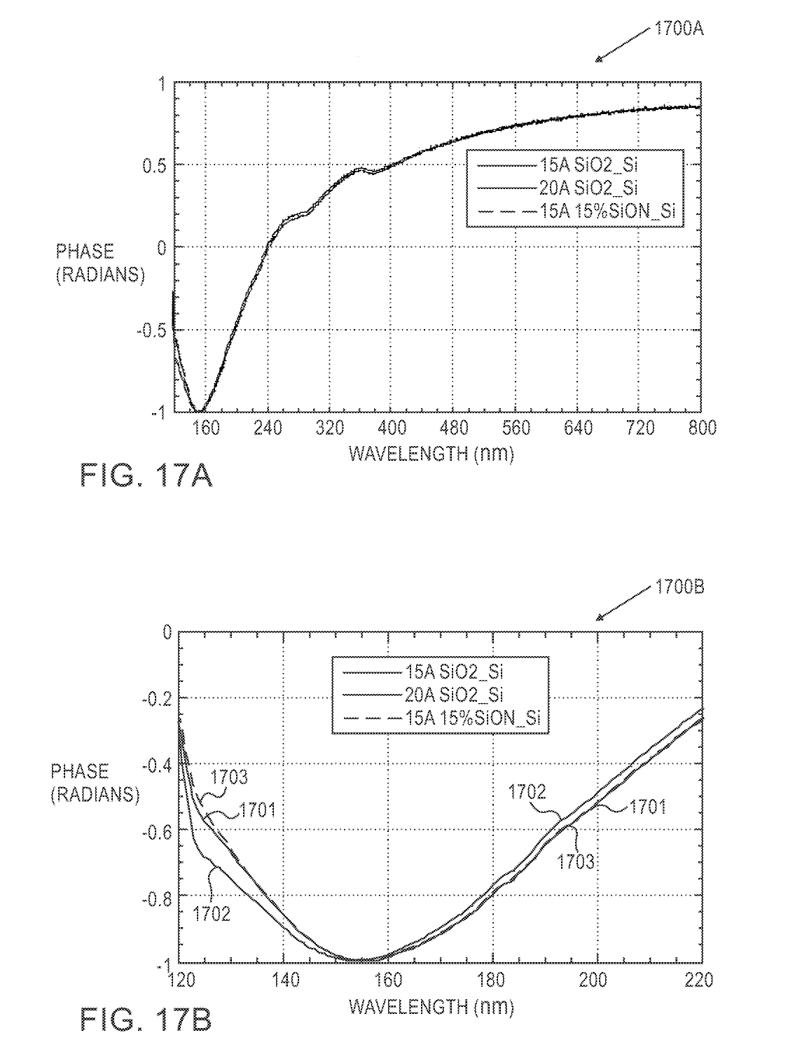

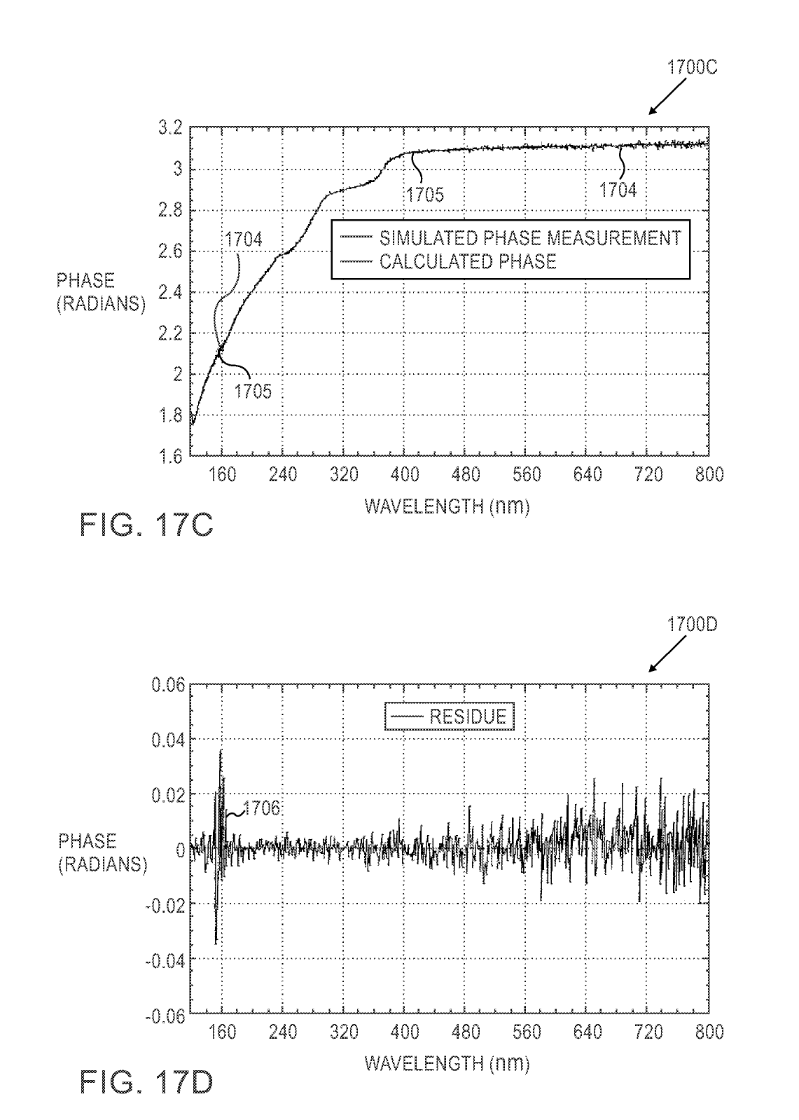

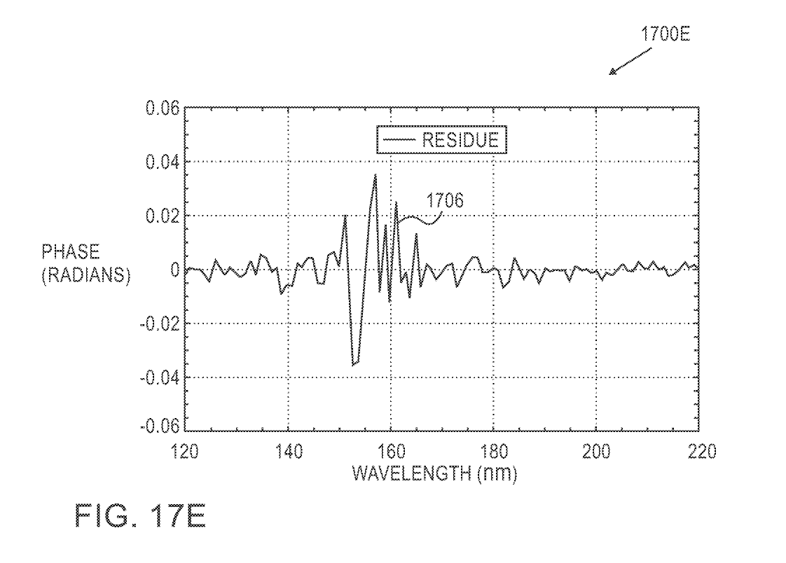

An illustration is shown in FIGS. 17A-17E. FIG. 17A shows a comparison of an interference term for 15 Å SiO₂/Si and 20 Å SiO₂/Si calibration samples, and a 15 Å, 15% nitride component SiON/Si at 120-800 nm 1700A. FIG. 17A shows the interference term, eq. 32, for 15 Å SiO₂/Si 1701 and 20 Å SiO₂/Si calibration 1702 samples, and a 15 Å, 15% nitride component SiON/Si 1703 “unknown” sample. FIG. 17B shows a zoom of the 120-220 nm region 1700B. FIG. 17B shows an expanded section of FIG. 17A, showing 15 Å SiO₂/Si 1701 and 20 Å SiO₂/Si calibration 1702 samples, and a 15 Å, 15% nitride component SiON/Si 1703 “unknown” sample. The interference minimum for all three samples is close to 155 nm. FIG. 17C shows a comparison of phase calculated using an algorithm to remove a phase ambiguity with the original theoretical phase at 120-800 nm wavelength 1700C. FIG. 17C shows the simulated phase measurement 1704 with phase ambiguity removed via the above method and the original theoretical phase 1705. A procedure similar to that used for FIGS. 13A-13E was used to generate the simulated phase measurement in FIG. 17C. FIG. 17D shows a wavelength range of 120-800 nm 1700D, showing the residue 1706 from FIG. 17C, and FIG. 17E shows a zoom of the 120-220 nm region 1700E, also showing the residue 1706 from FIG. 17C. The phase is accurate across the wavelength range, except for a small ˜10 nm window in the vicinity of the interference minima of the three samples. As in FIGS. 13A-13E, the path difference control could be used to move the minimum outside the measurement range, eliminating the error region entirely.

To illustrate the next method, we first note that the π ambiguity can be expressed by rewriting eq. A1 as

$${φ}_{S} + {φ}_{M}^{′} = \pm {cos}^{- 1} \{ \frac{{I}_{Det} - {I}_{Det , S} - {I}_{Det , M}}{2 F ( λ ) \sqrt{{I}_{Det , S} {I}_{Det , M}}} \} = \pm c . \qquad eq . A4$$

Given a path difference d₁ between sample and reference arm, a second measurement at a second path difference d₂ can be done simply by re-measuring I_{Det}, since all other quantities in eq. A4 remain the same. First, we assume a known calibration sample is measured for the two path differences in order to obtain φ_{M}′. If the right hand side of eq, A4 is denoted c₁ and c₂ for the two path differences and Δ=d₂−d₁, the various possibilities for φ_{M}′ are

φ_{M}′=c₁−φ_{Cal} eq. A5

φ_{M}′=−c₁−φ_{Cal} eq. A6

φ_{M}′=c₂−φ_{Cal}−2πΔ/λ eq. A7

φ_{M}′=−c₂−φ_{Cal}−2πΔ/λ eq. A8

The results of eqs. A5-A8 can be cast in the 0 to 2π interval by applying the algorithm

$${φ}_{M}^{′} = {φ}_{M}^{′} - 2 π \cdot floor ( \frac{{φ}_{M}^{′}}{2 π} ) \qquad eq . A9$$

where the floor function returns the integer quotient of its argument.

For a given wavelength, if eqs. A5 and A7 return the same value for φ_{M}′, or if eqs. A5 and A8 return the same value, then c₁ does not need to be negated. If eqs. A6 and A7 return the same φ_{M}′, or if eqs. A6 and A8 return the same value, then c₁ should be replaced with −c₁ at that wavelength. It suffices to determine all wavelength regions where c₁ should be inverted. Then eqs. A5 or A6 can be used as appropriate to unambiguously determine φ_{M}′ between 0 and 2π.

With knowledge of φ_{M}′ from the calibration, an unknown sample can be treated similarly:

φ_{S}=c₁−φ_{M}′ eq. A10

φ_{S}=−c₁−φ_{M}′ eq. A11

φ_{S}=c₂−φ_{M}′−2πΔ/λ eq. A12

φ_{S}=−c₂−φ_{M}′−2πΔ/λ eq. A13

where now c₁ and c₂ are the right hand sides of eq. A4 for the unknown sample, measured at the two path differences. The same rules as before are applied to determine c₁, and therefore φ_{S}, over the 0 to 2π interval.

Appendix B: Polarization Effects at the Beam Splitter

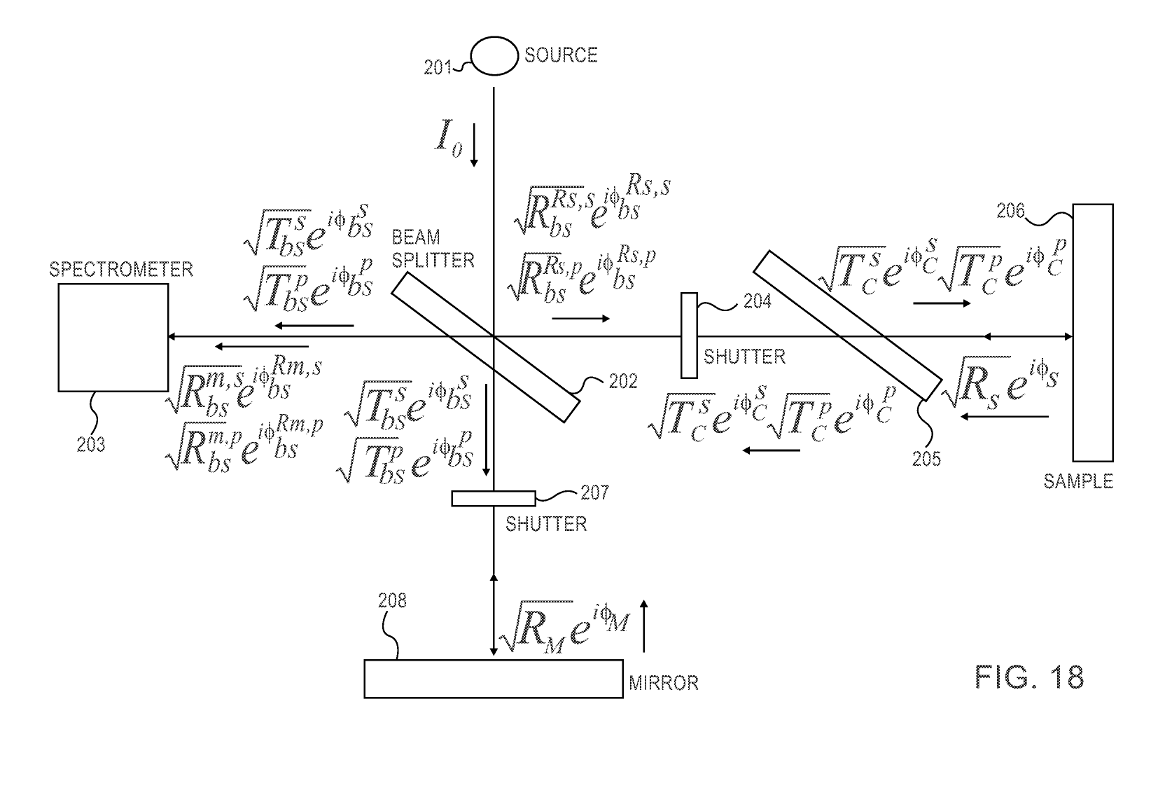

If the beam splitter 202 in FIG. 2 is polarizing, the complex reflection and transmission characteristics of the beam splitter and compensator consist of two components, one for each polarization, as shown in FIG. 18. The s and p polarization components are defined with respect to the plane of incidence on the beam splitter, and correspond to light polarized perpendicular (s polarization) or parallel (p polarization) to that plane. The symbols of FIG. 18 are defined as:
I₀=intensity incident on beam splitter
\sqrt{R_{bs}^{Rs,s}}e^{iφ}^{_{bs}}^{^{Rs,s}}\sqrt{R_{bs}^{Rs,p}}e^{iφ}^{_{bs}}^{^{Rs,p}}=total complex reflection coefficient of beam splitter films on sample arm side for s and p polarization
\sqrt{R_{S}}e^{iφ}^{_{S}}=total complex reflection coefficient of sample
\sqrt{R_{M}}e^{iφ}^{_{M}}=total complex reflection coefficient of reference surface
\sqrt{T_{C}^{s}}e^{iφ}^{_{C}}^{^{s}}\sqrt{T_{C}^{p}}e^{iφ}^{_{C}}^{^{p}}=total complex transmission coefficient of compensator or beam splitter substrate
\sqrt{R_{bs}^{Rm,s}}e^{iφ}^{_{bs}}^{^{Rm,s}}\sqrt{R_{bs}^{Rm,p}}e^{iφ}^{_{bs}}^{^{Rm,p}}=total complex reflection coefficient of beam splitter films on reference arm side
\sqrt{T_{bs}^{s}}e^{iφ}^{_{bs}}^{^{s}}\sqrt{T_{bs}^{p}}e^{iφ}^{_{bs}}^{^{p}}=total complex transmission coefficient of beam splitter films for light incident from sample arm side

Jones calculus can be used to determine the normalized intensities detected with the shutters in various configurations. The normalized intensity detected with the sample shutter only open is

$$\frac{{I}_{S}}{{I}_{0} } = \frac{1}{2} {R}_{S} \{ {{R}_{bs}^{Rs , s} ( {T}_{C}^{s} )}^{3} {T}_{bs}^{s} + {{R}_{bs}^{Rs , p} ( {T}_{C }^{p} )}^{3} {T}_{bs}^{p} \} , \qquad eq . B1$$

the normalized intensity detected with only the reference shutter open is

$$\frac{{I}_{M}}{{I}_{0}} = \frac{1}{2} {R}_{M} \{ {{T}_{bs}^{s} ( {T}_{C}^{s} )}^{3} {R}_{bs }^{Rm , s} + {{T}_{bs}^{p} ( {T}_{C}^{p} )}^{3} {R}_{bs}^{Rm , p} \} , \qquad eq . B2$$

and the normalized intensity detected when both shutters are open is

$$\frac{{I}_{D}}{{I}_{0}} = \frac{{I}_{S}}{{I}_{0}} + \frac{{I}_{M}}{{I}_{0}} + \sqrt{{R}_{bs}^{Rs , s} } {( {T}_{C}^{s} )}^{3} \sqrt{{R}_{S}} {T}_{bs}^{s} \sqrt{{R}_{M}} \sqrt{{R}_{bs}^{Rm , s}} cos \{ ( {φ}_{bs}^{Rs , s} - {φ}_{bs}^{Rm , s} ) + ( {φ}_{S} - {φ}_{M} ) + \frac{2 π}{λ} ( {d}_{S} - {d}_{M} ) \} + \sqrt{{R}_{bs}^{Rs , p}} {( {T}_{C}^{p} )}^{3} \sqrt{{R}_{S}} {T}_{bs}^{p} \sqrt{{R}_{M}} \sqrt{{R}_{bs}^{Rm , p}} cos \{ ( {φ}_{bs}^{Rs , p} ) + ( {φ}_{bs}^{Rm , p} ) + \frac{2 π}{λ} ( {d}_{S} - {d}_{M} ) \} \qquad eq . B3$$

If the beam splitter and compensator are non-polarizing, one obtains the result already presented since the intensities reduce to

$$\frac{{I}_{S}}{{I}_{0}} = {{R}_{bs}^{Rs} ( {T}_{C} )}^{3} {R}_{S} {T}_{bs} \qquad eq . B4$$

for the sample arm,

$$\frac{{I}_{M}}{{I}_{0}} = {{T}_{bs} ( {T}_{C} )}^{3} {R}_{M} {R}_{bs}^{Rm} \qquad eq . B5$$

for the reference arm, and

$$\frac{{I}_{D}}{{I}_{0}} = \frac{{I}_{S}}{{I}_{0}} + \frac{{I}_{M}}{{I}_{0}} + 2 ( \sqrt{{R}_{bs}^{Rs}} {( {T}_{C} )}^{3} {T}_{bs} \sqrt{{R}_{bs}^{Rm}} ) \sqrt{{R}_{S}} \sqrt{{R}_{M}} cos \{ ( {φ}_{bs}^{Rs} - {φ}_{bs}^{Rm} ) + ( {φ}_{S} - {φ}_{M} ) + \frac{2 π}{λ} ( {d}_{S} - {d}_{M} ) \} = \frac{{I}_{S}}{{I}_{0}} + \frac{{I}_{M}}{{I}_{0}} + 2 \sqrt{\frac{{I}_{S}}{{I}_{0}} \frac{{I}_{M}}{{I}_{0}}} cos \{ ( {φ}_{bs}^{Rs} - {φ}_{bs}^{Rm} ) + ( {φ}_{S} - {φ}_{M} ) + \frac{2 π}{λ} ( {d}_{S} - {d}_{M} ) \} \qquad eq . B6$$

for both arms, which is the same as eq. 13.

If the beam splitter is polarizing, but symmetric, one has R_{bs}^{Rs,s}=R_{bs}^{Rm,s}, φ_{bs}^{Rs,s}=φ_{bs}^{Rm,s} R_{bs}^{Rs,p}=R_{bs}^{Rm,p} and φ_{bs}^{Rs,p}=φ_{bs}^{Rm,p}. Eq. B1 and B2 become

$$\begin{matrix}\frac{{I}_{S}}{{I}_{0}} = \frac{1}{2} {R}_{S} \{ {{R}_{bs}^{s} ( {T}_{C}^{s} )}^{3} {T}_{bs}^{s} + {{R}_{bs}^{p} ( {T}_{C}^{p} )}^{3} {T}_{bs}^{p} \} \\ and & eq . B7 \\ \frac{{I}_{M}}{{I}_{0}} = \frac{1}{2} {R}_{M} \{ {{T}_{bs}^{s} ( {T}_{C}^{s} )}^{3} {R}_{bs}^{s} + {{T}_{bs}^{p} ( {T}_{C}^{p} )}^{3} {R}_{bs}^{p} \} . & eq . B8\end{matrix}$$

The normalized intensity detected with both shutters open is

$$\begin{matrix}\frac{{I}_{D}}{{I}_{0}} = \frac{{I}_{S}}{{I}_{0}} + \frac{{I}_{M}}{{I}_{0}} + ( {{R}_{bs}^{s} ( {T}_{C}^{s} )}^{3} \sqrt{{R}_{S}} {T}_{bs}^{s} \sqrt{{R}_{M}} + {{R}_{bs}^{p} ( {T}_{C}^{p} )}^{3} \sqrt{{R}_{S}} {T}_{bs}^{p} \sqrt{{R}_{M}} ) cos \{ ( {φ}_{S} - {φ}_{M} ) + \frac{2 π}{λ} ( {d}_{S} - {d}_{M} ) \} = \frac{{I}_{S}}{{I}_{0}} + \frac{{I}_{M}}{{I}_{0}} + \sqrt{( {{R}_{bs}^{s} ( {T}_{C}^{s} )}^{3} {T}_{bs}^{s} + {{R}_{bs}^{p} ( {T}_{C}^{p} )}^{3} {T}_{bs}^{p} ) {R}_{S}} \sqrt{( {{R}_{bs}^{s} ( {T}_{C}^{s} )}^{3} {T}_{bs}^{s} + {{R}_{bs}^{p} ( {T}_{C}^{p} )}^{3} {T}_{bs}^{p} ) {R}_{M}} cos \{ ( {φ}_{S} - {φ}_{M} ) + \frac{2 π}{λ} ( {d}_{S} - {d}_{M} ) \} & eq . B9 \\ so & \\ \frac{{I}_{D}}{{I}_{0}} = \frac{{I}_{S}}{{I}_{0}} + \frac{{I}_{M}}{{I}_{0}} + 2 \sqrt{\frac{{I}_{S}}{{I}_{0}} \frac{{I}_{M}}{{I}_{0}}} cos \{ ( {φ}_{S} - {φ}_{M} ) + \frac{2 π}{λ} ( {d}_{S} - {d}_{M} ) \} , & eq . B10\end{matrix}$$

which is again the same as eq. 13.

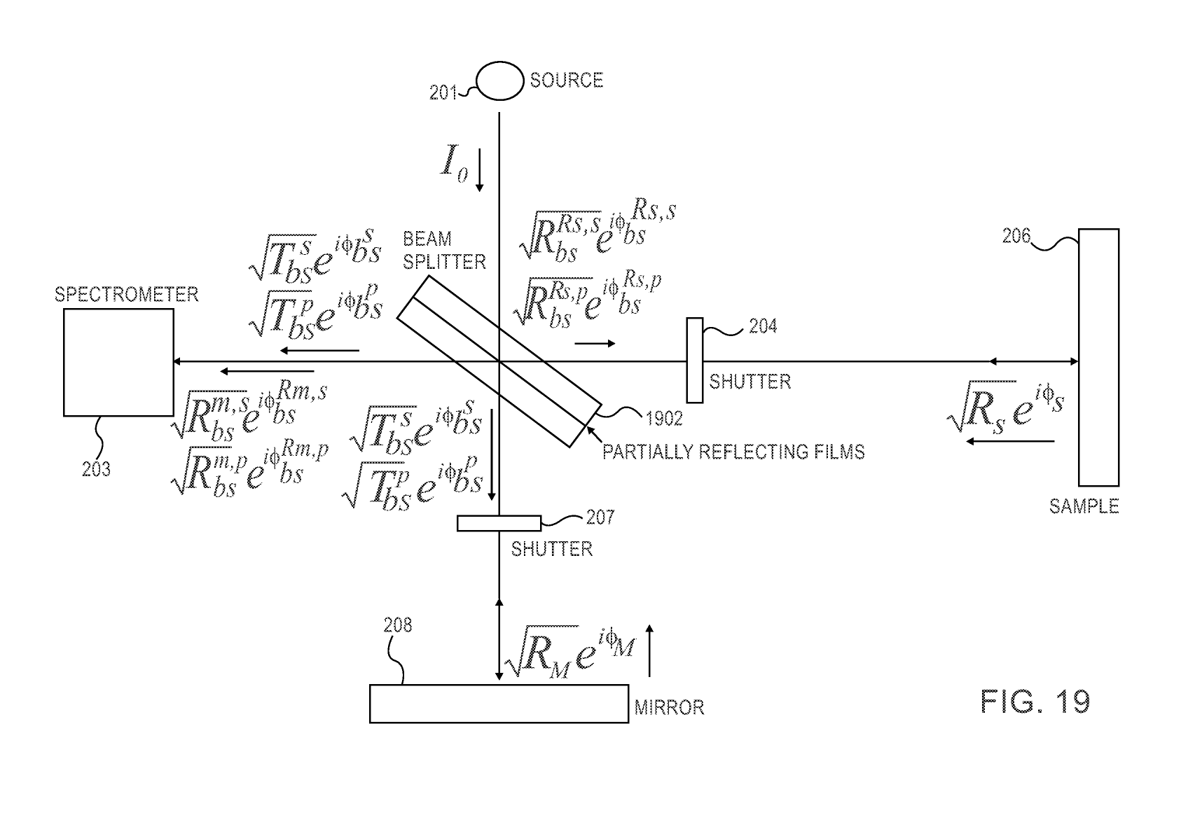

A symmetric beam splitter can be constructed in several ways. One method is to coat a thin film of the beam splitter substrate material on the beam splitting films. A second method is to construct a beam splitter consisting of beam splitting films sandwiched between two identical substrates, as illustrated in beam splitter 1902 FIG. 19. The configuration in FIG. 19 also eliminates the need for a separate compensating plate. In either case, the complex reflection and transmission coefficients from the beam splitting films are identical for light incident from either side of the films.

More generally, other components in the optical path may be polarizing as well. Aside from the beam splitter, focusing or flat optics that reflect light at an angle may impart some polarization on otherwise un-polarized incident light. The reference and sample arms can have polarizing components—eq. B10 will result as long as the polarization effects are the same for both arms.

Appendix C: Variations in Substrate Thickness—Unpolarized Light

The total phase argument in eqs. 13 or 19 is

$${φ}_{S} + {φ}_{M}^{′} = {φ}_{S} + \frac{2 π}{λ} ( {d}_{S} - {d}_{M} ) - {φ}_{M} , \qquad eq . C1$$

Where, without loss of generality, one may assume a symmetric beam splitter. The use of a calibration sample removes the reference surface and path length phases from consideration. This will hold to the extent that it is possible to reproducibly place sample surfaces at exactly the same height as the calibration surface.

For semiconductor applications in production environments, wafer-to-wafer and within wafer substrate thickness tolerances can be of the order of microns. Additionally, wafers may warp or bow, and vacuum systems for holding semiconductor wafers in place may cause further non-uniformities in d_{S}−d_{M} as a wafer surface is scanned. All of this means that when used for production semiconductor applications, the total path-length difference for calibration and unknown samples are very likely different.

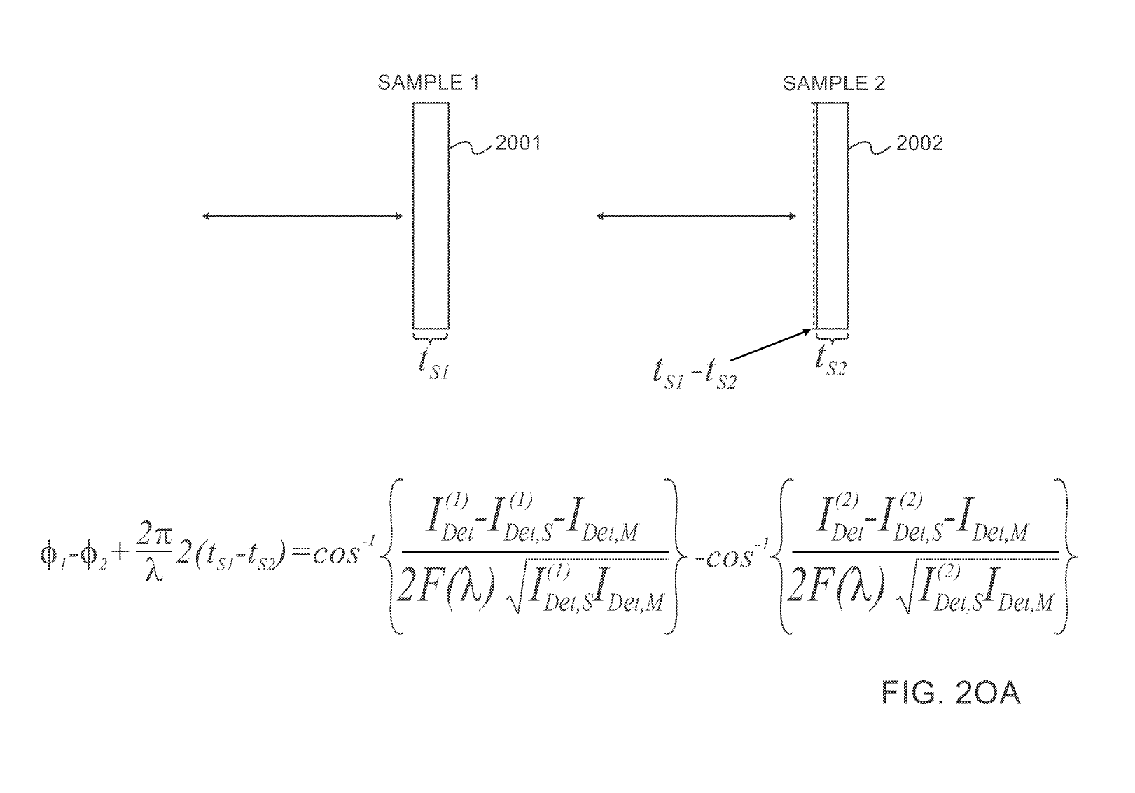

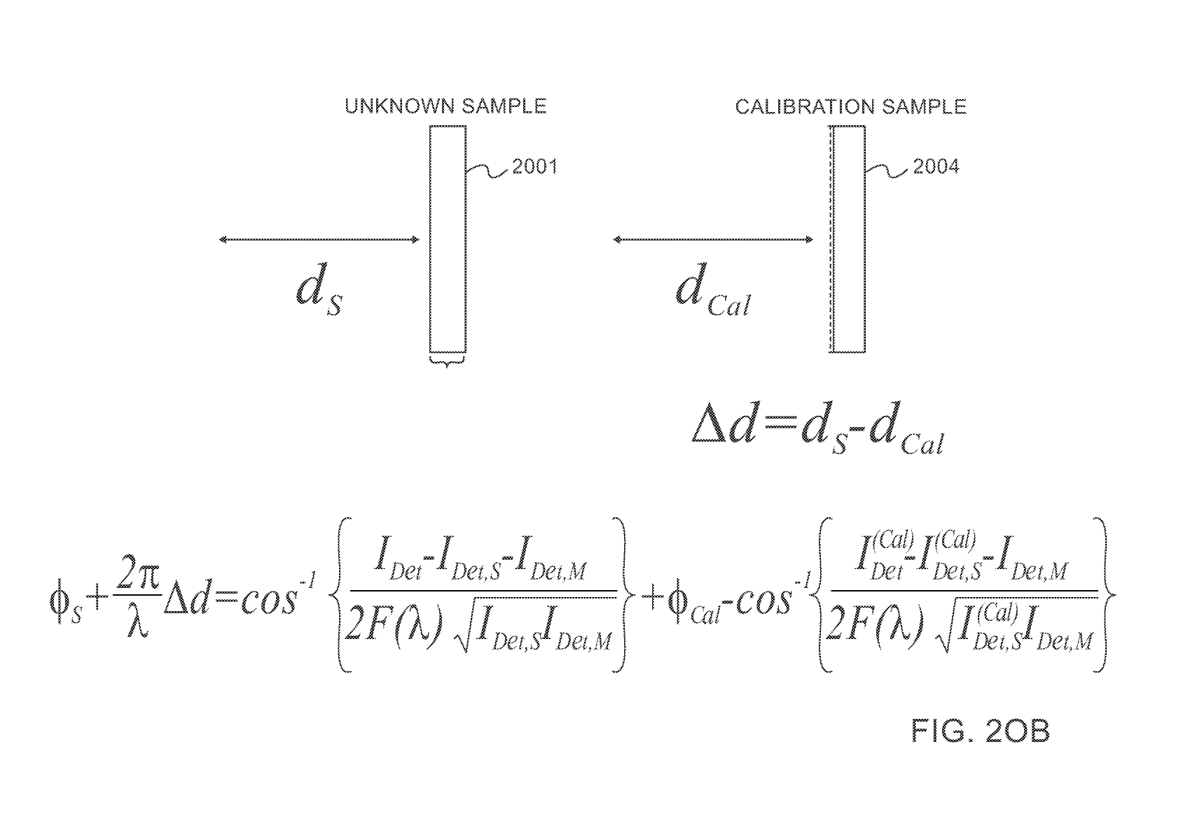

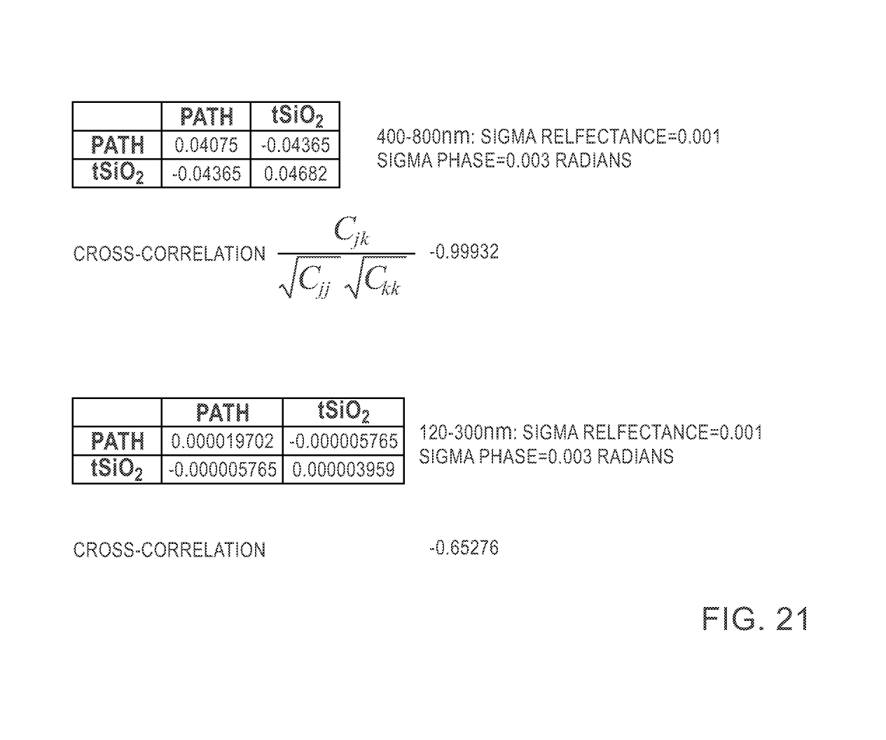

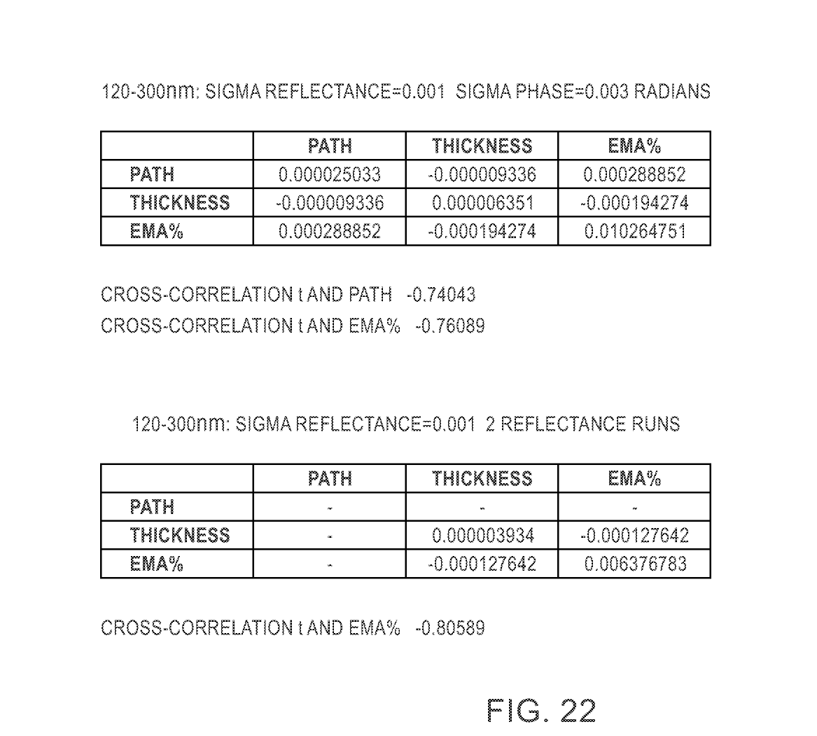

The situation is illustrated schematically in FIG. 20. FIG. 20A shows two samples, sample 2001 and 2002, in the sample arm with thicknesses t_{S1} and t_{S2}. The method of the present invention applied to this scenario determines

$${φ}_{1} - {φ}_{2} + \frac{2 π}{λ} 2 ( {t}_{S 1} - {t}_{S 2} ) = {cos}^{- 1} \{ \frac{{I}_{Det}^{( 1 )} - {I}_{Det , S}^{( 1 )} - {I}_{Det , M}}{2 F ( λ ) \sqrt{{I}_{Det , S}^{( 1 )} {I}_{Det , M}}} \} - {cos}^{- 1} \{ \frac{{I}_{Det}^{( 2 )} - {I}_{Det , S}^{( 2 )} - {I}_{Det , M}}{2 F ( λ ) \sqrt{{I}_{Det , S}^{( 2 )} {I}_{Det , M}}} \} . \qquad eq . C2$$

If t_{S1}−t_{S2} is known, by pre-measuring the substrate thicknesses for example, then the factor (2π/λ)*2*(t_{S1}−t_{S2}) can simply be subtracted from the measurements on the left hand side of eq. C2 to obtain φ₁−φ₂. On the other hand, if t_{S1}−t_{S2} is not known, the phase difference between the two samples is in error by the amount (2π/λ)2(t_{S1}−t_{S2}). Auto-focusing techniques can eliminate much of this error by adjusting the path length for each sample to compensate for the path difference, but a simple calculation shows that even a 1 Å difference in path-length can cause a 0.0015 radians error in phase at 400 nm, and a 0.005 radian phase error at 120 nm if unaccounted for.

Methods for measuring substrate thicknesses are possible. Silicon substrates can be measured using wavelengths near or above the silicon band gap of about 1100 nm. Near Infra-red and Infra-red reflectance, transmittance, or both can be used to measure silicon and other substrate thicknesses. Transparent substrates like glass and quartz could be measured using UV or visible wavelengths. It may be desirable to use laser or supercontinuum sources to ensure coherence of probe light undergoing multiple reflections from top and bottom surfaces of the substrate. Modeling such data might include the effects of surface films and variations in the substrate refractive index. The wavelength ranges used may also be chosen so that these effects are minimized.

Even if a substrate thickness measurement is obtained with the necessary precision, wafer bowing and vacuum warping affect the path difference independently of the substrate thickness. A separate interferometer might be employed to attempt a direct measurement of the change in path difference for each sample, but any interferometric measurement will likely suffer errors due to different phase contributions from the sample surfaces, which is what is being measured in the first place.

The goal of the reflectance and phase measurement is generally to extract structural and optical properties of the unknown sample, and not necessarily as a direct measure of sample phase. Referring to FIG. 20B, sample 2002 is replaced with a known calibration sample 2004, and the total round-trip path length difference for the sample is expressed as d_{S}, and that of the calibration sample as d_{Cal}. The functional form of the path difference error with respect to wavelength is known in terms of a single parameter, Δd, the difference between the total path lengths of the calibration and unknown samples. Accordingly, one embodiment of the current invention enhances the fit parameter set with the additional parameter Δd. Rewriting eq. C2:

$$\begin{matrix}{φ}_{S} + \frac{2 π}{λ} Δ d = {cos}^{- 1} \{ \frac{{I}_{Det} - {I}_{Det , S} - {I}_{Det , M}}{2 F ( λ ) \sqrt{{I}_{Det , S} {I}_{Det , M}}} \} + {φ}_{Cal} - {cos}^{- 1} \{ \frac{{I}_{Det}^{( Cal )} - {I}_{Det , S}^{( Cal )} - {I}_{Det , M}}{2 F ( λ ) \sqrt{{I}_{Det , S}^{( Cal )} {I}_{Det , M}}} \} & eq . C3 \\ where & \\ Δ d = ( {d}_{S} - {d}_{M} ) - ( {d}_{Cal} - {d}_{M} ) = {d}_{S} - {d}_{Cal} . & eq . C4\end{matrix}$$

For simplicity, Δd will be referred to as the path length difference.

Note that eq. C3 and C4 applies to total path differences between unknown sample and calibration sample due to any cause, and not just differences in substrate thicknesses. Now a phase measurement actually determines φ_{S}+(2π/λ)Δd, and the modified parameter set is a_{R}=a₁, a₂, . . . , aₘ) and a_{φ}=(a₁, a₂, . . . , aₘ, Δd). With R_{c,i}=R_{c,i}(a_{R}) and φ_{cj}=φ_{c,j}(a_{φ}). The aᵢ are the film properties that are to be determined. From the standard film models, one minimizes

$$\begin{matrix}{χ}^{2} = {\sum }_{i = 1}^{Nr} {( \frac{1}{{σ}_{i}^{r}} )}^{2} {( {R}_{i , m} - {R}_{i , c} ( {a}_{1} , … , {a}_{m} ) )}^{2} + {\sum }_{j = 1}^{Np} {( \frac{1}{{σ}_{j}^{p}} )}^{2} {( {φ}_{j , m} - {φ}_{j , c} ( {a}_{1} , … , {a}_{m} , Δ d ) )}^{2} , & eq . C 5 \\ or & \\ {χ}^{2} = {\sum }_{i = 1}^{Nr} {( \frac{1}{{σ}_{i}^{r}} )}^{2} {( {R}_{i , m} - {R}_{i , c} ( {a}_{1} , … , {a}_{m} ) )}^{2} + {\sum }_{j = 1}^{Np} {( \frac{1}{{σ}_{j}^{p}} )}^{2} {( {φ}_{j , m} - {φ}_{j , c} ( {a}_{1} , … , {a}_{m} ) - \frac{2 π}{{λ}_{j}} Δ d )}^{2} , & eq . C6\end{matrix}$$

where the remaining symbols have the same meaning as already presented in the body of the disclosure.

Now the difference in path lengths, Δd is obtained along with the previous film parameter set a. In most thin film or CD applications, the path difference is not of primary interest, and in these cases fitting the path length is really just a tool to allow for accurate extraction of the remaining parameters of the film system. Since the path length difference can have a variety of causes, the extended fit procedure of eq. C5 and eq. C6 actually compensates for a variety of potential stability issues, without further mechanical modification. Additionally, for wafer profiling applications, the path difference may indeed be desired, being fit separately at every measurement site. Reversing the role of the phase reflectometer, the path length difference obtained accounts for variations in film parameters, which can lead to more accurate determination of Δd in the presence of more complicated film systems than would be possible using traditional optical interferometers.

Generally, for thicker and more complicated film stacks, coupling between Δd and the thicknesses of films in the film stack is not a serious problem. However, for transparent ultra-thin films, the first-order contribution to the phase change in reflection also varies inversely with wavelength:

$${φ}_{S} = \frac{2 π}{λ} 2 {\tilde{N}}_{f} {t}_{f} + {φ}^{′} ( λ , {\tilde{N}}_{f} , {t}_{f} , {\tilde{N}}_{Subst} ) , \qquad eq . C7$$

where Ñ_{f}=n_{f}−ik_{f} is the complex index of the film and Ñ_{Subst}=n_{Subst}−ik_{Subst} is the complex index of the substrate. In eq. C7, the first term is the phase contribution due to light traversing the film instead of the ambient, and the second term is due to multiple reflections through the film as well as absorption of the film and substrate. For ultra-thin dielectrics on silicon substrates, the first term is dominant at longer wavelengths where the substrate and film are transparent, and the second term has more influence as the substrate and film begin to absorb, typically at shorter VUV-DUV wavelengths.

For wavelength regions where film and substrate are transparent, the phase dependence on film thickness is linear just as the phase difference due to changes in path difference. Since n_{f} depends on wavelength as well, multiple wavelengths can in principle help decouple changes in path length from changes in film thickness, although the wavelength dependence of n_{f} for a typical ultra-thin dielectric at visible wavelengths is fairly weak.

At DUV and especially VUV wavelength ranges, however, changes in film thickness and changes in path difference affect the wavelength dependence of phase spectra very differently, and the ability to simultaneously extract thickness and path difference is enhanced. Covariance analysis, which has already been described in the body of the disclosure, can be used to explore the degree of coupling between film thickness and path length differences for various cases.

The first example, shown in FIG. 21, is a 15 Å SiO₂/Si system. A factor of (2π/λ)*Δd was added to the model phase to account for the path length difference. A nominal Δd of 20 Å was used for the calculation in the table of FIG. 21, although the value chosen for Δd has almost no effect on the results. The table compares the 2×2 covariance matrix for reflectance and phase assuming variation of the path difference and SiO₂ thickness for a 400-800 nm wavelength range and a 120-300 nm wavelength range. The analysis assumed the same precision in measured data for the two data ranges. The diagonal elements of the covariance matrix give the variances for the parameters, and for random Gaussian data uncertainty, the 1-sigma standard uncertainty for the parameters is the square roots of the variances. Thickness units are nanometers. The 400-800 nm data appear to show some capability, but the cross-correlation coefficient, given by

$$\frac{{C}_{jk}}{\sqrt{{C}_{jj}} \sqrt{{C}_{kk}}} \qquad eq . C8$$

is nearly −1, indicating that the path difference and SiO₂ thickness are strongly and inversely correlated. In practice, simultaneously extracting path difference and SiO₂ thickness will be very hard using the 400-800 nm wavelength range. In contrast, the variances for the 120-300 nm range are orders of magnitude better, and the cross-correlation is much smaller, at −0.65276, well within practical performance limits. It is apparent from the table of FIG. 21 that the addition of the VUV portion of the phase spectra is enabling for determining ultra-thin film thickness simultaneously with the path difference. For thicker SiO₂ films, multiple reflections between the film surface and film-substrate interface make it much easier to decouple thickness from path length using any wavelength range.

Even if the path difference and film thickness can be simultaneously extracted, it is still possible that the precision of the measurement is degraded to the point that it may no longer be beneficial to add phase information. An SiON example was given in the body of the disclosure where high precision visible wavelength phase was used to significantly enhance the thickness performance for the SiON film. Running that same configuration, but including the path difference variable will negate the performance enhancement, at least as represented by a covariance analysis.

It is still worth looking into the SiON example a little further, as is done in the table of FIG. 22, for a 15 Å SiON film with 15% SiN component. The table of FIG. 22 compares 120-300 nm reflectance and phase with two successive reflectance-only measurements, so that the two cases require about the same measurement time. As can be seen in the table, use of the VUV phase data does result in significant capability for determining all three parameters—SiON thickness, EMA composition, and path difference. However, the thickness and composition results are about the same or perhaps a little worse than the corresponding reflectance-only measurements. For applications where only the film parameters are of interest, phase information brings no additional capability. The additional path difference variable is successful for this example, but at the cost of practically all of the benefit of having phase information in the first place. However, it is noteworthy that the path difference can be accurately extracted even in the presence of a two component SiON film on the sample.

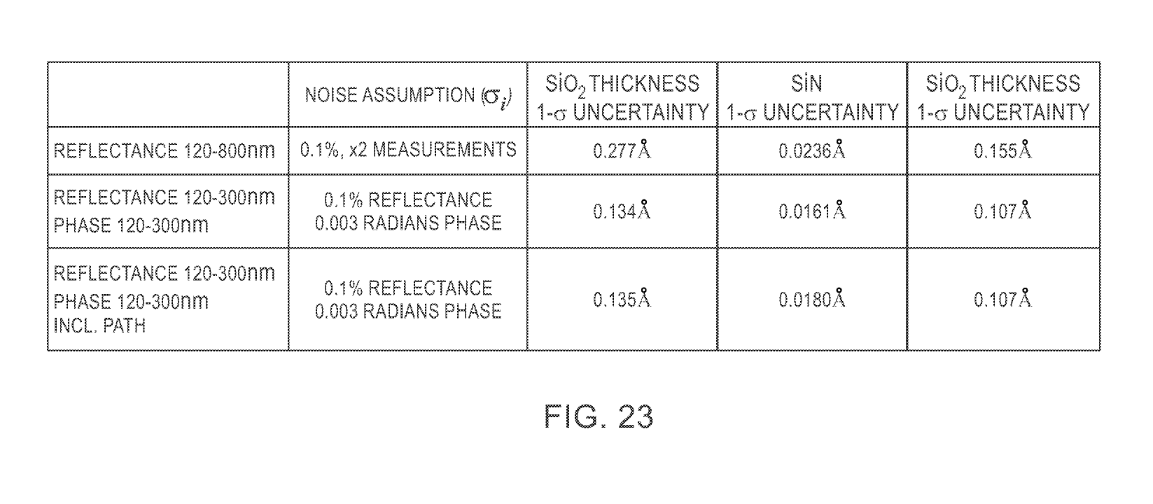

A last example is shown in the table of FIG. 23 involving an ONO stack, consisting of 65 Å SiO₂/45 Å SiN/50 Å SiO₂/Si. The table compares 1-sigma thickness uncertainties for two successive 120-800 nm reflectance measurements (row 1) with 120-300 nm reflectance and phase without fitting the path difference (row 2), and 120-300 nm phase fitting the path difference (row 3). From the table it is clear that the reflectance and phase together result in a factor of two improvement in the top two films, and at least some improvement for the bottom oxide film. Since the reflectance-only case already averages two reflectance measurements, approximately 8 total reflectance-only measurements would be required to match the reflectance+phase performance. Additionally, the inclusion of the path difference in the fit has had a negligible effect on the ability of the phase to enhance the metrology. This example shows that it is possible to enhance performance for some ultra-thin film systems using phase information, even when accounting for uncontrolled or otherwise unknown differences in path length.

It should be pointed out that the covariance analysis in this appendix is not an apples-to-apples comparison. The additional path parameter for the phase measurement actually takes into account a major component of the stability of the phase measurement, while the reflectance-only measurements do not attempt to take into account any stability considerations. It is conceivable that a non-semiconductor application might not suffer from the substrate-induced path difference errors, or that semiconductor applications may exist where the substrate thickness and rigidity tolerances are extremely tight, in which case the assumption that two film surfaces can be reproducibly placed at precisely the same distance from the beam splitter would be valid, and there would be no need to fit the path difference. From another angle, the covariance most closely mimics an idealized static precision measurement, which would not involve replacing a substrate. Even reflectance-only measurements will perform worse in a “load/unload” reproducibility test than on a static repeatability test. Therefore, the true apples-to-apples performance comparison should still be considered the covariance analysis without fitting the path, although it is probably fair to say that the interference-based phase measurement will suffer more performance degradation when comparing static repeatability measurements with reproducibility or stability measurements than will reflectance-only measurements.

In light of all of this, the factor of two performance enhancement over reflectance-only measurements for the ONO stack is even more impressive since the phase predictions include stability effects, while the reflectance measurements do not. Under more realistic conditions of film process control, one might expect that the performance gap may end up being even wider as the reflectance measurements are subjected to stability considerations as well.

In addition, the conclusion reached for the 15 Å SiON example may change as stability considerations come into play. Phase is expected to enhance SiON metrology capability as the SiON film thickness increases, even with path difference variation.

Appendix D: Variations in Substrate Thickness—Polarized Light

The total phase arguments in eqs. 113 and 119 are

$$\begin{matrix}{φ}_{S}^{s} + {Φ}_{M}^{s} = {φ}_{S}^{2} + \frac{2 π}{λ} ( {d}_{S} - {d}_{M} ) - {φ}_{M}^{s} , & eq . D1 \\ {φ}_{S}^{p} + {Φ}_{M}^{p} = {φ}_{S}^{p} + \frac{2 π}{λ} ( {d}_{S} - {d}_{M} ) - {φ}_{M}^{p} & eq . D1\end{matrix}$$

Where, without loss of generality, we assume a symmetric beam splitter. The use of a calibration sample removes the reference surface and path length phases from consideration. This will hold to the extent that it is possible to reproducibly place sample surfaces at exactly the same height as the calibration surface.

For semiconductor applications in production environments, wafer-to-wafer and within wafer substrate thickness tolerances can be of the order of microns. Additionally, wafers may warp or bow, and vacuum systems for holding semiconductor wafers in place may cause further non-uniformities in d_{S}−d_{M} as a wafer surface is scanned. All of this means that when used for production semiconductor applications, the total path-length difference for calibration and unknown samples are very likely different.

The situation is illustrated schematically in FIG. 26. FIG. 26 shows samples 2600 and 2602 in the sample arm with total path distances d₁ and d₂. Here, d₁ and d₂ refer to the total path difference between sample and reference arms with sample 1 and sample 2 in the sample arm, respectively. The difference in total path lengths could be due to differing substrate thicknesses, wafer warping, vacuum chuck effects, thermal effects, or any other effect that causes the total path difference to differ when measuring the two samples.

The method of the present disclosure applied to this scenario determines

$$\begin{matrix}{φ}_{S}^{1 , s} - {φ}_{S}^{2 , s} + \frac{2 π}{λ} ( {d}_{1} - {d}_{2} ) = {cos}^{- 1} \{ \frac{{I}_{Det}^{( 1 , s )} - {I}_{Det , S}^{( 1 , s )} - {I}_{Det , M}^{s}}{2 \sqrt{{I}_{Det , S}^{( 1 , s )} {I}_{Det , M}^{s}}} \} - {cos}^{- 1} \{ \frac{{I}_{Det}^{( 2 , s )} - {I}_{Det , S}^{( 2 , s )} - {I}_{Det , M}^{s}}{2 \sqrt{{I}_{Det , S}^{( 2 , s )} {I}_{Det , M}^{s}}} \} & eq . D3 \\ {φ}_{S}^{1 , p} - {φ}_{S}^{2 , p} + \frac{2 π}{λ} ( {d}_{1} - {d}_{2} ) = {cos}^{- 1} \{ \frac{{I}_{Det}^{( 1 , p )} - {I}_{Det , S}^{( 1 , p )} - {I}_{Det , M}^{p}}{2 \sqrt{{I}_{Det , S}^{( 1 , p )} {I}_{Det , M}^{p}}} \} - {cos}^{- 1} \{ \frac{{I}_{Det}^{( 2 , p )} - {I}_{Det , S}^{( 2 , p )} - {I}_{Det , M}^{p}}{2 \sqrt{{I}_{Det , S}^{( 2 , p )} {I}_{Det , M}^{p}}} \} . & eq . D4\end{matrix}$$

If (d₁−d₂) is known, by pre-measuring the substrate thicknesses for example, then the factor (2π/λ)*(d₁−d₂) can simply be subtracted from the measurements on the left hand side of eqs. D3 and D4 to obtain the phase differences. On the other hand, if (d₁−d₂) is not known, the phase difference between the two samples is in error by the amount (2π/λ)(d₁−d₂).

The path length difference can be fit as an unknown parameter according to the unpolarized light methods described above. The path length difference is determined in addition to the film parameters of interest. However, in many cases the additional unknown parameter degrades measurement performance for the film parameters of interest. This is usually due to coupling between the path length difference parameter and total thickness of films on the substrate, and is generally worse for longer wavelength data than for VUV data.

In this case, it is advantageous to work with the ellipsometric parameter Δ, since

$${φ}_{S}^{1 , p} - {φ}_{S}^{2 , p} - ( {φ}_{S}^{1 , s} - {φ}_{S}^{2 , s} ) = ( {φ}_{S}^{1 , p} - {φ}_{S}^{1 , s} ) - ( {φ}_{S}^{2 , p} - {φ}_{S}^{2 , s} ) = {Δ}_{S}^{1} - {Δ}_{S}^{2} = {cos}^{- 1} \{ \frac{{I}_{Det}^{( 1 , p )} - {I}_{Det , S}^{( 1 , p )} - {I}_{Det , M}^{p}}{2 \sqrt{{I}_{Det , S}^{( 1 , p )} {I}_{Det , M}^{p}}} \} - {cos}^{- 1} \{ \frac{{I}_{Det}^{( 1 , s )} - {I}_{Det , S}^{( 1 , s )} - {I}_{Det , M}^{s}}{2 \sqrt{{I}_{Det , S}^{( 1 , s )} {I}_{Det , M}^{s}}} \} - {cos}^{- 1} \{ \frac{{I}_{Det}^{( 2 , p )} - {I}_{Det , S}^{( 2 , p )} - {I}_{Det , M}^{p}}{2 \sqrt{{I}_{Det , S}^{( 2 , s )} {I}_{Det , M}^{p}}} \} + {cos}^{- 1} \{ \frac{{I}_{Det}^{( 2 , s )} - {I}_{Det , S}^{( 2 , s )} - {I}_{Det , M}^{s}}{2 \sqrt{{I}_{Det , S}^{( 2 , s )} {I}_{Det , M}^{s}}} \} \qquad eq . D 5$$

does not depend on the path length difference. If sample 1 is unknown and sample 2 is a known calibration sample, we have

$${Δ}_{S} = {Δ}_{Cal} + {cos}^{- 1} \{ \frac{{I}_{Det}^{p} - {I}_{Det , S}^{p} - {I}_{Det , M}^{p}}{2 \sqrt{{I}_{Det , S}^{p} {I}_{Det , M}^{p}}} \} - {cos}^{- 1} \{ \frac{{I}_{Det}^{s} - {I}_{Det , S}^{s} - {I}_{Det , M}^{s}}{2 \sqrt{{I}_{Det , S}^{s} {I}_{Det , M}^{s}}} \} - {cos}^{- 1} \{ \frac{{I}_{Det}^{( Cal , p )} - {I}_{Det , S}^{( Cal , p )} - {I}_{Det , M}^{p}}{2 \sqrt{{I}_{Det , S}^{( Cal , p )} {I}_{Det , M}^{p}}} \} + {cos}^{- 1} \{ \frac{{I}_{Det}^{( Cal , s )} - {I}_{Det , S}^{( Cal , s )} - {I}_{Det , M}^{s}}{2 \sqrt{{I}_{Det , S}^{( Cal , s )} {I}_{Det , M}^{s}}} \} \qquad eq . D6$$

The parameter Δ does depend on the thickness of films. Unlike reflectance magnitude, Δ is sensitive to film thickness changes at visible and near infra-red wavelengths, even for ultra-thin films.

Appendix E: Enhancement of VUV Reflectometry—Polarized Light

Coupled into a VUV reflectometer as illustrated in FIG. 24, the present disclosure can provide additional constraint to film metrology problems.

The laser source/detector can be coupled into a broad-band referencing VUV reflectometer. In this case, the ellipsometric parameters Ψ and Δ can be fit along with VUV-NIR reflectance to enhance the extraction of multiple parameters. In the case of an ultra-thin SiON film, for example, Δ in particular is sensitive to the total film thickness at visible wavelength ranges, but not very sensitive to composition, while reflectance is nearly insensitive to either parameter at longer wavelength ranges. While VUV reflectance is sensitive to both thickness and composition, there is typically lower available intensity at these wavelength ranges. This can adversely affect VUV signal noise, limiting the precision possible for film thickness. The additional constraint provided by visible wavelength λ information can assist in providing better precision for total SiON thickness due to a higher available visible wavelength signal (leading to better signal-to-noise properties). Meanwhile, composition is determined mostly by VUV reflectance information. Alternately, the information can help decouple additional SiON parameters, relating to multiple composition components, surface condition, interface condition, or film profile variation. Similar statements can be made about other ultra-thin film systems, such as the HfSiON/Interface Layer/Si system.

A second method couples the present techniques into the VUV phase reflectometer unpolarized light techniques described above. In this case, the Δ parameter contains information about the total thickness of films on the sample without suffering from path difference errors. This removes the coupling between film thickness and path length difference (Δd in Appendix C above) that might effect the technique when measuring films on semiconductor substrates. The VUV-NIR reflectance and phase now fits the path length difference in addition to all of the unknown film parameters, but A provides complimentary data that measures total film thickness independently of total path difference, effectively negating the coupling effect of the additional path length difference parameter. Another way to look at this is that the VUV-NIR reflectance and phase fits (2π/λ)(d₁−d₂) instead of the total film thickness, which is effectively determined by visible wavelength Δ information. The result is that the significant film performance enhancements predicted for the VUV phase reflectometer for unpolarized light by ignoring the path difference error are recovered, even when the path difference error is present.

Further modifications and alternative embodiments of the techniques disclosed herein will be apparent to those skilled in the art in view of this description. It will be recognized, therefore, that the techniques disclosed herein are not limited by these example arrangements. Accordingly, this description is to be construed as illustrative only and is for the purpose of teaching those skilled in the art the manner of carrying out the techniques disclosed herein. It is to be understood that the forms of the techniques disclosed herein shown and described are to be taken as the presently preferred embodiments. Various changes may be made in the implementations and architectures. For example, equivalent elements may be substituted for those illustrated and described herein, and certain features of the techniques disclosed herein may be utilized independently of the use of other features, all as would be apparent to one skilled in the art after having the benefit of this description of the techniques disclosed herein.

1. A method for obtaining multiple wavelength reflectance magnitude and phase measurements from a sample, comprising:
providing at least some vacuum ultra-violet (VUV) wavelengths of light;
obtaining interference signals between reference and sample arms of a reflectometer with the sample in place;
obtaining reflected intensities from the reference arm and sample arm independently with the sample in place; and
combining the reflected intensities and interference signals with reflected intensities and interference signals from one or more known calibration standards to obtain wavelength reflectance magnitude and reflectance phase data for the sample.
